SEQUENCE LISTING (1 sequence)

SEQ ID NO: 1 - protein, 302 aa, Neurospora crassa
IRSFATHAQLPISIVNREDDAFLNPNFRFIDHSIIGKNVPVADQSFRVGCSCASDEECMYSTCQCLDEMAPDSDEEADPYTRKKRFAYYSQGAKKGLLRDRVLQSQEPIYECHQGCACSKDCPNRVVERGRTVPLQIFRTKDRGWGVKCPVNIKRGQFVDRYLGEIITSEEADRRRAESTIARRKDVYLFALDKFSDPDSLDPLLAGQPLEVDGEYMSGPTRFINHSCDPNMAIFARVGDHADKHIHDLALFAIKDIPKGTELTFDYVNGLTGLESDAHDPSKISEMTKCLCGTAKCRGYLW

(19) United States
(12) Patent Application Publication
(10) Pub. No.: US 2007/0178523 A1
(43) Pub. Date: Aug. 2, 2007

(54) Novel druggable regions in set domain proteins, and methods of using the same

(75) Inventors: Xiaodong Cheng, Decatur, GA (US); Xing Zhang, Decatur, GA (US)

Correspondence Address: GREENLEE WINNER AND SULLIVAN P C, 4875 PEARL EAST CIRCLE, SUITE 200, BOULDER, CO, 80301, US

(73) Assignee: Emory University, Atlanta, GA (US)

(21) Appl. No.: 10/636,508

(22) Filed: Aug. 6, 2003

Related U.S. Application Data
(60) Provisional application No. 60/401,427, filed on Aug. 6, 2002.
(60) Provisional application No. 60/454,101, filed on Mar. 12, 2003.

(51) Int. Cl. C40B 30/02; C40B 30/06; C40B 40/10

(52) U.S. Cl. 435/7.1; 514/12; 702/19

(57) ABSTRACT

The present invention relates to novel druggable regions discovered in histone H3 lysine methyltransferase DIM-5, which is a SET domain protein. The present invention further relates to methods of using the druggable regions to screen potential candidate therapeutics for diseases in which the activity of SET domain proteins are implicated, for example, anti-cancer/anti-proliferative agents or anti-fungal agents.

### CROSS-REFERENCE TO RELATED APPLICATIONS

This application claims the benefit of priority to the following U.S. Provisional Applications, the contents of which applications are herein specifically incorporated by reference in their entireties: U.S. Provisional Application No. 60/401,427, filed Aug. 6, 2002 and U.S. Provisional Application No. 60/454,101, filed Mar. 12, 2003

### GOVERNMENT SUPPORT

The subject invention was made in part with government support under Grant Number GM 61355 awarded by the NIH. Accordingly, the U.S. Government has certain rights in this invention.

### FIELD OF THE INVENTION

The present invention relates to novel druggable regions in SET domain proteins, in particular the histone lysine methyltransferase proteins, and methods of using the same, e.g. for drug discovery.

### BACKGROUND OF THE INVENTION

Histones are subject to extensive post-translational modifications including acetylation, phosphorylation and methylation, primarily on their N-terminal tails that protrude from the nucleosome. Evidence accumulated over the past few years suggests that such modifications constitute a “histone code” that directs a variety of processes involving chromatin. Histone methylation represents the most recently recognized component of the histone code. Histone lysine (K) methyltransferases (HKMT) differ both in their substrate specificity for the various acceptor lysines, as well as in their product specificity for the number of methyl groups (one, two or three) they transfer. Known targets for HKMT include Lys-4, 9, 27, 36, and 79 in histone H3 and Lys-20 in histone H4 (reviewed in Marmorstein, 2003). The extent of methylation at these residues is not fully defined, however. The S. cerevisiae SET1 protein can catalyze di- and tri-methylation of H3 Lys-4, and tri-methylation of Lys-4 is thought to be present exclusively in active genes. Furthermore, DIM-5 of N. crassa generates primarily tri-methyl-Lys-9, which marks chromatin regions for DNA methylation. Human SET7/9 protein, on the other hand, generates exclusively mono-methyl Lys-4 of H3. Such differences between yeast and fungal proteins may be exploited in the design of therapeutics to treat diseases or conditions associated with each type of protein, for example, an anti-fungal, anti-cancer, or anti-proliferative therapeutics.

The SET domain, which is approximately 130 amino acids in length, is found in all but one known HKMT. HKMTs can be classified according to the presence or absence, and nature of, sequences surrounding the SET domain. Representatives of the major families include SUV39, SET1, SET2, EZ, and RIZ. The SET7/9 and SET8 proteins do not fit into these families (FIG. 1). The SUV39 family includes the greatest number of HKMTs. Crystal structures have recently been determined for several SET domain proteins. These include two SUV39 family proteins, DIM-5 and Clr4, a Rubisco MTase, four SET7/9 structures in various configurations, and a viral protein that contains only the SET domain. These structures revealed that the highly conserved residues of the SET domain (magenta in FIG. 1) form a knot-like structure that constitutes the active site of the enzymes. Most recently, the structure of SET7/9 complexed with a peptide revealed its substrate binding site.

### SUMMARY OF THE INVENTION

The SET domain protein DIM-5 and a ternary complex thereof have been crystallized and their structures solved as described in detail below, thereby providing information about the structure of the polypeptide, and druggable regions, domains and the like contained therein, all of which may be used in rational-based drug design efforts. DIM-5 is a SUV39-type histone H3 Lys-9 MTase from N. crassa that is essential for DNA methylation in vivo.

The present invention also provides purified, soluble and crystalline forms of histone lysine methyltransferases suitable for structural and functional characterization using a variety of techniques, including, for example, affinity chromatography, mass spectrometry, NMR and x-ray crystallography. The invention further provides modified and/or mutated versions of histone lysine methyltransferases to facilitate characterization, including polypeptides labeled with isotopic or heavy atoms and fusion proteins.

In general, the biological activity of a polypeptide of the invention is expected to be characterized as having a biochemical activity substantially similar to that of a SET domain protein, and in certain embodiments, a histone lysine methyltransferase, as described in more detail below. This assignment has been confirmed by solving the X-ray structure of DIM-5 and the DIM-5-peptide-cofactor complex.

All of the information learned and described herein about SET domain proteins may be used to design modulators of one or more of their biological activities. In particular, information critical to the design of therapeutic and diagnostic molecules, including, for example, the protein domain, druggable regions, structural information, and the like for SET domain proteins, and in certain embodiments, histone lysine methyltransferases, is now available or attainable as a result of the ability to prepare, purify and characterize them, and domains, fragments, variants and derivatives thereof.

In other aspects of the invention, structural and functional information about SET domain proteins, and in certain embodiments, histone lysine methyltransferases, has and will be obtained. Such information, for example, may be incorporated into databases containing information on SET domain proteins, and in certain embodiments, histone lysine methyltransferases, as well as other polypeptide targets from other microbial species. Such databases will provide investigators with a powerful tool to analyze the SET domain proteins, and in certain embodiments, histone lysine methyltransferases, and aid in the rapid discovery and design of therapeutic and diagnostic molecules.

In another aspect, modulators, inhibitors, agonists or antagonists against the SET domain proteins, and in certain embodiments, histone lysine methyltransferases, or biological complexes containing them, or orthologues thereto, may be used to treat any disease or other treatable condition of a patient (including humans and animals), for example, cancer, other proliferative diseases, syndromes such as Wolf-Hirschhorn or Prader-Willi, and fungal infections.

The present invention further allows relationships between polypeptides from the same and multiple species to be compared by isolating and studying the various SET domain proteins, and in certain embodiments, histone lysine methyltransferases. By such comparison studies, which may involve multi-variable analysis as appropriate, it is possible to identify drugs that will affect multiple species or drugs that will affect one or a few species. In such a manner, so-called “wide spectrum” and “narrow spectrum” anti-infectives may be identified. Alternatively, drugs that are selective for one or more bacterial or other non-mammalian species, and not for one or more mammalian species (especially human), may be identified (and vice-versa). In other embodiments, drugs that are selective for mammalian species, such as those for treating cancer, other proliferative diseases, or syndromes such as Wolf-Hirschhom or Prader-Willi, may be identified.

In other embodiments, the invention contemplates kits including the subject nucleic acids, polypeptides, crystallized polypeptides, antibodies, and other subject materials, and optionally instructions for their use. Uses for such kits include, for example, diagnostic and therapeutic applications.

The embodiments and practices of the present invention, other embodiments, and their features and characteristics, will be apparent from the description, figures and claims that follow, with all of the claims hereby being incorporated by this reference into this Summary.

### BRIEF DESCRIPTION OF THE FIGURES

FIG. 1A depicts the domain structure of SET HKMT family proteins. The DIM-5 protein (the smallest known member of the Suv39 family) contains four segments: a weakly conserved amino-terminal region (light blue), a pre-SET domain (yellow) containing nine invariant cysteines, the SET region (green) containing signature motifs NHXCXPN and ELXFDY (magenta), and the post-SET domain (gray) containing three invariant cysteines. FIG. 1B depicts the GRASP (Nicholls et al., 1991) surface charge distribution (blue for positive, red for negative, white for neutral) for the DIM-5 ternary complex. The H3 peptide and AdoHcy are shown as stick models. FIG. 1C depicts a diagram of the DIM-5 ternary complex having the same coloring scheme as FIG. 1A. The pre-SET residues (yellow) form a Zn3Cys9 triangular zinc cluster. The SET residues (green) and the N-terminal region are folded into six b-sheets surrounding a knot-like structure (magenta). The post-SET residues (grey) bind the fourth zinc atom, adjacent to the substrate H3 peptide (red) and AdoHcy (blue). FIG. 1D depicts the substrate H3 peptide (red), superimposed on an omit electron density contoured at 4.0s (orange), is inserted as a parallel b strand (red in FIG. 2C) between two DIM-5 strands, b10 (green) and b18 (magenta). The side chain density for H3 Arg-8 is complete at lower contour levels (2.5s in Fobs-Fcal and 0.8s in 2Fobs-Fcal).

FIG. 2A depicts various aspects of the DIM-5 methylation mechanism. FIG. 3A depicts a view of the post-SET zinc ion and the AdoHcy binding site. The zinc ion is presented as a red ball, coordinated by four cysteines, C244 (magenta) and C306XC308X4C313 (grey). AdoHcy is superimposed onto a difference electron density map contoured at 4.0o (orange). Dashed lines indicate the hydrogen bonds. FIG. 2B depicts a close-up view of the H3 peptide binding site with Lys-9 inserted into a channel. FIG. 2C depicts the target Lys binding site (stereo). The arrow indicates the movement of the methyl group transferred from the AdoMet methylsulfonium group to the target amino group. FIG. 2D depicts a graph of DIM-5 activity (LogCPM) as a function of pH. FIG. 2E depicts AdoHcy bound in a large surface pocket, allowing for processive methylation. The green ellipse indicates the location where the AdoHcy homocysteine moiety binds in the peptide-free structure (Zhang et al., 2002).

FIG. 3 depicts various aspects of the enzymatic properties of recombinant DIM-5 and SET7/9 mutants. FIG. 3A depicts the activities of DIM-5 and SET7/9 mutants using histone substrate (top), and AdoMet crosslinking experiments of DIM-5 showing flurograph (middle) and coomassie stain (bottom). FIG. 3B depicts a structure-based sequence alignment of DIM-5 and SET7/9. Secondary structures shown are based on Wilson et al. (2002) and Zhang et al. (2002). Vertical bars indicate residues that align spatially. Residues identical (black background) or similar (grey background) between the two enzymes, as well as the post-SET region of DIM-5, are highlighted. Numbered residues are described in the text. C-terminal hydrophobic residues of DIM-5 are underlined. FIG. 3C depicts a structural comparison of active sites in the ternary DIM-5 (in color) and binary SET7/9-AdoHcy (in black) (PDB 1MT6 (Jacobs et al., 2002)). The bound peptide in DIM-5 is represented as a solid electron density (orange), with the target Lys surrounded by either two Tyr and one Phe (DIM-5) or three Tyr (SET7/9).

FIGS. 4A and 4B depicts the results of mass spectrometry analysis of the kinetic progression of the methylation reaction. In FIG. 4A, the top panels are representative spectra at various time points for WT DIM-5, its F281Y variant, WT SET7/9, and its Y305F variant. The peaks for unmodified (Um) substrate, mono-, di-, and tri-methylated products are labeled. Unlabeled minor peaks correspond to the sodium adducts of the major peaks (+23 Da). The bottom panels show the full time courses. FIG. 4B depicts spectra for three DIM-5 mutants having severely impaired catalytic activity but with normal product specificity.

FIG. 5A depicts the results of analysis of zinc content of DIM-5 with and without EDTA treatment. DIM-5 protein was incubated with 20 mM EDTA for 2 days, at which time HKMT activity was no longer detectable. To remove zinc bound to EDTA, the protein was either dialyzed (Exp1) or subjected to gel filtration chromatography (Exp2) against 20 mM glycine (pH 9.8), 5% glycerol, 0.5 mM DTT and 1 mM EDTA. FIG. 5B depicts the results of incubation of purified DIM-5 protein (1 mg/ml in 20 mM glycine pH 9.8, 5% glycerol) with various concentrations of 1,10-phenanthroline or EDTA for the indicated times at 4° C. The enzyme was diluted 80-fold and assayed for HKMT activity under standard conditions, except that no DTT was present. FIG. 5B depicts fluorographic results of AdoMet crosslinking in the presence of EDTA.

FIG. 6 lists the atomic structure coordinates for a polypeptide of the invention derived from x-ray diffraction from a crystal of such polypeptide, as described in more detail below. There are multiple pages to FIG. 6, labeled 1, 2, 3, etc. The information in such Figure is presented in the following tabular format, with a generic entry provided as an example:

| Record | | | | Residue | | | | | |
|---|---|---|---|---|---|---|---|---|---|
| Header | No. | Atom Type | Residue | Number | X | Y | Z | OCC | B |
| ATOM 1 | 1 | CB | HIS | 1 | 4.497 | 15.607 | 34.172 | 1 | 70.54 |

In the table, “Record Header” describes the row type, such as “ATOM”. “No.” refers to the row number. The first “Atom Type” column refers to the atom whose coordinates are measured, with the first letter in the column identifying the atom by its elemental symbol and the subsequent letter defining the location of the atom in the amino acid residue or other molecule. “Residue” and “residue number” identifies the residue of the subject polypeptide. “X, Y, Z” crystallographically define the atomic position of the atom measured. “Occ” is an occupancy factor that refers to the fraction of the molecules in which each atom occupies the position specified by the coordinates. A value of “1” indicates that each atom has the same conformation, i.e., the same position, in all molecules of the crystal. “B” is a thermal factor that is related to the root mean square deviation in the position of the atom around the given atomic coordinate.

FIG. 7 depicts the amino acid sequence (SEQ ID NO: 1) of DIM-5.

### DETAILED DESCRIPTION OF THE INVENTION

A. General

We observed that the post-SET domain may form a zinc binding site that is essential for catalytic activity and results in sensitivity to metal chelators. In order to define the role of the post-SET domain and to establish the interactions between the histone lysine methyltransferase protein, cofactors, and substrate, we determined the structure of a ternary complex of DIM-5 from N. crassa (a histone H3 lysine 9 MTase), methyl-donor product AdoHcy, and a histone peptide. Further, we carried out mutational and biochemical studies to illuminate the mechanism of this enzyme.

We found that the highly conserved residues of the pre-SET region form a triangular zinc cluster, Zn₃Cys₉, and that residues in the SET domain are essential for the cofactor-binding and methyl-transfer. The SET domain also has a cleft that is the likely binding site for the methylatable amino-terminal tail of histone H3. The post-SET region may also contribute to cofactor binding and catalysis by forming another zinc binding site in conjunction with a conserved cysteine in the knot-like structure near the active site. The three-Cys domain should be relevant to the large number of SET proteins sporting the post-SET domain including members of the SUV39, SET1 and SET2 families. Finally, this work provides an example of completely unrelated, structurally-distinct, proteins that carry out a common function, in this case AdoMet-dependent methyl transfer. Thus, these results provide insight into a common fold and the catalytic mechanism for the SUV39 family histone H3 lysine 9 Mtases, and potentially for histone lysine methyltransferases in general.

We also determined the structural basis of product specificity by engineering variants of DIM-5 and SET7/9 that have altered specificity. Variants that differ in production of mono-, di- or tri-methyl lysine provides a resource to investigate the possibility that different methylation states on a given lysine may signal differently. For example, the F281Y mutant of DIM-5 can be used to test whether trimethyl Lys-9 is essential in signaling DNA methylation. The predominantly euchromatic H3 Lys-9 MTase G9a is a strong di-MTase and a much weaker tri-MTase. It would be interesting to examine the effect of converting G9a to either a mono- or a tri-MTase.

B. Definitions

For convenience, before further description of the present invention, certain terms employed in the specification, examples, and appendant claims are collected here. These definitions should be read in light of the entire disclosure and understood as by a person of skill in the art.

The articles “a” and “an” are used herein to refer to one or to more than one (i.e., to at least one) of the grammatical object of the article. By way of example, “an element” means one element or more than one element.

The term “amino acid” is intended to embrace all molecules, whether natural or synthetic, which include both an amino functionality and an acid functionality and capable of being included in a polymer of naturally-occurring amino acids. Exemplary amino acids include naturally-occurring amino acids; analogs, derivatives and congeners thereof; amino acid analogs having variant side chains; and all stereoisomers of any of any of the foregoing.

The term “binding” refers to an association, which may be a stable association, between two molecules, e.g., a SET domain protein and a binding partner, due to, for example, electrostatic, hydrophobic, ionic and/or hydrogen-bond interactions under physiological conditions.

The term “chemical entity,” as used herein, refers to chemical compounds, complexes of two or more chemical compounds, and fragments of such compounds or complexes. In certain instances, it is desirable to use chemical entities exhibiting a wide range of structural and functional diversity, such as compounds exhibiting different shapes (e.g., flat aromatic rings(s), puckered aliphatic rings(s), straight and branched chain aliphatics with single, double, or triple bonds) and diverse functional groups (e.g., carboxylic acids, esters, ethers, amines, aldehydes, ketones, and various heterocyclic rings).

The term “complex” refers to an association between at least two moieties (e.g. chemical or biochemical) that have an affinity for one another. Examples of complexes include associations between antigen/antibodies, lectin/carbohydrate, target polynucleotide/probe oligonucleotide, antibody/anti-antibody, receptor/ligand, enzyme/ligand, polypeptide/polypeptide, polypeptide/polynucleotide, polypeptide/co-factor, polypeptide/substrate, polypeptide/modulator, polypeptide/small molecule, and the like. “Member of a complex” refers to one moiety of the complex, such as an antigen or ligand. “Protein complex” or “polypeptide complex” refers to a complex comprising at least one polypeptide.

The term “compound” as used herein refers to any agent, molecule, complex, or other entity that may be capable of binding to or interacting with a protein. The term “test compound” refers to a molecule to be tested by one or more screening method(s) as a putative modulator of a SET domain protein, for example, a HKMT, or other biological entity or process. A test compound is usually not known to bind to a target of interest. The term “control test compound” refers to a compound known to bind to the target (e.g., a known agonist, antagonist, partial agonist or inverse agonist). The term “test compound” does not include a chemical added as a control condition that alters the function of the target to determine signal specificity in an assay. Such control chemicals or conditions include chemicals that 1) nonspecifically or substantially disrupt protein structure (e.g., denaturing agents (e.g., urea or guanidinium), chaotropic agents, sulfhydryl reagents (e.g., dithiothreitol and b-mercaptoethanol), and proteases), 2) generally inhibit cell metabolism (e.g., mitochondrial uncouplers) and 3) non-specifically disrupt electrostatic or hydrophobic interactions of a protein (e.g., high salt concentrations, or detergents at concentrations sufficient to non-specifically disrupt hydrophobic interactions). Further, the term “test compound” also does not include compounds known to be unsuitable for a therapeutic use for a particular indication due to toxicity of the subject. In certain embodiments, various predetermined concentrations of test compounds are used for screening such as 0.01 mM, 0.1 mM, 1.0 mM, and 10.0 mM. Examples of test compounds include, but are not limited to, peptides, nucleic acids, carbohydrates, and small molecules. The term “novel test compound” refers to a test compound that is not in existence as of the filing date of this application. In certain assays using novel test compounds, the novel test compounds comprise at least about 50%, 75%, 85%, 90%, 95% or more of the test compounds used in the assay or in any particular trial of the assay.

The term “conserved residue” refers to an amino acid that is a member of a group of amino acids having certain common properties. The term “conservative amino acid substitution” refers to the substitution (conceptually or otherwise) of an amino acid from one such group with a different amino acid from the same group. A functional way to define common properties between individual amino acids is to analyze the normalized frequencies of amino acid changes between corresponding proteins of homologous organisms (Schulz, G. E. and R. H. Schirmer., Principles of Protein Structure, Springer-Verlag). According to such analyses, groups of amino acids may be defined where amino acids within a group exchange preferentially with each other, and therefore resemble each other most in their impact on the overall protein structure (Schulz, G. E. and R. H. Schirmer, Principles of Protein Structure, Springer-Verlag). One example of a set of amino acid groups defined in this manner include: (i) a charged group, consisting of Glu and Asp, Lys, Arg and His, (ii) a positively-charged group, consisting of Lys, Arg and His, (iii) a negatively-charged group, consisting of Glu and Asp, (iv) an aromatic group, consisting of Phe, Tyr and Trp, (v) a nitrogen ring group, consisting of His and Trp, (vi) a large aliphatic nonpolar group, consisting of Val, Leu and Ile, (vii) a slightly-polar group, consisting of Met and Cys, (viii) a small-residue group, consisting of Ser, Thr, Asp, Asn, Gly, Ala, Glu, Gln and Pro, (ix) an aliphatic group consisting of Val, Leu, Ile, Met and Cys, and (x) a small hydroxyl group consisting of Ser and Thr.

The term “domain”, when used in connection with a polypeptide, refers to a specific region within such polypeptide that comprises a particular structure or mediates a particular function. In the typical case, a domain of a SET domain protein, for example a HKMT protein, is a fragment of the polypeptide. In certain instances, a domain is a structurally stable domain, as evidenced, for example, by mass spectroscopy, or by the fact that a modulator may bind to a druggable region of the domain.

The term “druggable region”, when used in reference to a polypeptide, nucleic acid, complex and the like, refers to a region of a SET domain protein, for example a HKMT protein, which is a target or is a likely target for binding an agent that reduces or inhibits viral infectivity. For a polypeptide, a druggable region generally refers to a region wherein several amino acids of a polypeptide would be capable of interacting with an agent. For a polypeptide or complex thereof, exemplary druggable regions including binding pockets and sites, interfaces between domains of a polypeptide or complex, surface grooves or contours or surfaces of a polypeptide or complex which are capable of participating in interactions with another molecule, such as a cell membrane. In particular, a subject druggable region is the zinc binding site of the pre-SET domain.

A druggable region may be described and characterized in a number of ways. For example, a druggable region may be characterized by some or all of the amino acids that make up the region, or the backbone atoms thereof, or the side chain atoms thereof (optionally with or without the Ca atoms). Alternatively, a druggable region may be characterized by comparison to other regions on the same or other molecules. For example, the term “affinity region” refers to a druggable region on a molecule (such as a a SET domain protein, for example a HKMT protein) that is present in several other molecules, in so much as the structures of the same affinity regions are sufficiently the same so that they are expected to bind the same or related structural analogs. An example of an affinity region is an ATP-binding site of a protein kinase that is found in several protein kinases (whether or not of the same origin). The term “selectivity region” refers to a druggable region of a molecule that may not be found on other molecules, in so much as the structures of different selectivity regions are sufficiently different so that they are not expected to bind the same or related structural analogs. An exemplary selectivity region is a catalytic domain of a protein kinase that exhibits specificity for one substrate. In certain instances, a single modulator may bind to the same affinity region across a number of proteins that have a substantially similar biological function, whereas the same modulator may bind to only one selectivity region of one of those proteins.

Continuing with examples of different druggable regions, the term “undesired region” refers to a druggable region of a molecule that upon interacting with another molecule results in an undesirable affect. For example, a binding site that oxidizes the interacting molecule (such as P-450 activity) and thereby results in increased toxicity for the oxidized molecule may be deemed a “undesired region”. Other examples of potential undesired regions includes regions that upon interaction with a drug decrease the membrane permeability of the drug, increase the excretion of the drug, or increase the blood brain transport of the drug. It may be the case that, in certain circumstances, an undesired region will no longer be deemed an undesired region because the affect of the region will be favorable, e.g., a drug intended to treat a brain condition would benefit from interacting with a region that resulted in increased blood brain transport, whereas the same region could be deemed undesirable for drugs that were not intended to be delivered to the brain.

When used in reference to a druggable region, the “selectivity” or “specificity” of a molecule such as a modulator to a druggable region may be used to describe the binding between the molecule and a druggable region. For example, the selectivity of a modulator with respect to a druggable region may be expressed by comparison to another modulator, using the respective values of Kd (i.e., the dissociation constants for each modulator-druggable region complex) or, in cases where a biological effect is observed below the Kd, the ratio of the respective EC50's (i.e., the concentrations that produce 50% of the maximum response for the modulator interacting with each druggable region).

The term “gene” refers to a nucleic acid comprising an open reading frame encoding a polypeptide having exon sequences and optionally intron sequences. The term “intron” refers to a DNA sequence present in a given gene which is not translated into protein and is generally found between exons.

The term “having substantially similar biological activity”, when used in reference to two polypeptides, refers to a biological activity of a first polypeptide which is substantially similar to at least one of the biological activities of a second polypeptide. A substantially similar biological activity means that the polypeptides carry out a similar function, e.g., a similar enzymatic reaction or a similar physiological process, etc. For example, two homologous proteins may have a substantially similar biological activity if they are involved in a similar enzymatic reaction, e.g., they are both kinases which catalyze phosphorylation of a substrate polypeptide, however, they may phosphory different regions on the same protein substrate or different substrate proteins altogether. Alternatively, two homologous proteins may also have a substantially similar biological activity if they are both involved in a similar physiological process, e.g., transcription. For example, two proteins may be transcription factors, however, they may bind to different DNA sequences or bind to different polypeptide interactors. Substantially similar biological activities may also be associated with proteins carrying out a similar structural role, for example, two membrane proteins.

The term “histone lysine methyltransferase” or “HKMT” refers to a protein having histone lysine methyltransferase activity and that comprises at least a SET domain. The term “SET domain protein” thus encompasses the histone lysine methyltransferases. Such histone lysine methyltransferases may have more specific characteristics, allowing them to be subclassified, for example, the metal-dependent histone lysine methyltransferases. All of such subclasses and variants are encompassed within this definition. The full-length amino acid sequence of sequence of DIM-5 from N. crassa (a histone H3 lysine 9 MTase) is SEQ ID NO: 1 of FIG. 7. The term “histone lysine methyltransferase” encompasses portions or fragments of, homologs of, orthologs of, variants of, isoforms of, and allelic variants of SEQ ID NO: 1. It further encompasses other sequences having histone lysine methyltransferase activity and having at least about 80% identity to the SET domain, pre-SET domain, and/or post-SET domain of the DIM-5 sequence, such as, for example eukaryotic H3 Lys-9 MTase G9a, and portions or fragments of, homologs of, orthologs of, variants of, isoforms of, and allelic variants thereof. Such HKMT proteins and protein fragments may be produced by any method known in the art, including purification from natural sources, recombinant methods, and peptide synthesis. Such proteins may be produced in a soluble form, e.g. lacking transmembrane regions, or solubilized using appropriate reagents (such as a detergent).

The term “isolated polypeptide” refers to a polypeptide, in certain embodiments prepared from recombinant DNA or RNA, or of synthetic origin, or some combination thereof, which (1) is not associated with proteins that it is normally found with in nature, (2) is isolated from the cell in which it occurs, (3) is isolated free of other proteins from the same cellular source, (4) is expressed by a cell from a different species, or (5) does not occur in nature.

The term “isolated nucleic acid” refers to a polynucleotide of genomic, cDNA, or synthetic origin or some combination there of, which (1) is not associated with the cell in which the “isolated nucleic acid” is found in nature, or (2) is operably linked to a polynucleotide to which it is not linked in nature.

The term “mammal” is known in the art, and exemplary mammals include humans, primates, bovines, porcines, canines, felines, and rodents (e.g., mice and rats).

The term “modulation”, when used in reference to a functional property or biological activity or process (e.g., enzyme activity or receptor binding), refers to the capacity to either up regulate (e.g., activate or stimulate), down regulate (e.g., inhibit or suppress) or otherwise change a quality of such property, activity or process. In certain instances, such regulation may be contingent on the occurrence of a specific event, such as activation of a signal transduction pathway, and/or may be manifest only in particular cell types.

The term “modulator” refers to a polypeptide, nucleic acid, macromolecule, complex, molecule, small molecule, compound, species or the like (naturally-occurring or non-naturally-occurring), or an extract made from biological materials such as bacteria, plants, fungi, or animal cells or tissues, that may be capable of causing modulation. Modulators may be evaluated for potential activity as modulators or activators (directly or indirectly) of a functional property, biological activity or process, or combination of them, (e.g., agonist, partial antagonist, partial agonist, inverse agonist, antagonist, anti-microbial agents, modulators of microbial infection or proliferation, and the like) by inclusion in assays. In such assays, many modulators may be screened at one time. The activity of a modulator may be known, unknown or partially known.

The term “motif” refers to an amino acid sequence that is commonly found in a protein of a particular structure or function. Typically, a consensus sequence is defined to represent a particular motif. The consensus sequence need not be strictly defined and may contain positions of variability, degeneracy, variability of length, etc. The consensus sequence may be used to search a database to identify other proteins that may have a similar structure or function due to the presence of the motif in its amino acid sequence. For example, on-line databases may be searched with a consensus sequence in order to identify other proteins containing a particular motif. Various search algorithms and/or programs may be used, including FASTA, BLAST or ENTREZ. FASTA and BLAST are available as a part of the GCG sequence analysis package (University of Wisconsin, Madison, Wis.). ENTREZ is available through the National Center for Biotechnology Information, National Library of Medicine, National Institutes of Health, Bethesda, Md.

The term “natural ligand” refers to a naturally-occurring co-factor, substrate, or other molecule that binds a SET domain protein. For example, HKMT SET domain proteins have at least the natural ligands zinc, histone polypeptides, and AdoMet.

The term “naturally-occurring”, as applied to an object, refers to the fact that an object may be found in nature. For example, a polypeptide or polynucleotide sequence that is present in an organism (including bacteria) that may be isolated from a source in nature and which has not been intentionally modified by man in the laboratory is naturally-occurring.

The term “nucleic acid” refers to a polymeric form of nucleotides, either ribonucleotides or deoxynucleotides or a modified form of either type of nucleotide. The terms should also be understood to include, as equivalents, analogs of either RNA or DNA made from nucleotide analogs, and, as applicable to the embodiment being described, single-stranded (such as sense or antisense) and double-stranded polynucleotides.

The term “polypeptide”, and the terms “protein” and “peptide” which are used interchangeably herein, refers to a polymer of amino acids. Exemplary polypeptides include gene products, naturally-occurring proteins, homologs, orthologs, paralogs, fragments, and other equivalents, variants and analogs of the foregoing.

The terms “polypeptide fragment” or “fragment”, when used in reference to a reference polypeptide, refers to a polypeptide in which amino acid residues are deleted as compared to the reference polypeptide itself, but where the remaining amino acid sequence is usually identical to the corresponding positions in the reference polypeptide. Such deletions may occur at the amino-terminus or carboxy-terminus of the reference polypeptide, or alternatively both. Fragments typically are at least 5, 6, 8 or 10 amino acids long, at least 14 amino acids long, at least 20, 30, 40 or 50 amino acids long, at least 75 amino acids long, or at least 100, 150, 200, 300, 500 or more amino acids long. A fragment can retain one or more of the biological activities of the reference polypeptide. In certain embodiments, a fragment may comprise a druggable region, and optionally additional amino acids on one or both sides of the druggable region, which additional amino acids may number from 5, 10, 15, 20, 30, 40, 50, or up to 100 or more residues. Further, fragments can include a sub-fragment of a specific region, which sub-fragment retains a function of the region from which it is derived. In another embodiment, a fragment may have immunogenic properties.

The term “purified” refers to an object species that is the predominant species present (i.e., on a molar basis it is more abundant than any other individual species in the composition). A “purified fraction” is a composition wherein the object species comprises at least about 50 percent (on a molar basis) of all species present. In making the determination of the purity of a species in solution or dispersion, the solvent or matrix in which the species is dissolved or dispersed is usually not included in such determination; instead, only the species (including the one of interest) dissolved or dispersed are taken into account. Generally, a purified composition will have one species that comprises more than about 80 percent of all species present in the composition, more than about 85%, 90%, 95%, 99% or more of all species present. The object species may be purified to essential homogeneity (contaminant species cannot be detected in the composition by conventional detection methods) wherein the composition consists essentially of a single species. A skilled artisan may purify a SET domain protein, for example a histone lysine methyltransferase, using standard techniques for protein purification in light of the teachings herein. Purity of a polypeptide may be determined by a number of methods known to those of skill in the art, including for example, amino-terminal amino acid sequence analysis, gel electrophoresis, mass-spectrometry analysis and the methods described in the Exemplification section herein.

The terms “recombinant protein” or “recombinant polypeptide” refer to a polypeptide which is produced by recombinant DNA techniques. An example of such techniques includes the case when DNA encoding the expressed protein is inserted into a suitable expression vector which is in turn used to transform a host cell to produce the protein or polypeptide encoded by the DNA.

The term “SET domain protein” refers to any protein (full-length or fragment) having the approximately 130-residue conserved SET domain motif, and optionally a pre-SET and post-SET domain motif.

The term “small molecule” refers to a compound, which has a molecular weight of less than about 5 kD, less than about 2.5 kD, less than about 1.5 kD, or less than about 0.9 kD. Small molecules may be, for example, nucleic acids, peptides, polypeptides, peptide nucleic acids, peptidomimetics, carbohydrates, lipids or other organic (carbon containing) or inorganic molecules. Many pharmaceutical companies have extensive libraries of chemical and/or biological mixtures, often fungal, bacterial, or algal extracts, which can be screened with any of the assays of the invention. The term “small organic molecule” refers to a small molecule that is often identified as being an organic or medicinal compound, and does not include molecules that are exclusively nucleic acids, peptides or polypeptides. The term “specifically hybridizes” refers to detectable and specific nucleic acid binding. Polynucleotides, oligonucleotides and nucleic acids of the invention selectively hybridize to nucleic acid strands under hybridization and wash conditions that minimize appreciable amounts of detectable binding to nonspecific nucleic acids. Stringent conditions may be used to achieve selective hybridization conditions as known in the art and discussed herein. Generally, the nucleic acid sequence homology between the polynucleotides, oligonucleotides, and nucleic acids of the invention and a nucleic acid sequence of interest will be at least 30%, 40%, 50%, 60%, 70%, 80%, 85%, 90%, 95%, 98%, 99%, or more. In certain instances, hybridization and washing conditions are performed under stringent conditions according to conventional hybridization procedures and as described further herein.

The terms “stringent conditions” or “stringent hybridization conditions” refer to conditions which promote specific hydribization between two complementary polynucleotide strands so as to form a duplex. Stringent conditions may be selected to be about 5° C. lower than the thermal melting point (Tm) for a given polynucleotide duplex at a defined ionic strength and pH. The length of the complementary polynucleotide strands and their GC content will determine the Tm of the duplex, and thus the hybridization conditions necessary for obtaining a desired specificity of hybridization. The Tm is the temperature (under defined ionic strength and pH) at which 50% of the a polynucleotide sequence hybridizes to a perfectly matched complementary strand. In certain cases it may be desirable to increase the stringency of the hybridization conditions to be about equal to the Tm for a particular duplex.

A variety of techniques for estimating the Tm are available. Typically, G-C base pairs in a duplex are estimated to contribute about 3° C. to the Tm, while A-T base pairs are estimated to contribute about 2° C., up to a theoretical maximum of about 80-100° C. However, more sophisticated models of Tm are available in which G-C stacking interactions, solvent effects, the desired assay temperature and the like are taken into account. For example, probes can be designed to have a dissociation temperature (Td) of approximately 60° C., using the formula: Td=(((((3×#GC)+(2×#AT))×37)−562)/#bp)−5; where #GC, #AT, and #bp are the number of guanine-cytosine base pairs, the number of adenine-thymine base pairs, and the number of total base pairs, respectively, involved in the formation of the duplex.

Hybridization may be carried out in 5×SSC, 4×SSC, 3×SSC, 2×SSC, 1×SSC or 0.2×SSC for at least about 1 hour, 2 hours, 5 hours, 12 hours, or 24 hours. The temperature of the hybridization may be increased to adjust the stringency of the reaction, for example, from about 25° C. (room temperature), to about 45° C., 50° C., 55° C., 60° C., or 65° C. The hybridization reaction may also include another agent affecting the stringency, for example, hybridization conducted in the presence of 50% formamide increases the stringency of hybridization at a defined temperature.

The hybridization reaction may be followed by a single wash step, or two or more wash steps, which may be at the same or a different salinity and temperature. For example, the temperature of the wash may be increased to adjust the stringency from about 25° C. (room temperature), to about 45° C., 50° C., 55° C., 60° C., 65° C., or higher. The wash step may be conducted in the presence of a detergent, e.g., 0.1 or 0.2% SDS. For example, hybridization may be followed by two wash steps at 65° C. each for about 20 minutes in 2×SSC, 0.1% SDS, and optionally two additional wash steps at 65° C. each for about 20 minutes in 0.2×SSC, 0.1% SDS.

Exemplary stringent hybridization conditions include overnight hybridization at 65° C. in a solution comprising, or consisting of, 50% formamide, 10× Denhardt (0.2% Ficoll, 0.2% Polyvinylpyrrolidone, 0.2% bovine serum albumin) and 200 μg/ml of denatured carrier DNA, e.g., sheared salmon sperm DNA, followed by two wash steps at 65° C. each for about 20 minutes in 2×SSC, 0.1% SDS, and two wash steps at 65° C. each for about 20 minutes in 0.2×SSC, 0.1% SDS.

Hybridization may consist of hybridizing two nucleic acids in solution, or a nucleic acid in solution to a nucleic acid attached to a solid support, e.g., a filter. When one nucleic acid is on a solid support, a prehybridization step may be conducted prior to hybridization. Prehybridization may be carried out for at least about 1 hour, 3 hours or 10 hours in the same solution and at the same temperature as the hybridization solution (without the complementary polynucleotide strand).

Appropriate stringency conditions are known to those skilled in the art or may be determined experimentally by the skilled artisan. See, for example, Current Protocols in Molecular Biology, John Wiley & Sons, N.Y. (1989), 6.3.1-12.3.6; Sambrook et al., 1989, Molecular Cloning, A Laboratory Manual, Cold Spring Harbor Press, N.Y; S. Agrawal (ed.) Methods in Molecular Biology, volume 20; Tijssen (1993) Laboratory Techniques in biochemistry and molecular biology-hybridization with nucleic acid probes, e.g., part I chapter 2 “Overview of principles of hybridization and the strategy of nucleic acid probe assays”, Elsevier, N.Y.; and Tibanyenda, N. et al., Eur. J. Biochem. 139:19 (1984) and Ebel, S. et al., Biochem. 31:12083 (1992).

As applied to proteins, the term “substantial identity” means that two protein sequences, when optimally aligned, such as by the programs GAP or BESTFIT using default gap weights, typically share at least about 70 percent sequence identity, alternatively at least about 80, 85, 90, 95 percent sequence identity or more. In certain instances, residue positions that are not identical differ by conservative amino acid substitutions, which are described above.

The term “structural motif”, when used in reference to a polypeptide, refers to a polypeptide that, although it may have different amino acid sequences, may result in a similar structure, wherein by structure is meant that the motif forms generally the same tertiary structure, or that certain amino acid residues within the motif, or alternatively their backbone or side chains (which may or may not include the Cα atoms of the side chains) are positioned in a like relationship with respect to one another in the motif.

The term “therapeutically effective amount” refers to that amount of a modulator, drug or other molecule which is sufficient to effect treatment when administered to a subject in need of such treatment. The therapeutically effective amount will vary depending upon the subject and disease condition being treated, the weight and age of the subject, the severity of the disease condition, the manner of administration and the like, which can readily be determined by one of ordinary skill in the art.

The term “transfection” means the introduction of a nucleic acid, e.g., an expression vector, into a recipient cell, which in certain instances involves nucleic acid-mediated gene transfer. The term “transformation” refers to a process in which a cell's genotype is changed as a result of the cellular uptake of exogenous nucleic acid. For example, a transformed cell may express a recombinant form of a SET domain protein, for example a histone lysine methyltransferase, or antisense expression may occur from the transferred gene so that the expression of a naturally-occurring form of the gene is disrupted.

The term “transgene” means a nucleic acid sequence, which is partly or entirely heterologous to a transgenic animal or cell into which it is introduced, or, is homologous to an endogenous gene of the transgenic animal or cell into which it is introduced, but which is designed to be inserted, or is inserted, into the animal's genome in such a way as to alter the genome of the cell into which it is inserted (e.g., it is inserted at a location which differs from that of the natural gene or its insertion results in a knockout). A transgene may include one or more regulatory sequences and any other nucleic acids, such as introns, that may be necessary for optimal expression.

The term “transgenic animal” refers to any animal, for example, a mouse, rat or other non-human mammal, a bird or an amphibian, in which one or more of the cells of the animal contain heterologous nucleic acid introduced by way of human intervention, such as by transgenic techniques well known in the art. The nucleic acid is introduced into the cell, directly or indirectly, by way of deliberate genetic manipulation, such as by microinjection or by infection with a recombinant virus. The term genetic manipulation does not include classical cross-breeding, or in vitro fertilization, but rather is directed to the introduction of a recombinant DNA molecule. This molecule may be integrated within a chromosome, or it may be extrachromosomally replicating DNA. In the typical transgenic animals described herein, the transgene causes cells to express a recombinant form of a protein. However, transgenic animals in which the recombinant gene is silent are also contemplated.

The term “vector” refers to a nucleic acid capable of transporting another nucleic acid to which it has been linked. One type of vector which may be used in accord with the invention is an episome, i.e., a nucleic acid capable of extra-chromosomal replication. Other vectors include those capable of autonomous replication and expression of nucleic acids to which they are linked. Vectors capable of directing the expression of genes to which they are operatively linked are referred to herein as “expression vectors”. In general, expression vectors of utility in recombinant DNA techniques are often in the form of “plasmids” which refer to circular double stranded DNA molecules which, in their vector form are not bound to the chromosome. In the present specification, “plasmid” and “vector” are used interchangeably as the plasmid is the most commonly used form of vector. However, the invention is intended to include such other forms of expression vectors which serve equivalent functions and which become known in the art subsequently hereto.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the present invention.

C. Drug Discovery

C.1. Druggable Regions

Based in part on the structural information described in the Exemplification, we have identified novel druggable regions in histone lysine methyltransferase, a SET domain protein. In one aspect, the present invention is directed towards druggable regions of a SET domain protein and in certain embodiments, a histone lysine methyltransferase protein, comprising the majority of the amino acid residues contained in a subject druggable region. In one embodiment, this region comprises the pre-SET domain. In another embodiment, this region comprises the post-SET domain. In yet another embodiment, this region comprises the SET domain active site. In still other embodiments, wherein the SET domain protein is a histone methyltransferase, this region may comprise the AdoMet/AdoHcy cofactor binding pocket, peptide binding cleft, or target lysine binding site.

C.2. Modulators, Modulator Design and Screening Using the Subject Druggable Regions

In one aspect, the present invention provides methods of screening the subject druggable regions for potential modulators, as well as methods of designing such modulators. Modulators to polypeptides of the invention and other structurally related molecules, and complexes containing the same, may be identified and developed as set forth below and otherwise using techniques and methods known to those of skill in the art. The modulators of the invention may be employed, for instance, to inhibit and treat disease caused by an organism having a SET domain protein, or a disease in which a SET domain protein is involved.

Protein lysine methylation by SET domain proteins regulates chromatin structure, gene silencing, transcriptional activation, plant metabolism, and other processes in a variety of species. For example, the S. cerevisiae SET1 protein can catalyze di- and tri-methylation of H3 Lys-4, and tri-methylation of Lys-4 is thought to be present exclusively in active genes. Furthermore, DIM-5 of N. crassa generates primarily tri-methyl-Lys-9, which marks chromatin regions for DNA methylation. Human SET7/9 protein, on the other hand, generates exclusively mono-methyl Lys-4 of H3. SET domain proteins are also found in plants. Such differences between plant, yeast and fungal proteins may be exploited in the design of therapeutics to treat diseases or conditions associated with each type of protein, for example, an anti-fungal therapeutic or an herbicide.

Further, because SET proteins regulate chromatin structure, gene silencing, and transcriptional activation in mammals, SET proteins may be exploited in the design of therapeutics to treat diseases or conditions associated with disorders of chromatin structure, gene silencing, and transcriptional activation, such as many forms of cancer and other proliferative diseases, Wolf-Hirshhom syndrome, and Prader-Willi syndrome.

In another aspect, the present invention is directed toward modulators which bind with, interact with, modulate the function or activity of an active or binding site of, or otherwise modulate the binding of a substrate or cofactor to a SET domain protein, for example, a histone lysine methyltransferase. Such modulators by binding or interacting with at least one of the residues of a subject druggable region are expected to reduce or inhibit the binding of a substrate or cofactor. Likewise, such modulators may inhibit the movement or reaction of at least one of the residues comprising a subject druggable region. In certain embodiments, the present invention is directed towards modulators of the activity of a SET domain protein druggable region. In one embodiment, modulating is accomplished by contacting a compound with said druggable region. The contacting may result in binding of the compound to the region, and/or result in the modulation of the binding ability of a natural ligand of the region. For example, a compound may bind a druggable region and prevent the natural ligand from binding to or interacting with the region. In other embodiments, a compound may bind up or chelate the natural ligand, preventing it from binding to the region. In one embodiment, the modulator affects the binding of zinc atoms to a druggable region. The modulator may prevent the zinc atoms by binding to the druggable region by blocking access to or by chelating the zinc. In certain embodiments, the zinc binding site comprises the cysteines in the post-SET region of the protein.

A variety of methods for modulating SET domain protein activity using the modulators are contemplated by the present invention. For example, exemplary methods involve contacting a pathogenic organism having a SET domain protein with a modulator thought or shown to be effective against such pathogen.

For example, in one aspect, the present invention contemplates a method for treating a patient suffering from cancer, a proliferative disease, Wolf-Hirschhom syndrome, or Prader-Willi syndrome comprising administering to the patient an amount of a modulator effective to modulate the expression and/or activity of a SET domain protein. In certain instances, the animal is a human or a livestock animal such as a cow, pig, goat or sheep. The present invention further contemplates a method for treating a subject suffering from a microorganism-related disease or disorder, comprising administering to the subject having the condition a therapeutically effective amount of a molecule identified using one of the methods of the present invention.

In another embodiment, modulators of a SET domain protein, or biological complexes containing them, may be used in the manufacture of a medicament for any number of uses, including, for example, treating any disease or other treatable condition of a patient (including humans and animals).

(a) Modulator Design

A number of techniques can be used to screen, identify, select and design chemical entities capable of associating with a SET domain protein, for example a histone lysine methyltransferase, structurally homologous molecules, and other molecules. Knowledge of the structures for a histone lysine methyltransferase and a ternary complex thereof, determined in accordance with the methods described herein, permits the design and/or identification of molecules and/or other modulators which have a shape complementary to the conformation of a SET domain protein, for example a histone lysine methyltransferase, or more particularly, a druggable region thereof. It is understood that such techniques and methods may use, in addition to the exact structural coordinates and other information for a SET domain protein, for example a histone lysine methyltransferase, structural equivalents thereof described above (including, for example, those structural coordinates that are derived from the structural coordinates of amino acids contained in a druggable region as described above).

In one aspect, the method of drug design generally includes computationally evaluating the potential of a selected chemical entity to associate with any of the molecules or complexes of the present invention (or portions thereof). For example, this method may include the steps of (a) employing computational means to perform a fitting operation between the selected chemical entity and a druggable region of the molecule or complex; and (b) analyzing the results of said fitting operation to quantify the association between the chemical entity and the druggable region.

A chemical entity may be examined either through visual inspection or through the use of computer modeling using a docking program such as GRAM, DOCK, or AUTODOCK (Dunbrack et al., Folding & Design, 2:27-42 (1997)). This procedure can include computer fitting of chemical entities to a target to ascertain how well the shape and the chemical structure of each chemical entity will complement or interfere with the structure of a SET domain protein, for example a histone lysine methyltransferase (Bugg et al., Scientific American, December: 92-98 (1993); West et al., TIPS, 16:67-74 (1995)). Computer programs may also be employed to estimate the attraction, repulsion, and steric hindrance of the chemical entity to a druggable region, for example. Generally, the tighter the fit (e.g., the lower the steric hindrance, and/or the greater the attractive force) the more potent the chemical entity will be because these properties are consistent with a tighter binding constant. Furthermore, the more specificity in the design of a chemical entity the more likely that the chemical entity will not interfere with related proteins, which may minimize potential side-effects due to unwanted interactions.

A variety of computational methods for molecular design, in which the steric and electronic properties of druggable regions are used to guide the design of chemical entities, are known: Cohen et al. (1990) J. Med. Cam. 33: 883-894; Kuntz et al. (1982) J. Mol. Biol 161: 269-288; DesJarlais (1988) J. Med. Cam. 31: 722-729; Bartlett et al. (1989) Spec. Publ., Roy. Soc. Chem. 78: 182-196; Goodford et al. (1985) J. Med. Cam. 28: 849-857; and DesJarlais et al. J. Med. Cam. 29: 2149-2153. Directed methods generally fall into two categories: (1) design by analogy in which 3-D structures of known chemical entities (such as from a crystallographic database) are docked to the druggable region and scored for goodness-of-fit; and (2) de novo design, in which the chemical entity is constructed piece-wise in the druggable region. The chemical entity may be screened as part of a library or a database of molecules. Databases which may be used include ACD (Molecular Designs Limited), NCI (National Cancer Institute), CCDC (Cambridge Crystallographic Data Center), CAST (Chemical Abstract Service), Derwent (Derwent Information Limited), Maybridge (Maybridge Chemical Company Ltd), Aldrich (Aldrich Chemical Company), DOCK (University of California in San Francisco), and the Directory of Natural Products (Chapman & Hall). Computer programs such as CONCORD (Tripos Associates) or DB-Converter (Molecular Simulations Limited) can be used to convert a data set represented in two dimensions to one represented in three dimensions.

Chemical entities may be tested for their capacity to fit spatially with a druggable region or other portion of a target protein. As used herein, the term “fits spatially” means that the three-dimensional structure of the chemical entity is accommodated geometrically by a druggable region. A favorable geometric fit occurs when the surface area of the chemical entity is in close proximity with the surface area of the druggable region without forming unfavorable interactions. A favorable complementary interaction occurs where the chemical entity interacts by hydrophobic, aromatic, ionic, dipolar, or hydrogen donating and accepting forces. Unfavorable interactions may be steric hindrance between atoms in the chemical entity and atoms in the druggable region.

If a model of the present invention is a computer model, the chemical entities may be positioned in a druggable region through computational docking. If, on the other hand, the model of the present invention is a structural model, the chemical entities may be positioned in the druggable region by, for example, manual docking. As used herein the term “docking” refers to a process of placing a chemical entity in close proximity with a druggable region, or a process of finding low energy conformations of a chemical entity/druggable region complex.

In an illustrative embodiment, the design of potential modulator begins from the general perspective of shape complimentary for the druggable region of a SET domain protein, for example a histone lysine methyltransferase, and a search algorithm is employed which is capable of scanning a database of small molecules of known three-dimensional structure for chemical entities which fit geometrically with the target druggable region. Most algorithms of this type provide a method for finding a wide assortment of chemical entities that are complementary to the shape of a druggable region of a SET domain protein, for example a histone lysine methyltransferase. Each of a set of chemical entities from a particular data-base, such as the Cambridge Crystallographic Data Bank (CCDB) (Allen et al. (1973) J. Chem. Doc. 13: 119), is individually docked to the druggable region of a SET domain protein, for example a histone lysine methyltransferase, in a number of geometrically permissible orientations with use of a docking algorithm. In certain embodiments, a set of computer algorithms called DOCK, can be used to characterize the shape of invaginations and grooves that form the active sites and recognition surfaces of the druggable region (Kuntz et al. (1982) J. Mol. Biol 161: 269-288). The program can also search a database of small molecules for templates whose shapes are complementary to particular binding sites of a SET domain protein, for example a histone lysine methyltransferase, (DesJarlais et al. (1988) J Med Chem 31: 722-729).

The orientations are evaluated for goodness-of-fit and the best are kept for further examination using molecular mechanics programs, such as AMBER or CHARMM. Such algorithms have previously proven successful in finding a variety of chemical entities that are complementary in shape to a druggable region.

Goodford (1985, J Med Chem 28:849-857) and Boobbyer et al. (1989, J Med Chem 32:1083-1094) have produced a computer program (GRID) which seeks to determine regions of high affinity for different chemical groups (termed probes) of the druggable region. GRID hence provides a tool for suggesting modifications to known chemical entities that might enhance binding. It may be anticipated that some of the sites discerned by GRID as regions of high affinity correspond to “pharmacophoric patterns” determined inferentially from a series of known ligands. As used herein, a “pharmacophoric pattern” is a geometric arrangement of features of chemical entities that is believed to be important for binding. Attempts have been made to use pharmacophoric patterns as a search screen for novel ligands (Jakes et al. (1987) J Mol Graph 5:41-48; Brint et al. (1987) J Graph 5:49-56; Jakes et al. (1986) J Mol Graph 4:12-20).

Yet a further embodiment of the present invention utilizes a computer algorithm such as CLIX which searches such databases as CCDB for chemical entities which can be oriented with the druggable region in a way that is both sterically acceptable and has a high likelihood of achieving favorable chemical interactions between the chemical entity and the surrounding amino acid residues. The method is based on characterizing the region in terms of an ensemble of favorable binding positions for different chemical groups and then searching for orientations of the chemical entities that cause maximum spatial coincidence of individual candidate chemical groups with members of the ensemble. The algorithmic details of CLIX is described in Lawrence et al. (1992) Proteins 12:31-41.

In this way, the efficiency with which a chemical entity may bind to or interfere with a druggable region may be tested and optimized by computational evaluation. For example, for a favorable association with a druggable region, a chemical entity must preferably demonstrate a relatively small difference in energy between its bound and fine states (i.e., a small deformation energy of binding). Thus, certain, more desirable chemical entities will be designed with a deformation energy of binding of not greater than about 10 kcal/mole, and more preferably, not greater than 7 kcal/mole. Chemical entities may interact with a druggable region in more than one conformation that is similar in overall binding energy. In those cases, the deformation energy of binding is taken to be the difference between the energy of the free entity and the average energy of the conformations observed when the chemical entity binds to the target.

In this way, the present invention provides computer-assisted methods for identifying or designing a potential modulator of the activity of a SET domain protein, for example a histone lysine methyltransferase, including: supplying a computer modeling application with a set of structure coordinates of a molecule or complex, the molecule or complex including at least a portion of a druggable region from a SET domain protein, for example a histone lysine methyltransferase; supplying the computer modeling application with a set of structure coordinates of a chemical entity; and determining whether the chemical entity is expected to bind to the molecule or complex, wherein binding to the molecule or complex is indicative of potential modulation of the activity of a SET domain protein, for example a histone lysine methyltransferase.

In another aspect, the present invention provides a computer-assisted method for identifying or designing a potential modulator to a a SET domain protein, for example a histone lysine methyltransferase, supplying a computer modeling application with a set of structure coordinates of a molecule or complex, the molecule or complex including at least a portion of a druggable region of a SET domain protein, for example a histone lysine methyltransferase; supplying the computer modeling application with a set of structure coordinates for a chemical entity; evaluating the potential binding interactions between the chemical entity and active site of the molecule or molecular complex; structurally modifying the chemical entity to yield a set of structure coordinates for a modified chemical entity, and determining whether the modified chemical entity is expected to bind to the molecule or complex, wherein binding to the molecule or complex is indicative of potential modulation of the SET domain protein, for example a histone lysine methyltransferase.

In one embodiment, a potential modulator can be obtained by screening a peptide or other compound or chemical library (Scott and Smith, Science, 249:386-390 (1990); Cwirla et al., Proc. Natl. Acad. Sci., 87:6378-6382 (1990); Devlin et al., Science, 249:404-406 (1990)). A potential modulator selected in this manner could then be systematically modified by computer modeling programs until one or more promising potential drugs are identified. Such analysis has been shown to be effective in the development of HIV protease modulators (Lam et al., Science 263:380-384 (1994); Wlodawer et al., Ann. Rev. Biochem. 62:543-585 (1993); Appelt, Perspectives in Drug Discovery and Design 1:23-48 (1993); Erickson, Perspectives in Drug Discovery and Design 1: 109-128 (1993)). Alternatively a potential modulator may be selected from a library of chemicals such as those that can be licensed from third parties, such as chemical and pharmaceutical companies. A third alternative is to synthesize the potential modulator de novo.

For example, in certain embodiments, the present invention provides a method for making a potential modulator for a SET domain protein, for example a histone lysine methyltransferase, the method including synthesizing a chemical entity or a molecule containing the chemical entity to yield a potential modulator of a SET domain protein, for example a histone lysine methyltransferase, the chemical entity having been identified during a computer-assisted process including supplying a computer modeling application with a set of structure coordinates of a molecule or complex, the molecule or complex including at least one druggable region from a SET domain protein, for example a histone lysine methyltransferase; supplying the computer modeling application with a set of structure coordinates of a chemical entity; and determining whether the chemical entity is expected to bind to the molecule or complex at the active site, wherein binding to the molecule or complex is indicative of potential modulation. This method may further include the steps of evaluating the potential binding interactions between the chemical entity and the active site of the molecule or molecular complex and structurally modifying the chemical entity to yield a set of structure coordinates for a modified chemical entity, which steps may be repeated one or more times.

Once a potential modulator is identified, it can then be tested in any standard assay for the macromolecule depending of course on the macromolecule, including in high throughput assays. Further refinements to the structure of the modulator will generally be necessary and can be made by the successive iterations of any and/or all of the steps provided by the particular screening assay, in particular further structural analysis by e.g., ¹⁵N NMR relaxation rate determinations or x-ray crystallography with the modulator bound to a SET domain protein, for example a histone lysine methyltransferase. These studies may be performed in conjunction with biochemical assays.

Once identified, a potential modulator may be used as a model structure, and analogs to the compound can be obtained. The analogs are then screened for their ability to bind to a SET domain protein, for example a histone lysine methyltransferase. An analog of the potential modulator might be chosen as a modulator when it binds to a SET domain protein, for example a histone lysine methyltransferase, with a higher binding affinity than the predecessor modulator.

In a related approach, iterative drug design is used to identify modulators of a target protein. Iterative drug design is a method for optimizing associations between a protein and a modulator by determining and evaluating the three dimensional structures of successive sets of protein/modulator complexes. In iterative drug design, crystals of a series of protein/modulator complexes are obtained and then the three-dimensional structures of each complex is solved. Such an approach provides insight into the association between the proteins and modulators of each complex. For example, this approach may be accomplished by selecting modulators with modulatory activity, obtaining crystals of this new protein/modulator complex, solving the three dimensional structure of the complex, and comparing the associations between the new protein/modulator complex and previously solved protein/modulator complexes. By observing how changes in the modulator affected the protein/modulator associations, these associations may be optimized.

In addition to designing and/or identifying a chemical entity to associate with a druggable region, as described above, the same techniques and methods may be used to design and/or identify chemical entities that either associate, or do not associate, with affinity regions, selectivity regions or undesired regions of protein targets. By such methods, selectivity for one or a few targets, or alternatively for multiple targets, from the same species or from multiple species, can be achieved.

For example, a chemical entity may be designed and/or identified for which the binding energy for one druggable region, e.g., an affinity region or selectivity region, is more favorable than that for another region, e.g., an undesired region, by about 20%, 30%, 50% to about 60% or more. It may be the case that the difference is observed between (a) more than two regions, (b) between different regions (selectivity, affinity or undesirable) from the same target, (c) between regions of different targets, (d) between regions of homologs from different species, or (e) between other combinations. Alternatively, the comparison may be made by reference to the K_{d}, usually the apparent K_{d}, of said chemical entity with the two or more regions in question.

In another aspect, prospective modulators are screened for binding to two nearby druggable regions on a target protein. For example, a modulator that binds a first region of a target polypeptide does not bind a second nearby region. Binding to the second region can be determined by monitoring changes in a different set of amide chemical shifts in either the original screen or a second screen conducted in the presence of a modulator (or potential modulator) for the first region. From an analysis of the chemical shift changes, the approximate location of a potential modulator for the second region is identified. Optimization of the second modulator for binding to the region is then carried out by screening structurally related compounds (e.g., analogs as described above). When modulators for the first region and the second region are identified, their location and orientation in the ternary complex can be determined experimentally. On the basis of this structural information, a linked compound, e.g., a consolidated modulator, is synthesized in which the modulator for the first region and the modulator for the second region are linked. In certain embodiments, the two modulators are covalently linked to form a consolidated modulator. This consolidated modulator may be tested to determine if it has a higher binding affinity for the target than either of the two individual modulators. A consolidated modulator is selected as a modulator when it has a higher binding affinity for the target than either of the two modulators. Larger consolidated modulators can be constructed in an analogous manner, e.g., linking three modulators which bind to three nearby regions on the target to form a multilinked consolidated modulator that has an even higher affinity for the target than the linked modulator. In this example, it is assumed that is desirable to have the modulator bind to all the druggable regions. However, it may be the case that binding to certain of the druggable regions is not desirable, so that the same techniques may be used to identify modulators and consolidated modulators that show increased specificity based on binding to at least one but not all druggable regions of a target.

The present invention provides a number of methods that use drug design as described above. For example, in one aspect, the present invention contemplates a method for designing a candidate compound for screening for modulators of a SET domain protein, for example a histone lysine methyltransferase, the method comprising: (a) determining the three dimensional structure of a crystallized a SET domain protein, for example a histone lysine methyltransferase, or a fragment thereof; and (b) designing a candidate modulator based on the three dimensional structure of the crystallized polypeptide or fragment.

In another aspect, the present invention contemplates a method for identifying a potential modulator of a SET domain protein, for example a histone lysine methyltransferase, the method comprising: (a) providing the three-dimensional coordinates of a SET domain protein, for example a histone lysine methyltransferase, or a fragment thereof; (b) identifying a druggable region of the polypeptide or fragment; and (c) selecting from a database at least one compound that comprises three dimensional coordinates which indicate that the compound may bind the druggable region; (d) wherein the selected compound is a potential modulator of a SET domain protein, for example, a hi stone lysine methyltransferase.

In another aspect, the present invention contemplates a method for identifying a potential modulator of a molecule comprising a druggable region, the method comprising: (a) using the atomic coordinates of amino acid residues from a druggable region, such as, for example a pre-SET domain, or a fragment thereof, ± a root mean square deviation from the backbone atoms of the amino acids of not more than 1.5 Å, to generate a three-dimensional structure of a molecule comprising a druggable region, such as, for example, a pre-SET domain-like region; (b) employing the three dimensional structure to design or select the potential modulator; (c) synthesizing the modulator; and (d) contacting the modulator with the molecule to determine the ability of the modulator to interact with the molecule.

In another aspect, the present invention contemplates an apparatus for determining whether a compound is a potential modulator of a SET domain protein, for example a histone lysine methyltransferase, the apparatus comprising: (a) a memory that comprises: (i) the three dimensional coordinates and identities of the atoms of a SET domain protein, for example a histone lysine methyltransferase, or a fragment thereof that form a druggable site, such as for example, a pre-SET domain; and (ii) executable instructions; and (b) a processor that is capable of executing instructions to: (i) receive three-dimensional structural information for a candidate compound; (ii) determine if the three-dimensional structure of the candidate compound is complementary to the structure of the interior of the druggable site; and (iii) output the results of the determination.

In another aspect, the present invention contemplates a method for designing a potential compound for the prevention or treatment of a SET domain protein related disease or disorder, the method comprising: (a) providing the three dimensional structure of a crystallized SET domain protein, for example a histone lysine methyltransferase, or a fragment thereof; (b) synthesizing a potential compound for the prevention or treatment of SET domain protein related disease or disorder based on the three dimensional structure of the crystallized polypeptide or fragment; (c) contacting a SET domain protein, for example a histone lysine methyltransferase, with the potential compound; and (d) assaying the activity of a SET domain protein, for example a histone lysine methyltransferase, wherein a change in the activity of the polypeptide indicates that the compound may be useful for prevention or treatment of a SET domain related disease or disorder.

(b) Modulator Libraries

The synthesis and screening of combinatorial libraries is a validated strategy for the identification and study of organic molecules of interest. According to the present invention, the synthesis of libraries containing molecules bind, interact with, or modulate the activity/function of a subject druggable region may be performed using established combinatorial methods for solution phase, solid phase, or a combination of solution phase and solid phase synthesis techniques. The synthesis of combinatorial libraries is well known in the art and has been reviewed (see, e.g., “Combinatorial Chemistry”, Chemical and Engineering News, Feb. 24, 1997, p. 43; Thompson et al., Chem. Rev. (1996) 96:555). Many libraries are commercially available. One of ordinary skill in the art will realize that the choice of method for any particular embodiment will depend upon the specific number of molecules to be synthesized, the specific reaction chemistry, and the availability of specific instrumentation, such as robotic instrumentation for the preparation and analysis of the inventive libraries. In certain embodiments, the reactions to be performed to generate the libraries are selected for their ability to proceed in high yield, and in a stereoselective and regioselective fashion, if applicable.

In one aspect of the present invention, the inventive libraries are generated using a solution phase technique. Traditional advantages of solution phase techniques for the synthesis of combinatorial libraries include the availability of a much wider range of reactions, and the relative ease with which products may be characterized, and ready identification of library members, as discussed below. For example, in certain embodiments, for the generation of a solution phase combinatorial library, a parallel synthesis technique is utilized, in which all of the products are assembled separately in their own reaction vessels. In a particular parallel synthesis procedure, a microtitre plate containing n rows and m columns of tiny wells which are capable of holding a few milliliters of the solvent in which the reaction will occur, is utilized. It is possible to then use n variants of reactant A, such as a ligand, and m variants of reactant B, such as a second ligand, to obtain n×m variants, in n×m wells. One of ordinary skill in the art will realize that this particular procedure is most useful when smaller libraries are desired, and the specific wells may provide a ready means to identify the library members in a particular well.

In other embodiments of the present invention, a solid phase synthesis technique is utilized. Solid phase techniques allow reactions to be driven to completion because excess reagents may be utilized and the unreacted reagent washed away. Solid phase synthesis also allows the use a technique called “split and pool”, in addition to the parallel synthesis technique, developed by Furka. See, e.g., Furka et al., Abstr. 14th Int. Congr. Biochem., (Prague, Czechoslovakia) (1988) 5:47 ; Furka et al., Int. J. Pept. Protein Res. (1991) 37:487; Sebestyen et al., Bioorg. Med. Chem. Lett. (1993) 3:413. In this technique, a mixture of related molecules may be made in the same reaction vessel, thus substantially reducing the number of containers required for the synthesis of very large libraries, such as those containing as many as or more than one million library members. As an example, the solid support with the starting material attached may be divided into n vessels, where n represents the number species of reagent A to be reacted with the such starting material. After reaction, the contents from n vessels are combined and then split into m vessels, where m represents the number of species of reagent B to be reacted with the now modified starting materials. This procedure is repeated until the desired number of reagents is reacted with the starting materials to yield the inventive library.

The use of solid phase techniques in the present invention may also include the use of a specific encoding technique. Specific encoding techniques have been reviewed by Czamik in Current Opinion in Chemical Biology (1997) 1:60. One of ordinary skill in the art will also realize that if smaller solid phase libraries are generated in specific reaction wells, such as 96 well plates, or on plastic pins, the reaction history of these library members may also be identified by their spatial coordinates in the particular plate, and thus are spatially encoded. In other embodiments, an encoding technique involves the use of a particular “identifying agent” attached to the solid support, which enables the determination of the structure of a specific library member without reference to its spatial coordinates. Examples of such encoding techniques include, but are not limited to, spatial encoding techniques, graphical encoding techniques, including the “tea bag” method, chemical encoding methods, and spectrophotometric encoding methods. One of ordinary skill in the art will realize that the particular encoding method to be used in the present invention must be selected based upon the number of library members desired, and the reaction chemistry employed.

In certain embodiments, molecules of the present invention may be prepared using solid support chemistry known in the art. For example, polypeptides having up to twenty amino acids or more may be generated using standard solid phase technology on commercially available equipment (such as Advanced Chemtech multiple organic synthesizers). In certain embodiments, a starting material or later reactant may be attached to the solid phase, through a linking unit, or directly, and subsequently used in the synthesis of desired molecules. The choice of linkage will depend upon the reactivity of the molecules and the solid support units and the stability of these linkages. Direct attachment to the solid support via a linker molecule may be useful if it is desired not to detach the library member from the solid support. For example, for direct on-bead analysis of biological activity, a stronger interaction between the library member and the solid support may be desirable. Alternatively, the use of a linking reagent may be useful if more facile cleavage of the inventive library members from the solid support is desired.

In regard to automation of the present subject methods, a variety of instrumentation may be used to allow for the facile and efficient preparation of chemical libraries of the present invention, and methods of assaying members of such libraries. In general, automation, as used in reference to the synthesis and preparation of the subject chemical libraries, involves having instrumentation complete one or more of the operative steps that must be repeated a multitude of times because a library instead of a single molecule is being prepared. Examples of automation include, without limitation, having instrumentation complete the addition of reagents, the mixing and reaction of them, filtering of reaction mixtures, washing of solids with solvents, removal and addition of solvents, and the like. Automation may be applied to any steps in a reaction scheme, including those to prepare, purify and assay molecules for use in the compositions of the present invention.

There is a range of automation possible. For example, the synthesis of the subject libraries may be wholly automated or only partially automated. If wholly automated, the subject library may be prepared by the instrumentation without any human intervention after initiating the synthetic process, other than refilling reagent bottles or monitoring or programming the instrumentation as necessary. Although synthesis of a subject library may be wholly automated, it may be necessary for there to be human intervention for purification, identification, or the like of the library members.

In contrast, partial automation of the synthesis of a subject library involves some robotic assistance with the physical steps of the reaction schema that gives rise to the library, such as mixing, stirring, filtering and the like, but still requires some human intervention other than just refilling reagent bottles or monitoring or programming the instrumentation. This type of robotic automation is distinguished from assistance provided by convention organic synthetic and biological techniques because in partial automation, instrumentation still completes one or more of the steps of any schema that is required to be completed a multitude of times because a library of molecules is being prepared.

In certain embodiments, the subject library may be prepared in multiple reaction vessels (e.g., microtitre plates and the like), and the identity of particular members of the library may be determined by the location of each vessel. In other embodiments, the subject library may be synthesized in solution, and by the use of deconvolution techniques, the identity of particular members may be determined.

In one aspect of the invention, the subject screening method may be carried out utilizing immobilized libraries. In certain embodiments, the immobilized library will have the ability to bind to a microorganism as described above. The choice of a suitable support will be routine to the skilled artisan. Important criteria may include that the reactivity of the support not interfere with the reactions required to prepare the library. Insoluble polymeric supports include functionalized polymers based on polystyrene, polystyrene/divinylbenzene copolymers, and the like, including any of the particles described in section 4.3. It will be understood that the polymeric support may be coated, grafted or otherwise bonded to other solid supports.

In another embodiment, the polymeric support may be provided by reversibly soluble polymers. Such polymeric supports include functionalized polymers based on polyvinyl alcohol or polyethylene glycol (PEG). A soluble support may be made insoluble (e.g., may be made to precipitate) by addition of a suitable inert nonsolvent. One advantage of reactions performed using soluble polymeric supports is that reactions in solution may be more rapid, higher yielding, and more complete than reactions that are performed on insoluble polymeric supports.

Once the synthesis of either a desired solution phase or solid support bound template has been completed, the template is then available for further reaction to yield the desired solution phase or solid support bound structure. The use of solid support bound templates enables the use of more rapid split and pool techniques.

Characterization of the library members may be performed using standard analytical techniques, such as mass spectrometry, Nuclear Magnetic Resonance Spectroscopy, including 195Pt and 1H NMR, chromatography (e.g, liquid etc.) and infra-red spectroscopy. One of ordinary skill in the art will realize that the selection of a particular analytical technique will depend upon whether the inventive library members are in the solution phase or on the solid phase. In addition to such characterization, the library member may be synthesized separately to allow for more ready identification.

(c) In Vitro Assays

Any form of a SET domain protein, for example a histone lysine methyltransferase, e.g. a full-length polypeptide or a fragment comprising the target druggable region, may be used to assess the activity of candidate small molecules and other modulators in in vitro assays. In one embodiment of such an assay, agents are identified which modulate the biological activity of a druggable region, the protein-protein interaction of interest or formation of a protein complex involving a subject druggable region. In another embodiment of such an assay, agents are identified which bind or interact with subject druggable region. In certain embodiments, the test agent is a small organic molecule. The candidate agents may be selected, for example, from the following classes of compounds: detergents, proteins, peptides, peptidomimetics, small molecules, cytokines, or hormones. In some embodiments, the candidate therapeutics may be in a library of compounds. These libraries may be generated using combinatorial synthetic methods as described above. In certain embodiments of the present invention, the ability of said candidate therapeutics to bind a target gene or gene product may be evaluated by an in vitro assay. In either embodiments, discussed in the next section, the binding assay may also be in vivo.

The invention also provides a method of screening multiple compounds to identify those which modulate the action of polypeptides of the invention, or polynucleotides encoding the same. The method of screening may involve high-throughput techniques. For example, to screen for modulators, a synthetic reaction mix, a cellular compartment, such as a membrane, cell envelope or cell wall, or a preparation of any thereof, a whole cell or tissue, or even a whole organism comprising a SET domain protein, for example a histone lysine methyltransferase,and a labeled substrate or ligand of such polypeptide is incubated in the absence or the presence of a candidate molecule that may be a modulator of a SET domain protein, for example a histone lysine methyltransferase. The ability of the candidate molecule to modulatea SET domain protein, for example a histone lysine methyltransferase, is reflected in decreased binding of the labeled ligand or decreased production of product from such substrate. Detection of the rate or level of production of product from substrate may be enhanced by using a reporter system. Reporter systems that may be useful in this regard include but are not limited to colorimetric labeled substrate converted into product, a reporter gene that is responsive to changes in a nucleic acid of the invention or polypeptide activity, and binding assays known in the art.

Another example of an assay for a modulator of a SET domain protein, for example a histone lysine methyltransferase, is a competitive assay that combines a SET domain protein, for example a histone lysine methyltransferase, and a potential modulator with molecules that bind to a SET domain protein, for example a histone lysine methyltransferase, recombinant molecules that bind to a SET domain protein, for example a histone lysine methyltransferase, natural substrates or ligands, or substrate or ligand mimetics, under appropriate conditions for a competitive inhibition assay. Polypeptides of the invention can be labeled, such as by radioactivity or a colorimetric compound, such that the number of molecules of a SET domain protein, for example a histone lysine methyltransferase, bound to a binding molecule or converted to product can be determined accurately to assess the effectiveness of the potential modulator.

A number of methods for identifying a molecule which modulates the activity of a polypeptide are known in the art. For example, in one such method, a SET domain protein, for example a histone lysine methyltransferase, is contacted with a test compound, and the activity of the SET domain protein, for example a histone lysine methyltransferase, in the presence of the test compound is determined, wherein a change in the activity of the SET domain protein, for example a histone lysine methyltransferase, is indicative that the test compound modulates the activity of the SET domain protein, for example a histone lysine methyltransferase. In certain instances, the test compound agonizes the activity of the SET domain protein, for example a histone lysine methyltransferase, and in other instances, the test compound antagonizes the activity of the SET domain protein, for example a histone lysine methyltransferase,.

In another example, a compound which modulates a SET domain protein, for example a histone lysine methyltransferase may be identified by (a) contacting a SET domain protein, for example a histone lysine methyltransferase, with a test compound; and (b) determining the activity of the polypeptide in the presence of the test compound, wherein a change in the activity of the polypeptide is indicative that the test compound may modulate the protein.

In certain instances, the test compound may not act directly on the SET domain protein, but instead act on one of its natural ligands, e.g. a cofactor, or a substrate. For example, certain test compounds may chelate or bind a natural ligand, such as zinc, and prevent it from binding to the SET domain protein. Such test compounds may be evaluate by assaying their binding to the natural ligand, or assaying the activity normally associated with the binding of the natural ligand.

In certain of the subject assays, to evaluate the results using the subject compositions, comparisons may be made to known molecules, such as one with a known binding affinity for the target. For example, a known molecule and a new molecule of interest may be assayed. The result of the assay for the subject complex will be of a type and of a magnitude that may be compared to result for the known molecule. To the extent that the subject complex exhibits a type of response in the assay that is quantifiably different from that of the known molecule then the result for such complex in the assay would be deemed a positive or negative result. In certain assays, the magnitude of the response may be expressed as a percentage response with the known molecule result, e.g. 100% of the known result if they are the same.

As those skilled in the art will understand, based on the present description, binding assays may be used to detect agents that bind a polypeptide. Cell-free assays may be used to identify molecules that are capable of interacting with a polypeptide. In a preferred embodiment, cell-free assays for identifying such molecules are comprised essentially of a reaction mixture containing a target and a test molecule or a library of test molecules. A test molecule may be, e.g., a derivative of a known binding partner of the target, e.g., a biologically inactive peptide, or a small molecule. Agents to be tested for their ability to bind may be produced, for example, by bacteria, yeast or other organisms (e.g. natural products), produced chemically (e.g. small molecules, including peptidomimetics), or produced recombinantly. In certain embodiments, the test molecule is selected from the group consisting of lipids, carbohydrates, peptides, peptidomimetics, peptide-nucleic acids (PNAs), proteins, small molecules, natural products, aptamers and oligonucleotides. In other embodiments of the invention, the binding assays are not cell-free. In a preferred embodiment, such assays for identifying molecules that bind a target comprise a reaction mixture containing a target microorganism and a test molecule or a library of test molecules.

In many candidate screening programs which test libraries of molecules and natural extracts, high throughput assays are desirable in order to maximize the number of molecules surveyed in a given period of time. Assays of the present invention which are performed in cell-free systems, such as may be derived with purified or semi-purified proteins or with lysates, are often preferred as “primary” screens in that they may be generated to permit rapid development and relatively easy detection of binding between a target and a test molecule. Moreover, the effects of cellular toxicity and/or bioavailability of the test molecule may be generally ignored in the in vitro system, the assay instead being focused primarily on the ability of the molecule to bind the target. Accordingly, potential binding molecules may be detected in a cell-free assay generated by constitution of functional interactions of interest in a cell lysate. In an alternate format, the assay may be derived as a reconstituted protein mixture which, as described below, offers a number of benefits over lysate-based assays.

In one aspect, the present invention provides assays that may be used to screen for molecules that bind a SET domain protein, for example a histone lysine methyltransferase, druggable regions. In an exemplary binding assay, the molecule of interest is contacted with a mixture generated from target cell surface polypeptides. Detection and quantification of expected binding from to a target polypeptide provides a means for determining the molecule's efficacy at binding the target. The efficacy of the molecule may be assessed by generating dose response curves from data obtained using various concentrations of the test molecule. Moreover, a control assay may also be performed to provide a baseline for comparison. In the control assay, the formation of complexes is quantitated in the absence of the test molecule.

Complex formation between a molecule and a target SET domain protein, for example a histone lysine methyltransferase, or microorganism containing a SET domain protein may be detected by a variety of techniques, many of which are effectively described above. For instance, modulation in the formation of complexes may be quantitated using, for example, detectably labeled proteins (e.g. radiolabeled, fluorescently labeled, or enzymatically labeled), by immunoassay, or by chromatographic detection.

Accordingly, one exemplary screening assay of the present invention includes the steps of contacting a SET domain protein, for example a histone lysine methyltransferase, or functional fragment thereof with a test molecule or library of test molecules and detecting the formation of complexes. For detection purposes, for example, the molecule may be labeled with a specific marker and the test molecule or library of test molecules labeled with a different marker. Interaction of a test molecule with a polypeptide or fragment thereof may then be detected by determining the level of the two labels after an incubation step and a washing step. The presence of two labels after the washing step is indicative of an interaction. Such an assay may also be modified to work with a whole target cell.

An interaction between SET domain protein, for example a histone lysine methyltransferase, target and a molecule may also be identified by using real-time BIA (Biomolecular Interaction Analysis, Pharmacia Biosensor AB) which detects surface plasmon resonance (SPR), an optical phenomenon. Detection depends on changes in the mass concentration of macromolecules at the biospecific interface, and does not require any labeling of interactants. In one embodiment, a library of test molecules may be immobilized on a sensor surface, e.g., which forms one wall of a micro-flow cell. A solution containing the target is then flowed continuously over the sensor surface. A change in the resonance angle as shown on a signal recording, indicates that an interaction has occurred. This technique is further described, e.g., in BIAtechnology Handbook by Pharmacia.

In a preferred embodiment, it will be desirable to immobilize the target to facilitate separation of complexes from uncomplexed forms, as well as to accommodate automation of the assay. Binding of polypeptide to a test molecule may be accomplished in any vessel suitable for containing the reactants. Examples include microtitre plates, test tubes, and micro-centrifuge tubes. In one embodiment, a fusion protein may be provided which adds a domain that allows the target to be bound to a matrix. For example, glutathione-S-transferase/polypeptide (GST/polypeptide) fusion proteins may be adsorbed onto glutathione sepharose beads (Sigma Chemical, St. Louis, Mo.) or glutathione derivatized microtitre plates, which are then combined with a labeled test molecule (e.g., S³⁵ labeled, P³³ labeled, and the like, and the mixture incubated under conditions conducive to complex formation, e.g. at physiological conditions for salt and pH, though slightly more stringent conditions may be desired. Following incubation, the beads are washed to remove any unbound label, and the matrix immobilized and radiolabel determined directly (e.g. beads placed in scintillant), or in the supernatant after the complexes are subsequently dissociated. Alternatively, the complexes may be dissociated from the matrix, separated by SDS-PAGE, and the level of polypeptide or binding partner found in the bead fraction quantitated from the gel using standard electrophoretic techniques such as described in the appended examples. The above techniques could also be modified in which the test molecule is immobilized, and the labeled target is incubated with the immobilized test molecules. In one embodiment of the invention, the test molecules are immobilized, optionally via a linker, to a particle of the invention, e.g. to create the ultimate composition.

Other techniques for immobilizing targets or molecules on matrices may be used in the subject assays. For instance, a target or molecule may be immobilized utilizing conjugation of biotin and streptavidin. For instance, biotinylated polypeptide molecules may be prepared from biotin-NHS (N-hydroxy-succinimide) using techniques well known in the art (e.g., biotinylation kit, Pierce Chemicals, Rockford, Ill.), and immobilized in the wells of streptavidin-coated 96 well plates (Pierce Chemical). Alternatively, antibodies reactive with a target or molecule may be derivatized to the wells of the plate, and the target or molecule trapped in the wells by antibody conjugation. As above, preparations of test molecules are incubated in the polypeptide presenting wells of the plate, and the amount of complex trapped in the well may be quantitated. Exemplary methods for detecting such complexes, in addition to those described above for the GST-immobilized complexes, include immunodetection of complexes using antibodies reactive with the complex, or which are reactive with one of the complex components; as well as enzyme-linked assays which rely on detecting an enzymatic activity associated with a target or molecule, either intrinsic or extrinsic activity. In an instance of the latter, the enzyme may be chemically conjugated or provided as a fusion protein with the target or molecule. To illustrate, a target polypeptide may be chemically cross-linked or genetically fused with horseradish peroxidase, and the amount of polypeptide trapped in a complex with a molecule may be assessed with a chromogenic substrate of the enzyme, e.g. 3,3′-diamino-benzadine terahydrochloride or 4-chloro-1-napthol. Likewise, a fusion protein comprising the polypeptide and glutathione-S-transferase may be provided, and complex formation quantitated by detecting the GST activity using 1-chloro-2,4-dinitrobenzene (Habig et al (1974) J Biol Chem 249:7130).

For processes that rely on immunodetection for quantitating one of the components trapped in a complex, antibodies against a component, such as anti-polypeptide antibodies, may be used. Alternatively, the component to be detected in the complex may be “epitope tagged” in the form of a fusion protein which includes, in addition to the polypeptide sequence, a second polypeptide for which antibodies are readily available (e.g. from commercial sources). For instance, the GST fusion proteins described above may also be used for quantification of binding using antibodies against the GST moiety. Other useful epitope tags include myc-epitopes (e.g., see Ellison et al. (1991) J Biol Chem 266:21150-21157) which includes a 10-residue sequence from c-myc, as well as the pFLAG system (International Biotechnologies, Inc.) or the pEZZ-protein A system (Pharmacia, N.J.).

In certain in vitro embodiments of the present assay, the solution containing the target comprises a reconstituted protein mixture of at least semi-purified proteins. By semi-purified, it is meant that the components utilized in the reconstituted mixture have been previously separated from other cellular or viral proteins. For instance, in contrast to cell lysates, a target protein is present in the mixture to at least 50% purity relative to all other proteins in the mixture, and more preferably are present at 90-95% purity. In certain embodiments of the subject method, the reconstituted protein mixture is derived by mixing highly purified proteins such that the reconstituted mixture substantially lacks other proteins (such as of cellular or viral origin) which might interfere with or otherwise alter the ability to measure binding activity. In one embodiment, the use of reconstituted protein mixtures allows more careful control of the target:molecule interaction conditions.

In still other embodiments of the present invention, variations of infectivity assays may be utilized in order to determine the ability of a test molecule to prevent a yeast, fungus, or other pathogen expressing a SET domain protein, for example a histone lysine methyltransferase, from binding to, fusing with, or infecting cells. If fusion, binding, or infecting is prevented, then the molecule or composition may be useful as a therapeutic agent.

All of the screening methods may be accomplished by using a variety of assay formats. In light of the present disclosure, those not expressly described herein will nevertheless be known and comprehended by one of ordinary skill in the art. Assay formats which approximate such conditions as formation of protein complexes or protein-nucleic acid complexes, and enzymatic activity may be generated in many different forms, as those skilled in the art will appreciate based on the present description and include but are not limited to assays based on cell-free systems, e.g. purified proteins or cell lysates, as well as cell-based assays which utilize intact cells. Assaying binding resulting from a given target:molecule interaction may be accomplished in any vessel suitable for containing the reactants. Examples include microtitre plates, test tubes, and micro-centrifuge tubes. Any of the assays may be provided in kit format and may be automated. Many of the following particularized assays rely on general principles, such as blockage or prevention of fusion, that may apply to other particular assays.

(d) In Vivo Assays

Candidates may also be evaluated by any of a number of cell-based assays, representative of different mechanisms of disease pathology, and also by additional experiments in animals. Such methods are referred to within this section as in vivo as they involve the use of whole cells in culture or the use of animals or samples taken therefrom. These methods may also be used to validate targets, as well as in candidate therapeutic screening methods. In an illustrative embodiment, the subject progenitor cells, and their progeny, can be used to screen various compounds. Such cells can be maintained in minimal culture media for extended periods of time (e.g., for 7-21 days or longer) and can be contacted with any compound, to determine the effect of such compound on one of cellular growth, proliferation or differentiation of progenitor cells in the culture. Detection and quantification of growth, proliferation or differentiation of these cells in response to a given compound provides a means for determining the compound's efficacy at inducing one of the growth, proliferation or differentiation in a given ductal explant. Methods of measuring cell proliferation are well known in the art and most commonly include determining DNA synthesis characteristic of cell replication. However, measurement of protein synthesis may also be used. There are numerous methods in the art for measuring protein synthesis, any of which may be used according to the invention. In an embodiment of the invention, protein synthesis has been determined using a radioactive labeled amino acid (e.g., ³H-leucine) or labeled amino acid or amino acid analogues for detection by immunofluorescence. The efficacy of the compound can be assessed by generating dose response curves from data obtained using various concentrations of the compound. A control assay can also be performed to provide a baseline for comparison. Identification of the progenitor cell population(s) amplified in response to a given test compound can be carried out according to such phenotyping as described above.

Further, the efficacy of the candidate therapeutics may be tested by administering a candidate therapeutic to a test animal and monitoring inhibition of the progress of a disease in which the target SET domain protein has been implicated (e.g., a fungal infection, cancer, proliferative disease, Wolf-Hirschhorn syndrome, Prader-Willi syndrome) or at least one symptom thereof.

Exemplary cell lines and cell cultures for screening SET domain therapeutics (which also may be used in whole cell in vitro candidate therapeutic screening) include yeast and fungal cells and cell lines, as well as cancer cell lines derived from subjects having cancer. Cell lines and cell cultures may be cultured using well-known techniques of cell culture. Suitable media for culture include natural media based on tissue extracts and bodily fluids as well chemically defined media. Media suitable for use with the present invention include media containing serum as well as media that is serum-free. Serum may be from any source, including calf, fetal bovine, horse, and human serum. Any selected medium may contain one or more of the following in any suitable combination: basal media, water, buffers, free-radical scavengers, detergents, surfactants, polymers, cellulose, salts, amino acids, vitamins, carbon sources, organic supplements, hormones, growth factors, antibiotics, nutrients and metabolites, lipids, minerals, and inhibitors. Media may be selected or developed so that a particular pH, CO₂ tension, oxygen tension, osmolality, viscosity, and/or surface tension results from the composition of the medium. The incubation steps of the above method may be accomplished by maintaining the cell cultures in an environment wherein temperature and atmosphere are controlled. The culture conditions may be altered to maintain cellular proliferation and contractile activity in the cell cultures (optimum culture conditions are described below).

Cells, tissues, or other samples taken from animal models of a particular disease state, such as cancer or other proliferative disease, may be used in the methods. Tissues and samples may be extracted from the animals using a variety of methods known in the art, for example, surgical resection, withdrawal of blood or other bodily fluid, urine collection, swabbing, and the like. Examples of experiments that can be performed to evaluate the cells and/or tissues and or samples from the animals include, but are not limited to, morphological examination of cells; histological examination of synovial tissue, of joint tissue; evaluation of DNA replication and/or expression; assays to evaluate enzyme activity; and assays studying programmed cell death, or apoptosis. The methods to perform such experiments are standard and are well known in the art.

For screening assays that use whole animals, a candidate agent or treatment is applied to the subject animals. Typically, a group of animals is used as a negative, untreated or placebo-treated control, and a test group is treated with the candidate therapy. Generally a plurality of assays are run in parallel with different agent dose levels to obtain a differential response to the various dosages. The dosages and routes of administration are determined by the specific compound or treatment to be tested, and will depend on the specific formulation, stability of the candidate agent, response of the animal, etc.

The analysis may be directed towards determining effectiveness in prevention of disease induction, where the treatment is administered before induction of the disease, i.e. prior to injection of the tumor cells or pathogen. Alternatively, the analysis is directed toward regression of existing lesions, and the treatment is administered after initial onset of the disease, or establishment of moderate to severe disease. Frequently, treatment effective for prevention is also effective in regressing the disease.

In either case, after a period of time sufficient for the development or regression of the disease, the animals are assessed for impact of the treatment, by visual, histological, immunohistological, and other assays suitable for determining effectiveness of the treatment. The results may be expressed on a semi-quantitative or quantitative scale in order to provide a basis for statistical analysis of the results.

(d) Efficacy and Selectivty Studies

The efficacy of the compounds may then be tested in additional in vitro assays and in vivo. A test compound may be administered to a cell or tissue and at least one characteristic or behavior of the tissue or cell monitored. For example, expression of one or more target genes characteristic of a particular disorder, proliferative state, or differentiation state may also be measured before and after administration of the test compound to the tissue or cell. A normalization of the expression of one or more of these target genes is indicative of the efficiency of the compound for treating disorders in the animal. In another example, the activity of a target protein may be monitored before and after administration of the test compound to a tissue or cell.

The efficacy of the compound can be assessed by generating dose response curves from data obtained using various concentrations of the compound. A control assay can also be performed to provide a baseline for comparison. The data obtained from the cell culture assays and animal studies may be used in formulating a range of dosage for use in humans. The dosage of any supplement, or alternatively of any components therein, lies generally within a range of circulating concentrations that include the ED₅₀ with little or no toxicity. The dosage may vary within this range depending upon the dosage form employed and the route of administration utilized. For agents of the present invention, the therapeutically effective dose may be estimated initially from cell culture assays. A dose may be formulated in animal models to achieve a circulating plasma concentration range that includes the IC₅₀ (i.e., the concentration of the test compound which achieves a half-maximal inhibition of symptoms) as determined in cell culture. Such information may be used to more accurately determine useful doses in humans. Levels in plasma may be measured, for example, by high performance liquid chromatography.

In another embodiment of the invention, a drug is developed by rational drug design, i.e., it is designed or identified based on information stored in computer readable form and analyzed by algorithms. More and more databases of expression profiles are currently being established, numerous ones being publicly available. The present invention provides expression profiles as well as methods for generating them (see next section). By screening such databases for the description of drugs affecting the expression of at least some of the genes characteristic of a disorder in a manner similar to the change in gene expression profile from a diseased cell to that of a normal cell corresponding to the diseased cell, compounds may be identified which normalize gene expression in a diseased cell. Derivatives and analogues of such compounds may then be synthesized to optimize the activity of the compound, and tested and optimized as described above.

The selectivity of a candidate therapeutic can be further evaluated by comparing its activity on a target to its activity on other genes or proteins. For example, the selectivity of a candidate therapeutic with respect to a target gene or protein may be expressed by comparison to another compound, using the respective values of K_{d} (i.e., the dissociation constants for each modulator-druggable region complex) or, in cases where a biological effect is observed below the K_{d}, the ratio of the respective EC_{50'}s (i.e., the concentrations that produce 50% of the maximum response for the modulator interacting with each druggable region).

Once compounds have been identified that show activity as inhibitors of target function, a program of optimization can be undertaken in an effort to improve the potency and or selectivity of the activity. This analysis of structure-activity relationships (SAR) typically involves of iterative series of selective modifications of compound structures and their correlation to biochemical or biological activity. Families of related compounds can be designed that all exhibit the desired activity, with certain members of the family, namely those possessing suitable pharmacological profiles, potentially qualifying as therapeutic candidates. In addition to designing and/or identifying a chemical entity to associate with a target, as described above, the same techniques and methods may be used to design and/or identify chemical entities that either associate, or do not associate, with affinity regions, selectivity regions or undesired regions of protein or gene targets. By such methods, selectivity for one or a few targets, or alternatively for multiple targets, from the same species or from multiple species, can be achieved.

For example, a compound may be designed and/or identified for which the binding energy for one druggable region, e.g., an affinity region or selectivity region, is more favorable than that for another region, e.g., an undesired region, by about 20%, 30%, 50% to about 60% or more. It may be the case that the difference is observed between (a) more than two regions, (b) between different regions (selectivity, affinity or undesirable) from the same target, (c) between regions of different targets, (d) between regions of homologs from different species, or (e) between other combinations. Alternatively, the comparison may be made by reference to the K_{d}, usually the apparent K_{d}, of said chemical entity with the two or more regions in question.

In another aspect, prospective compounds are screened for binding to two nearby druggable regions on a target protein or gene. For example, a compound that binds a first region of a target polypeptide does not bind a second nearby region. Binding to the second region can be determined by monitoring changes in a different set of amide chemical shifts in either the original screen or a second screen conducted in the presence of a candidate therapeutic (or potential modulator) for the first region. From an analysis of the chemical shift changes, the approximate location of a potential modulator for the second region is identified. Optimization of the second modulator for binding to the region is then carried out by screening structurally related compounds (e.g., analogs as described above). When modulators for the first region and the second region are identified, their location and orientation in the ternary complex can be determined experimentally. On the basis of this structural information, a linked compound, e.g., a consolidated modulator, is synthesized in which the modulator for the first region and the modulator for the second region are linked. In certain embodiments, the two modulators are covalently linked to form a consolidated modulator. This consolidated modulator may be tested to determine if it has a higher binding affinity for the target than either of the two individual modulators. A consolidated modulator is selected as a modulator when it has a higher binding affinity for the target than either of the two modulators. Larger consolidated modulators can be constructed in an analogous manner, e.g., linking three modulators which bind to three nearby regions on the target to form a multilinked consolidated modulator that has an even higher affinity for the target than the linked modulator. In this example, it is assumed that is desirable to have the modulator bind to all the druggable regions. However, it may be the case that binding to certain of the druggable regions is not desirable, so that the same techniques may be used to identify modulators and consolidated modulators that show increased specificity based on binding to at least one but not all druggable regions of a target.

D. Pharmaceutical Compositions

Pharmaceutical compositions of this invention include any modulator identified according to the present invention, or a pharmaceutically acceptable salt thereof, and a pharmaceutically acceptable carrier, adjuvant, or vehicle. The term “pharmaceutically acceptable carrier” refers to a carrier(s) that is “acceptable” in the sense of being compatible with the other ingredients of a composition and not deleterious to the recipient thereof.

Methods of making and using such pharmaceutical compositions, for example, for treating cancer, a proliferative disease, a syndrome such as Wolf-Hirschhorn or Prader-Willi, or an infection, are also included in the invention. The pharmaceutical compositions of the invention can be administered orally, parenterally, by inhalation spray, topically, rectally, nasally, buccally, vaginally, or via an implanted reservoir. The term parenteral as used herein includes subcutaneous, intracutaneous, intravenous, intramuscular, intra articular, intrasynovial, intrasternal, intrathecal, intralesional, and intracranial injection or infusion techniques.

Dosage levels of between about 0.01 and about 100 mg/kg body weight per day, preferably between about 0.5 and about 75 mg/kg body weight per day of the modulators described herein are useful for the prevention and treatment of disease and conditions, including diseases and conditions mediated by pathogenic species of origin for the polypeptides of the invention. The amount of active ingredient that may be combined with the carrier materials to produce a single dosage form will vary depending upon the host treated and the particular mode of administration. A typical preparation will contain from about 5% to about 95% active compound (w/w). Alternatively, such preparations contain from about 20% to about 80% active compound.

E. Kits

The present invention provides kits for treating cancer, proliferative diseases, Wolf-Hirschhorn syndrome, Prader-Willi syndrome, or infections by organisms having a SET domain protein. For example, a kit may comprise compositions comprising compounds identified herein as modulators of SET domain protein, for example a histone lysine methyltransferase. The compositions may be pharmaceutical compositions comprising a pharmaceutically acceptable excipient. In other embodiments involving kits, this invention contemplates a kit including compositions of the present invention, and optionally instructions for their use. Kit components may be packaged for either manual or partially or wholly automated practice of the foregoing methods. Such kits may have a variety of uses, including, for example, imaging, diagnosis, therapy, and other applications.

F. Further Characterization of SET Domain Protein Druggable Regions and Complexes of the Same

F.1. Analysis of Proteins by X-ray Crystallography

(i) X-Ray Structure Determination

Exemplary methods for obtaining the three dimensional structure of the crystalline form of a molecule or complex are described herein and, in view of this specification, variations on these methods will be apparent to those skilled in the art (see Ducruix and Geige 1992, IRL Press, Oxford, England).

A variety of methods involving x-ray crystallography are contemplated by the present invention. For example, the present invention contemplates producing SET domain protein, for example a histone lysine methyltransferase, or a fragment thereof, by: (a) introducing into a host cell an expression vector comprising a nucleic acid encoding forSET domain protein, for example a histone lysine methyltransferase, or a fragment thereof; (b) culturing the host cell in a cell culture medium to express the protein or fragment; (c) isolating the protein or fragment from the cell culture; and (d) crystallizing the protein or fragment thereof. Alternatively, the present invention contemplates determining the three dimensional structure of a crystallized SET domain protein, for example a histone lysine methyltransferase, or a fragment thereof, by: (a) crystallizing a SET domain protein, for example a histone lysine methyltransferase, or a fragment thereof, such that the crystals will diffract x-rays to a resolution of 3.5 Å or better; and (b) analyzing the polypeptide or fragment by x-ray diffraction to determine the three-dimensional structure of the crystallized polypeptide.

X-ray crystallography techniques generally require that the protein molecules be available in the form of a crystal. Crystals may be grown from a solution containing SET domain protein, for example a histone lysine methyltransferase, or a fragment thereof (e.g., a stable domain), by a variety of conventional processes. These processes include, for example, batch, liquid, bridge, dialysis, vapour diffusion (e.g., hanging drop or sitting drop methods). (See for example, McPherson, 1982 John Wiley, New York; McPherson, 1990, Eur. J. Biochem. 189: 1-23; Webber. 1991, Adv. Protein Chem. 41:1-36).

In certain embodiments, native crystals of the invention may be grown by adding precipitants to the concentrated solution of the polypeptide. The precipitants are added at a concentration just below that necessary to precipitate the protein. Water may be removed by controlled evaporation to produce precipitating conditions, which are maintained until crystal growth ceases.

The formation of crystals is dependent on a number of different parameters, including pH, temperature, protein concentration, the nature of the solvent and precipitant, as well as the presence of added ions or ligands to the protein. In addition, the sequence of the polypeptide being crystallized will have a significant affect on the success of obtaining crystals. Many routine crystallization experiments may be needed to screen all these parameters for the few combinations that might give crystal suitable for x-ray diffraction analysis (See, for example, Jancarik, J & Kim, S. H., J. Appl. Cryst. 1991 24: 409-411).

Crystallization robots may automate and speed up the work of reproducibly setting up large number of crystallization experiments. Once some suitable set of conditions for growing the crystal are found, variations of the condition may be systematically screened in order to find the set of conditions which allows the growth of sufficiently large, single, well ordered crystals. In certain instances, a SET domain protein, for example a histone lysine methyltransferase, is co-crystallized with a compound that stabilizes the polypeptide.

A number of methods are available to produce suitable radiation for x-ray diffraction. For example, x-ray beams may be produced by synchrotron rings where electrons (or positrons) are accelerated through an electromagnetic field while traveling at close to the speed of light. Because the admitted wavelength may also be controlled, synchrotrons may be used as a tunable x-ray source (Hendrickson W A., Trends Biochem Sci December 2000; 25(12):637-43). For less conventional Laue diffraction studies, polychromatic x-rays covering a broad wavelength window are used to observe many diffraction intensities simultaneously (Stoddard, B. L., Curr. Opin. Struct Biol October 1998; 8(5):612-8). Neutrons may also be used for solving protein crystal structures (Gutberlet T, Heinemann U & Steiner M., Acta Crystallogr D 2001;57: 349-54).

Before data collection commences, a protein crystal may be frozen to protect it from radiation damage. A number of different cryo-protectants may be used to assist in freezing the crystal, such as methyl pentanediol (MPD), isopropanol, ethylene glycol, glycerol, formate, citrate, mineral oil, or a low-molecular-weight polyethylene glycol (PEG). The present invention contemplates a composition comprising a SET domain protein, for example a histone lysine methyltransferase, and a cryo-protectant. As an alternative to freezing the crystal, the crystal may also be used for diffraction experiments performed at temperatures above the freezing point of the solution. In these instances, the crystal may be protected from drying out by placing it in a narrow capillary of a suitable material (generally glass or quartz) with some of the crystal growth solution included in order to maintain vapour pressure.

X-ray diffraction results may be recorded by a number of ways known to one of skill in the art. Examples of area electronic detectors include charge coupled device detectors, multi-wire area detectors and phosphoimager detectors (Amemiya, Y, 1997. Methods in Enzymology, Vol. 276. Academic Press, San Diego, pp. 233-243; Westbrook, E. M., Naday, I. 1997. Methods in Enzymology, Vol. 276. Academic Press, San Diego, pp. 244-268; 1997. Kahn, R. & Fourme, R. Methods in Enzymology, Vol. 276. Academic Press, San Diego, pp. 268-286).

A suitable system for laboratory data collection might include a Bruker AXS Proteum R system, equipped with a copper rotating anode source, Confocal Max-Flux™ optics and a SMART 6000 charge coupled device detector. Collection of x-ray diffraction patterns are well documented by those skilled in the art (See, for example, Ducruix and Geige, 1992, IRL Press, Oxford, England).

The theory behind diffraction by a crystal upon exposure to x-rays is well known. Because phase information is not directly measured in the diffraction experiment, and is needed to reconstruct the electron density map, methods that can recover this missing information are required. One method of solving structures ab initio are the real/reciprocal space cycling techniques. Suitable real/reciprocal space cycling search programs include shake-and-bake (Weeks C M, DeTitta G T, Hauptman H A, Thuman P, Miller R Acta Crystallogr A 1994; V50: 210-20).

Other methods for deriving phases may also be needed. These techniques generally rely on the idea that if two or more measurements of the same reflection are made where strong, measurable, differences are attributable to the characteristics of a small subset of the atoms alone, then the contributions of other atoms can be, to a first approximation, ignored, and positions of these atoms may be determined from the difference in scattering by one of the above techniques. Knowing the position and scattering characteristics of those atoms, one may calculate what phase the overall scattering must have had to produce the observed differences.

One version of this technique is isomorphous replacement technique, which requires the introduction of new, well ordered, x-ray scatterers into the crystal. These additions are usually heavy metal atoms, (so that they make a significant difference in the diffraction pattern); and if the additions do not change the structure of the molecule or of the crystal cell, the resulting crystals should be isomorphous. Isomorphous replacement experiments are usually performed by diffusing different heavy-metal metals into the channels of a pre-existing protein crystal. Growing the crystal from protein that has been soaked in the heavy atom is also possible (Petsko, G. A., 1985. Methods in Enzymology, Vol. 114. Academic Press, Orlando, pp. 147-156). Alternatively, the heavy atom may also be reactive and attached covalently to exposed amino acid side chains (such as the sulfur atom of cysteine) or it may be associated through non-covalent interactions. It is sometimes possible to replace endogenous light metals in metallo-proteins with heavier ones, e.g., zinc by mercury, or calcium by samarium (Petsko, G. A., 1985. Methods in Enzymology, Vol. 114. Academic Press, Orlando, pp. 147-156). Exemplary sources for such heavy compounds include, without limitation, sodium bromide, sodium selenate, trimethyl lead acetate, mercuric chloride, methyl mercury acetate, platinum tetracyanide, platinum tetrachloride, nickel chloride, and europium chloride.

A second technique for generating differences in scattering involves the phenomenon of anomalous scattering. X-rays that cause the displacement of an electron in an inner shell to a higher shell are subsequently rescattered, but there is a time lag that shows up as a phase delay. This phase delay is observed as a (generally quite small) difference in intensity between reflections known as Friedel mates that would be identical if no anomalous scattering were present. A second effect related to this phenomenon is that differences in the intensity of scattering of a given atom will vary in a wavelength dependent manner, given rise to what are known as dispersive differences. In principle anomalous scattering occurs with all atoms, but the effect is strongest in heavy atoms, and may be maximized by using x-rays at a wavelength where the energy is equal to the difference in energy between shells. The technique therefore requires the incorporation of some heavy atom much as is needed for isomorphous replacement, although for anomalous scattering a wider variety of atoms are suitable, including lighter metal atoms (copper, zinc, iron) in metallo-proteins. One method for preparing a protein for anomalous scattering involves replacing the methionine residues in whole or in part with selenium containing seleno-methionine. Soaks with halide salts such as bromides and other non-reactive ions may also be effective (Dauter Z, Li M, Wlodawer A., Acta Crystallogr D 2001; 57: 239-49).

In another process, known as multiple anomalous scattering or MAD, two to four suitable wavelengths of data are collected. (Hendrickson, W. A. and Ogata, C. M. 1997 Methods in Enzymology 276, 494-523). Phasing by various combinations of single and multiple isomorphous and anomalous scattering are possible too. For example, SIRAS (single isomorphous replacement with anomalous scattering) utilizes both the isomorphous and anomalous differences for one derivative to derive phases. More traditionally, several different heavy atoms are soaked into different crystals to get sufficient phase information from isomorphous differences while ignoring anomalous scattering, in the technique known as multiple isomorphous replacement (MIR) (Petsko, G. A., 1985. Methods in Enzymology, Vol. 114. Academic Press, Orlando, pp. 147-156).

Additional restraints on the phases may be derived from density modification techniques. These techniques use either generally known features of electron density distribution or known facts about that particular crystal to improve the phases. For example, because protein regions of the crystal scatter more strongly than solvent regions, solvent flattening/flipping may be used to adjust phases to make solvent density a uniform flat value (Zhang, K. Y. J., Cowtan, K. and Main, P. Methods in Enzymology 277, 1997 Academic Press, Orlando pp 53-64). If more than one molecule of the protein is present in the asymmetric unit, the fact that the different molecules should be virtually identical may be exploited to further reduce phase error using non-crystallographic symmetry averaging (Villieux, F. M. D. and Read, R. J. Methods in Enzymology 277, 1997 Academic Press, Orlando pp 18-52). Suitable programs for performing these processes include DM and other programs of the CCP4 suite (Collaborative Computational Project, Number 4. 1994. Acta Cryst. D50, 760-763) and CNX.

The unit cell dimensions, symmetry, vector amplitude and derived phase information can be used in a Fourier transform function to calculate the electron density in the unit cell, i.e., to generate an experimental electron density map. This may be accomplished using programs of the CNX or CCP4 packages. The resolution is measured in Angstrom (A) units, and is closely related to how far apart two objects need to be before they can be reliably distinguished. The smaller this number is, the higher the resolution and therefore the greater the amount of detail that can be seen. Preferably, crystals of the invention diffract x-rays to a resolution of better than about 4.0, 3.5, 3.0, 2.5, 2.0, 1.5, 1.0, 0.5 Å or better.

As used herein, the term “modeling” includes the quantitative and qualitative analysis of molecular structure and/or function based on atomic structural information and interaction models. The term “modeling” includes conventional numeric-based molecular dynamic and energy minimization models, interactive computer graphic models, modified molecular mechanics models, distance geometry and other structure-based constraint models.

Model building may be accomplished by either the crystallographer using a computer graphics program such as TURBO or O (Jones, T A. et al., Acta Crystallogr. A47, 100-119, 1991) or, under suitable circumstances, by using a fully automated model building program, such as wARP (Anastassis Perrakis, Richard Morris & Victor S. Lamzin; Nature Structural Biology, May 1999 Volume 6 Number 5 pp 458-463) or MAID (Levitt, D. G., Acta Crystallogr. D 2001 V57: 1013-9). This structure may be used to calculate model-derived diffraction amplitudes and phases. The model-derived and experimental diffraction amplitudes may be compared and the agreement between them can be described by a parameter referred to as R-factor. A high degree of correlation in the amplitudes corresponds to a low R-factor value, with 0.0 representing exact agreement and 0.59 representing a completely random structure. Because the R-factor may be lowered by introducing more free parameters into the model, an unbiased, cross-correlated version of the R-factor known as the R-free gives a more objective measure of model quality. For the calculation of this parameter a subset of reflections (generally around 10%) are set aside at the beginning of the refinement and not used as part of the refinement target. These reflections are then compared to those predicted by the model (Kleywegt G J, Brunger A T, Structure Aug. 15, 1996; 4(8):897-904).

The model may be improved using computer programs that maximize the probability that the observed data was produced from the predicted model, while simultaneously optimizing the model geometry. For example, the CNX program may be used for model refinement, as can the XPLOR program (1992, Nature 355:472-475, G. N. Murshudov, A. A. Vagin and E. J. Dodson, (1997) Acta Cryst. D 53, 240-255). In order to maximize the convergence radius of refinement, simulated annealing refinement using torsion angle dynamics may be employed in order to reduce the degrees of freedom of motion of the model (Adams P D, Pannu N S, Read R J, Brunger A T., Proc Natl Acad Sci USA May 13, 1997; 94(10):5018-23). Where experimental phase information is available (e.g. where MAD data was collected) Hendrickson-Lattman phase probability targets may be employed. Isotropic or anisotropic domain, group or individual temperature factor refinement, may be used to model variance of the atomic position from its mean. Well defined peaks of electron density not attributable to protein atoms are generally modeled as water molecules. Water molecules may be found by manual inspection of electron density maps, or with automatic water picking routines. Additional small molecules, including ions, cofactors, buffer molecules or substrates may be included in the model if sufficiently unambiguous electron density is observed in a map.

In general, the R-free is rarely as low as 0.15 and may be as high as 0.35 or greater for a reasonably well-determined protein structure. The residual difference is a consequence of approximations in the model (inadequate modeling of residual structure in the solvent, modeling atoms as isotropic Gaussian spheres, assuming all molecules are identical rather than having a set of discrete conformers, etc.) and errors in the data (Lattman E E., Proteins 1996; 25: i-ii). In refined structures at high resolution, there are usually no major errors in the orientation of individual residues, and the estimated errors in atomic positions are usually around 0.1-0.2 up to 0.3 Å.

The three dimensional structure of a new crystal may be modeled using molecular replacement. The term “molecular replacement” refers to a method that involves generating a preliminary model of a molecule or complex whose structure coordinates are unknown, by orienting and positioning a molecule whose structure coordinates are known within the unit cell of the unknown crystal, so as best to account for the observed diffraction pattern of the unknown crystal. Phases may then be calculated from this model and combined with the observed amplitudes to give an approximate Fourier synthesis of the structure whose coordinates are unknown. This, in turn, can be subject to any of the several forms of refinement to provide a final, accurate structure of the unknown crystal. Lattman, E., “Use of the Rotation and Translation Functions”, in Methods in Enzymology, 115, pp. 55-77 (1985); M. G. Rossmann, ed., “The Molecular Replacement Method”, Int. Sci. Rev. Ser., No. 13, Gordon & Breach, New York, (1972).

Commonly used computer software packages for molecular replacement are CNX, X-PLOR (Brunger 1992, Nature 355: 472-475), AMoRE (Navaza, 1994, Acta Crystallogr. A50:157-163), the CCP4 package, the MERLOT package (P. M. D. Fitzgerald, J. Appl. Cryst., Vol. 21, pp. 273-278, 1988) and XTALVIEW (McCree et al (1992) J. Mol. Graphics 10: 44-46). The quality of the model may be analyzed using a program such as PROCHECK or 3D-Profiler (Laskowski et al 1993 J. Appl. Cryst. 26:283-291; Luthy R. et al, Nature 356: 83-85, 1992; and Bowie, J. U. et al, Science 253: 164-170, 1991).

Homology modeling (also known as comparative modeling or knowledge-based modeling) methods may also be used to develop a three dimensional model from a polypeptide sequence based on the structures of known proteins. The method utilizes a computer model of a known protein, a computer representation of the amino acid sequence of the polypeptide with an unknown structure, and standard computer representations of the structures of amino acids. This method is well known to those skilled in the art (Greer, 1985, Science 228, 1055; Bundell et al 1988, Eur. J. Biochem. 172, 513; Knighton et al., 1992, Science 258:130-135, http://biochem.vt.edu/courses/-modelinglhomology.htn). Computer programs that can be used in homology modeling are QUANTA and the Homology module in the Insight II modeling package distributed by Molecular Simulations Inc, or MODELLER (Rockefeller University, www.iucr.ac.uk/sinris-top/logical/prg-modeller.html).

Once a homology model has been generated it is analyzed to determine its correctness. A computer program available to assist in this analysis is the Protein Health module in QUANTA which provides a variety of tests. Other programs that provide structure analysis along with output include PROCHECK and 3D-Profiler (Luthy R. et al, Nature 356: 83-85, 1992; and Bowie, J. U. et al, Science 253: 164-170, 1991). Once any irregularities have been resolved, the entire structure may be further refined.

Other molecular modeling techniques may also be employed in accordance with this invention. See, e.g., Cohen, N. C. et al, J. Med. Chem., 33, pp. 883-894 (1990). See also, Navix, M. A. and M. A. Marko, Current Opinions in Structural Biology, 2, pp. 202-210 (1992).

Under suitable circumstances, the entire process of solving a crystal structure may be accomplished in an automated fashion by a system such as ELVES (http://ucxray.berkeley.edu/˜jamesh/elves/index.html) with little or no user intervention.

(ii) X-Ray Structure

The present invention provides methods for determining some or all of the structural coordinates for amino acids of a SET domain protein, for example a histone lysine methyltransferase, or a complex thereof.

In another aspect, the present invention provides methods for identifying a druggable region of SET domain protein, for example a histone lysine methyltransferase. For example, one such method includes: (a) obtaining crystals of SET domain protein, for example a histone lysine methyltransferase, or a fragment thereof such that the three dimensional structure of the crystallized protein can be determined to a resolution of 3.5 Å or better; (b) determining the three dimensional structure of the crystallized polypeptide or fragment using x-ray diffraction; and (c) identifying a druggable region of a SET domain protein, for example a histone lysine methyltransferase, based on the three-dimensional structure of the polypeptide or fragment.

A three dimensional structure of a molecule or complex may be described by the set of atoms that best predict the observed diffraction data (that is, which possesses a minimal R value). Files may be created for the structure that defines each atom by its chemical identity, spatial coordinates in three dimensions, root mean squared deviation from the mean observed position and fractional occupancy of the observed position.

Those of skill in the art understand that a set of structure coordinates for an protein, complex or a portion thereof, is a relative set of points that define a shape in three dimensions. Thus, it is possible that an entirely different set of coordinates could define a similar or identical shape. Moreover, slight variations in the individual coordinates may have little affect on overall shape. Such variations in coordinates may be generated because of mathematical manipulations of the structure coordinates. For example, structure coordinates could be manipulated by crystallographic permutations of the structure coordinates, fractionalization of the structure coordinates, integer additions or subtractions to sets of the structure coordinates, inversion of the structure coordinates or any combination of the above. Alternatively, modifications in the crystal structure due to mutations, additions, substitutions, and/or deletions of amino acids, or other changes in any of the components that make up the crystal, could also yield variations in structure coordinates. Such slight variations in the individual coordinates will have little affect on overall shape. If such variations are within an acceptable standard error as compared to the original coordinates, the resulting three-dimensional shape is considered to be structurally equivalent. It should be noted that slight variations in individual structure coordinates of a SET domain protein, for example a histone lysine methyltransferase, or a complex thereof would not be expected to significantly alter the nature of modulators that could associate with a druggable region thereof. Thus, for example, a modulator that bound to the active site of a SET domain protein, for example a histone lysine methyltransferase, would also be expected to bind to or interfere with another active site whose structure coordinates define a shape that falls within the acceptable error.

A crystal structure of the present invention may be used to make a structural or computer model of the polypeptide, complex or portion thereof. A model may represent the secondary, tertiary and/or quaternary structure of the polypeptide, complex or portion. The configurations of points in space derived from structure coordinates according to the invention can be visualized as, for example, a holographic image, a stereodiagram, a model or a computer-displayed image, and the invention thus includes such images, diagrams or models.

(iii) Structural Equivalents

Various computational analyses can be used to determine whether a molecule or the active site portion thereof is structurally equivalent with respect to its three-dimensional structure, to all or part of a structure of SET domain protein, for example a histone lysine methyltransferase, or a portion thereof.

For the purpose of this invention, any molecule or complex or portion thereof, that has a root mean square deviation of conserved residue backbone atoms (N, Ca, C, O) of less than about 1.75 Å, when superimposed on the relevant backbone atoms described by the reference structure coordinates of SET domain protein, for example a histone lysine methyltransferase, is considered “structurally equivalent” to the reference molecule. That is to say, the crystal structures of those portions of the two molecules are substantially identical, within acceptable error. Alternatively, the root mean square deviation may be is less than about 1.50, 1.40, 1.25, 1.0, 0.75, 0.5 or 0.35 Å.

The term “root mean square deviation” is understood in the art and means the square root of the arithmetic mean of the squares of the deviations. It is a way to express the deviation or variation from a trend or object.

In another aspect, the present invention provides a scalable three-dimensional configuration of points, at least a portion of said points, and preferably all of said points, derived from structural coordinates of at least a portion of a SET domain protein, for example a histone lysine methyltransferase, and having a root mean square deviation from the structure coordinates of the SET domain protein, for example a histone lysine methyltransferase, of less than 1.50, 1.40, 1.25, 1.0, 0.75, 0.5 or 0.35 Å. In certain embodiments, the portion of a SET domain protein, for example a histone lysine methyltransferase, is 25%, 33%, 50%, 66%, 75%, 85%, 90% or 95% or more of the amino acid residues contained in the polypeptide.

In another aspect, the present invention provides a molecule or complex including a druggable region of a SET domain protein, for example a histone lysine methyltransferase, the druggable region being defined by a set of points having a root mean square deviation of less than about 1.75 Å from the structural coordinates for points representing (a) the backbone atoms of the amino acids contained in a druggable region of SET domain protein, for example a histone lysine methyltransferase, (b) the side chain atoms (and optionally the Ca atoms) of the amino acids contained in such druggable region, or (c) all the atoms of the amino acids contained in such druggable region. In certain embodiments, only a portion of the amino acids of a druggable region may be included in the set of points, such as 25%, 33%, 50%, 66%, 75%, 85%, 90% or 95% or more of the amino acid residues contained in the druggable region. In certain embodiments, the root mean square deviation may be less than 1.50, 1.40, 1.25, 1.0, 0.75, 0.5, or 0.35 Å. In still other embodiments, instead of a druggable region, a stable domain, fragment or structural motif is used in place of a druggable region.

(iv) Machine Displays and Machine Readable Storage Media

The invention provides a machine-readable storage medium including a data storage material encoded with machine readable data which, when using a machine programmed with instructions for using said data, displays a graphical three-dimensional representation of any of the molecules or complexes, or portions thereof, of this invention. In another embodiment, the graphical three-dimensional representation of such molecule, complex or portion thereof includes the root mean square deviation of certain atoms of such molecule by a specified amount, such as the backbone atoms by less than 0.8 Å. In another embodiment, a structural equivalent of such molecule, complex, or portion thereof, may be displayed. In another embodiment, the portion may include a druggable region of the SET domain protein, for example a histone lysine methyltransferase.

According to one embodiment, the invention provides a computer for determining at least a portion of the structure coordinates corresponding to x-ray diffraction data obtained from a molecule or complex, wherein said computer includes: (a) a machine-readable data storage medium comprising a data storage material encoded with machine-readable data, wherein said data comprises at least a portion of the structural coordinates of a SET domain protein, for example a histone lysine methyltransferase; (b) a machine-readable data storage medium comprising a data storage material encoded with machine-readable data, wherein said data comprises x-ray diffraction data from said molecule or complex; (c) a working memory for storing instructions for processing said machine-readable data of (a) and (b); (d) a central-processing unit coupled to said working memory and to said machine-readable data storage medium of (a) and (b) for performing a Fourier transform of the machine readable data of (a) and for processing said machine readable data of (b) into structure coordinates; and (e) a display coupled to said central-processing unit for displaying said structure coordinates of said molecule or complex. In certain embodiments, the structural coordinates displayed are structurally equivalent to the structural coordinates of a SET domain protein, for example a histone lysine methyltransferase.

In an alternative embodiment, the machine-readable data storage medium includes a data storage material encoded with a first set of machine readable data which includes the Fourier transform of the structure coordinates of a SET domain protein, for example a histone lysine methyltransferase, or a portion thereof, and which, when using a machine programmed with instructions for using said data, can be combined with a second set of machine readable data including the x-ray diffraction pattern of a molecule or complex to determine at least a portion of the structure coordinates corresponding to the second set of machine readable data.

For example, a system for reading a data storage medium may include a computer including a central processing unit (“CPU”), a working memory which may be, e.g., RAM (random access memory) or “core” memory, mass storage memory (such as one or more disk drives or CD-ROM drives), one or more display devices (e.g., cathode-ray tube (“CRT”) displays, light emitting diode (“LED”) displays, liquid crystal displays (“LCDs”), electroluminescent displays, vacuum fluorescent displays, field emission displays (“FEDs”), plasma displays, projection panels, etc.), one or more user input devices (e.g., keyboards, microphones, mice, touch screens, etc.), one or more input lines, and one or more output lines, all of which are interconnected by a conventional bidirectional system bus. The system may be a stand-alone computer, or may be networked (e.g., through local area networks, wide area networks, intranets, extranets, or the internet) to other systems (e.g., computers, hosts, servers, etc.). The system may also include additional computer controlled devices such as consumer electronics and appliances.

Input hardware may be coupled to the computer by input lines and may be implemented in a variety of ways. Machine-readable data of this invention may be inputted via the use of a modem or modems connected by a telephone line or dedicated data line. Alternatively or additionally, the input hardware may include CD-ROM drives or disk drives. In conjunction with a display terminal, a keyboard may also be used as an input device.

Output hardware may be coupled to the computer by output lines and may similarly be implemented by conventional devices. By way of example, the output hardware may include a display device for displaying a graphical representation of an active site of this invention using a program such as QUANTA as described herein. Output hardware might also include a printer, so that hard copy output may be produced, or a disk drive, to store system output for later use.

In operation, a CPU coordinates the use of the various input and output devices, coordinates data accesses from mass storage devices, accesses to and from working memory, and determines the sequence of data processing steps. A number of programs may be used to process the machine-readable data of this invention. Such programs are discussed in reference to the computational methods of drug discovery as described herein. References to components of the hardware system are included as appropriate throughout the following description of the data storage medium.

Machine-readable storage devices useful in the present invention include, but are not limited to, magnetic devices, electrical devices, optical devices, and combinations thereof. Examples of such data storage devices include, but are not limited to, hard disk devices, CD devices, digital video disk devices, floppy disk devices, removable hard disk devices, magneto-optic disk devices, magnetic tape devices, flash memory devices, bubble memory devices, holographic storage devices, and any other mass storage peripheral device. It should be understood that these storage devices include necessary hardware (e.g., drives, controllers, power supplies, etc.) as well as any necessary media (e.g., disks, flash cards, etc.) to enable the storage of data.

In one embodiment, the present invention contemplates a computer readable storage medium comprising structural data, wherein the data include the identity and three-dimensional coordinates of a SET domain protein, for example a histone lysine methyltransferase, or portion thereof. In another aspect, the present invention contemplates a database comprising the identity and three-dimensional coordinates of a SET domain protein, for example a histone lysine methyltransferase, or a portion thereof. Alternatively, the present invention contemplates a database comprising a portion or all of the atomic coordinates of a SET domain protein, for example a histone lysine methyltransferase, or portion thereof.

(v) Structurally Similar Molecules and Complexes

Structural coordinates for a SET domain protein, for example a histone lysine methyltransferase, can be used to aid in obtaining structural information about another molecule or complex. This method of the invention allows determination of at least a portion of the three-dimensional structure of molecules or molecular complexes which contain one or more structural features that are similar to structural features of a SET domain protein, for example a histone lysine methyltransferase. Similar structural features can include, for example, regions of amino acid identity, conserved active site or binding site motifs, and similarly arranged secondary structural elements (e.g., α helices and β sheets). Many of the methods described above for determining the structure of a SET domain protein, for example a histone lysine methyltransferase, may be used for this purpose as well.

For the present invention, a “structural homolog” is a polypeptide that contains one or more amino acid substitutions, deletions, additions, or rearrangements with respect to a subject amino acid sequence of a SET domain protein, for example a histone lysine methyltransferase, but that, when folded into its native conformation, exhibits or is reasonably expected to exhibit at least a portion of the tertiary (three-dimensional) structure of the polypeptide encoded by the related subject amino acid sequence or such other SET domain protein, for example a histone lysine methyltransferase. For example, structurally homologous molecules can contain deletions or additions of one or more contiguous or noncontiguous amino acids, such as a loop or a domain. Structurally homologous molecules also include modified polypeptide molecules that have been chemically or enzymatically derivatized at one or more constituent amino acids, including side chain modifications, backbone modifications, and N— and C-terminal modifications including acetylation, hydroxylation, methylation, amidation, and the attachment of carbohydrate or lipid moieties, cofactors, and the like.

By using molecular replacement, all or part of the structure coordinates of a SET domain protein, for example a histone lysine methyltransferase, can be used to determine the structure of a crystallized molecule or complex whose structure is unknown more quickly and efficiently than attempting to determine such information ab initio. For example, in one embodiment this invention provides a method of utilizing molecular replacement to obtain structural information about a molecule or complex whose structure is unknown including: (a) crystallizing the molecule or complex of unknown structure; (b) generating an x-ray diffraction pattern from said crystallized molecule or complex; and (c) applying at least a portion of the structure coordinates for a SET domain protein, for example a histone lysine methyltransferase, to the x-ray diffraction pattern to generate a three-dimensional electron density map of the molecule or complex whose structure is unknown.

In another aspect, the present invention provides a method for generating a preliminary model of a molecule or complex whose structure coordinates are unknown, by orienting and positioning the relevant portion of a SET domain protein, for example a histone lysine methyltransferase, within the unit cell of the crystal of the unknown molecule or complex so as best to account for the observed x-ray diffraction pattern of the crystal of the molecule or complex whose structure is unknown.

Structural information about a portion of any crystallized molecule or complex that is sufficiently structurally similar to a portion of a SET domain protein, for example a histone lysine methyltransferase, may be resolved by this method. In addition to a molecule that shares one or more structural features with a SET domain protein, for example a histone lysine methyltransferase, a molecule that has similar bioactivity, such as the same catalytic activity, substrate specificity or ligand binding activity as a SET domain protein, for example a histone lysine methyltransferase, may also be sufficiently structurally similar toa SET domain protein, for example a histone lysine methyltransferase, to permit use of the structure coordinates for a SET domain protein, for example a histone lysine methyltransferase, to solve its crystal structure.

In another aspect, the method of molecular replacement is utilized to obtain structural information about a complex containing a SET domain protein, for example a histone lysine methyltransferase, such as a complex between a modulator and a SET domain protein, for example a histone lysine methyltransferase, (or a domain, fragment, ortholog, homolog etc. thereof). In certain instances, the complex includes a SET domain protein, for example a histone lysine methyltransferase, (or a domain, fragment, ortholog, homolog etc. thereof) co-complexed with a modulator. For example, in one embodiment, the present invention contemplates a method for making a crystallized complex comprising a SET domain protein, for example a histone lysine methyltransferase, or a fragment thereof, and a compound, the method comprising: (a) crystallizing a SET domain protein, for example a histone lysine methyltransferase, such that the crystals will diffract x-rays to a resolution of 3.5 Å or better; and (b) soaking the crystal in a solution comprising the compound, thereby producing a crystallized complex comprising the polypeptide and the compound. In other embodiments, a SET domain protein, for example a histone lysine methyltransferase, may be complexed with at least one substrate or cofactor. For example, such a complex may comprise a histone lysine methyltransferase protein and a substrate. In certain embodiments, the histone lysine methyltransferase may be metal-dependent. The histone lysine methyltransferase may be a mutant of a histone lysine methyltransferase protein, either naturally occurring or designed. In certain embodiments, such a mutant has at least about 95% homology to the native sequence, and in certain embodiments, has greater than 95% homology to the SET region of a naturally occurring histone lysine methyltransferase protein. Substrates comprising the complex, may be, e.g. a peptide. In certain embodiments, the HKMT may be a metal-dependent histone lysine methyltransferase protein and a substrate, wherein said transferase acts on lysine-9 in histone H3. In one embodiment, the HKMT may be DIM-5, and the substrate a peptide. In certain embodiments, the peptide is an H3 peptide. Such complexes may also comprise cofactors such as zinc and/or S-adenosyl-L-homocysteine.

Using homology modeling, a computer model of a structural homolog or other polypeptide can be built or refined without crystallizing the molecule. For example, in another aspect, the present invention provides a computer-assisted method for homology modeling a structural homolog of a SET domain protein, for example a histone lysine methyltransferase, including: aligning the amino acid sequence of a known or suspected structural homolog with the amino acid sequence of a SET domain protein, for example a histone lysine methyltransferase, and incorporating the sequence of the homolog into a model of a SET domain protein, for example a histone lysine methyltransferase, protein derived from atomic structure coordinates to yield a preliminary model of the homolog; subjecting the preliminary model to energy minimization to yield an energy minimized model; remodeling regions of the energy minimized model where stereochemistry restraints are violated to yield a final model of the homolog.

In another embodiment, the present invention contemplates a method for determining the crystal structure of a homolog of a polypeptide encoded by a subject amino acid sequence, or equivalent thereof, the method comprising: (a) providing the three dimensional structure of a crystallized polypeptide of a subject amino acid sequence, or a fragment thereof; (b) obtaining crystals of a homologous polypeptide comprising an amino acid sequence that is at least 80% identical to the subject amino acid sequence such that the three dimensional structure of the crystallized homologous polypeptide may be determined to a resolution of 3.5 Å or better; and (c) determining the three dimensional structure of the crystallized homologous polypeptide by x-ray crystallography based on the atomic coordinates of the three dimensional structure provided in step (a). In certain instances of the foregoing method, the atomic coordinates for the homologous polypeptide have a root mean square deviation from the backbone atoms of the polypeptide encoded by the applicable subject amino acid sequence, or a fragment thereof, of not more than 1.5 Å for all backbone atoms shared in common with the homologous polypeptide and the such encoded polypeptide, or a fragment thereof.

(vi) NMR Analysis Using X-Ray Structural Data

In another aspect, the structural coordinates of a known crystal structure may be applied to nuclear magnetic resonance data to determine the three dimensional structures of polypeptides with uncharacterized or incompletely characterized structure. (See for example, Wuthrich, 1986, John Wiley and Sons, New York: 176-199; Pflugrath et al., 1986, J. Molecular Biology 189: 383-386; Kline et al., 1986 J. Molecular Biology 189:377-382). While the secondary structure of a polypeptide may often be determined by NMR data, the spatial connections between individual pieces of secondary structure are not as readily determined. The structural coordinates of a polypeptide defined by x-ray crystallography can guide the NMR spectroscopist to an understanding of the spatial interactions between secondary structural elements in a polypeptide of related structure. Information on spatial interactions between secondary structural elements can greatly simplify NOE data from two-dimensional NMR experiments. In addition, applying the structural coordinates after the determination of secondary structure by NMR techniques simplifies the assignment of NOE's relating to particular amino acids in the polypeptide sequence.

In an embodiment, the invention relates to a method of determining three dimensional structures of polypeptides with unknown structures, by applying the structural coordinates of a crystal of the present invention to nuclear magnetic resonance data of the unknown structure. This method comprises the steps of: (a) determining the secondary structure of an unknown structure using NMR data; and (b) simplifying the assignment of through-space interactions of amino acids. The term “through-space interactions” defines the orientation of the secondary structural elements in the three dimensional structure and the distances between amino acids from different portions of the amino acid sequence. The term “assignment” defines a method of analyzing NMR data and identifying which amino acids give rise to signals in the NMR spectrum.

For all of this section on x-ray crystallography, see also Brooks et al. (1983) J Comput Chem 4:187-217; Weineret al (1981) J. Comput. Chem. 106: 765; Eisenfield et al. (1991) Am J Physiol 261 :C376-386; Lybrand (1991) J Pharm Belg 46:49-54; Froimowitz (1990) Biotechniques 8:640-644; Burbam et al. (1990) Proteins 7:99-111; Pedersen (1985) Environ Health Perspect 61:185-190; and Kini et al. (1991) J Biomol Struct Dyn 9:475-488; Ryckaert et al. (1977) J Comput Phys 23:327; Van Gunsteren et al. (1977) Mol Phys 34:1311; Anderson (1983) J Comput Phys 52:24; J. Mol. Biol. 48: 442-453, 1970; Dayhoff et al., Meth. Enzymol. 91: 524-545, 1983; Henikoff and Henikoff, Proc. Nat. Acad. Sci. USA 89: 10915-10919, 1992; J. Mol. Biol. 233: 716-738, 1993; Methods in Enzymology, Volume 276, Macromolecular crystallography, Part A, ISBN 0-12-182177-3 and Volume 277, Macromolecular crystallography, Part B, ISBN 0-12-182178-1, Eds. Charles W. Carter, Jr. and Robert M. Sweet (1997), Academic Press, San Diego; Pfuetzner, et al., J. Biol. Chem. 272: 430-434 (1997).

### EXEMPLIFICATION

The invention having been generally described, may be more readily understood by reference to the following examples, which are included merely for purposes of illustration of certain aspects and embodiments of the present invention, and are not intended to limit the invention in any way.

### Example 1

### Production and Analysis of Native and Mutant Forms of DIM-5, a K9 histone H3 methyltransferase (MTase) from N. crassa

Protein Expression and Purification

N. crassa DIM-5 protein was expressed as a GST fusion. A segment of the wild-type dim-5 ORF, including amino acid residues 17-318, was amplified from pGEX-5X-3/DIM-5, and subcloned between the BamHI and EcoRI sites in pGEX2T (Amersham-Pharmacia), yielding pXC379. E. coli strain BL21(DE3) Codon plus RIL (Stratagene) carrying pXC379 was grown in LB medium supplemented with 10 μM ZnSO₄ at 37° C. to OD_{600=0.5,} shifted to 22° C., and induced with 0.4 mM IPTG overnight at 22° C. The proteins were purified using Glutathione-Sepharose 4B (Amersham-Pharmacia), UnoQ6 (Bio-Rad), and Superdex 75 columns (Amersham-Pharmacia). The GST tag was cleaved by applying thrombin to fusion proteins bound to the Glutathione-Sepharose column, leaving 5 additional residues (GSHMG) in front of amino acid 17 of DIM-5. All purification buffers contained 1 mM DTT and no EDTA. The protein was stored in the Superdex 75 column buffer containing 20 mM glycine (pH 9.8), 150 mM NaCl, 1 mM DTT and 5% glycerol. Se-containing DIM-5 (with 5 methionines) was expressed in a methionine auxotroph strain (B834) grown in the presence of Se-methionine, and the protein was purified similarly to the native protein.

Methyl Transfer Activity Assay

The activity of the DIM-5 was assayed in a 20 μl reaction containing 50 mM glycine (pH 9.8), 2 mM DTT, 40-80 μM unlabelled AdoMet (Sigma), 0.5 μCi [methyl-³H]AdoMet (78 Ci/mmol, NEN NET155H), 0.25-0.5 μg of DIM-5 protein, and 2-5 μg histones (calf thymus histones Sigma H4524, Roche 223565, or recombinant chicken erythrocyte histones, a gift from Dr. V. Ramakrishnan). The reaction was incubated at room temperature for 10-15 min and methylation was analyzed either by SDS-PAGE and fluorography, or by precipitation with 20% TCA, filtration (Milipore GF/F filter), washing and liquid scintillation counting. Under these conditions, DIM-5 activity was linearly related to reaction time and amount of enzyme and AdoMet and histone were saturating. For some reason, the relatively crude Sigma H4524 histone preparations generally gave 2-4 fold higher incorporation than either the Roche preparations or the recombinant histones.

AdoMet-Binding Assay by UV Crosslinking

Twenty μl of purified DIM-5 protein (2-5 μg) was incubated with 0.5 μCi of [methyl-³H]AdoMet (78 Ci/mmol, NEN NET155H) overnight at 4° C. Samples were added to a 96-well plate on ice and placed 8 cm from an inverted UV transilluminator (VWR, 302 nm) for 1 hr. The protein was then separated by SDS-PAGE, stained with Coomassie and subjected to fluorography.

Zinc Content Analysis

One sample of untreated and two samples of EDTA treated DIM-5 protein (about 2 ml of 2 mg/ml each) was analyzed for the presence of 20 elements on a Thermo Jarrell-Ash Enviro 36 ICAP analyzer at the Chemical Analysis Laboratory of the University of Georgia at Athens. In order to calculate the molar ratio of Zn to protein, the precise concentration of the untreated DIM-5 protein was determined by amino acid analysis (averaging two independent measurements) performed at the Keck Facilities at Yale University. The extinction coefficient (29,559 M⁻¹ cm⁻¹) derived from the amino acid analysis was used to estimate the protein concentration of the EDTA-treated samples.

Mutagenesis

Amino acid replacements of DIM-5 to yield R155H, W161F, Y204F, R238H, N241Q, H242K, D282K and Y283F, were made using QuikChange site-directed mutagenesis protocol (Stratagene) using pXC379 and primer pairs to generate CAC, TTC, TTC, CAC, CAG, AAA, AAC and TTC codons in place of AGG, TGG, TAC, AGG, AAC, CAC, GAC and TAT codons, respectively. The DIM-5 mutant 3C to 3S, in which all three invariant cysteines in the post-SET region are replaced by serines, was generated by PCR using a mutagenic 3′ primer. All mutants were sequenced to verify the presence of the intended mutation and the absence of additional mutations. The only exception is the Y204F mutant, which carries an additional Asp substitution (A24D) in the N-terminal region that was not observed in the structure. Mutant proteins, along with wild type, were purified from 100-200 ml of induced cultures. A disposable column containing 0.5 ml of Glutathione-Sepharose 4B (Amersham-Pharmacia) was used for each mutant. The mutant proteins were separated from GST by on-column thrombin cleavage and then used for enzymatic assay (using calf thymus histones Sigma H4524 as substrate), AdoMet binding by cross-linking analysis, and analytical gel filtration chromatography for native protein size determination. Full-length SET7/9 (366 residues) and mutant proteins were expressed and purified in similar ways as the DIM-5 proteins.

Enzymatic properties of DIM-5

The DIM-5 protein is a very active HKMT in vitro. We noticed several rather unusual properties of DIM-5: (1) Under our laboratory conditions, the enzyme is most active at ˜10° C. and nearly inactive at 37° C. (2) DIM-5 is extremely sensitive to salt, e.g. 100 mM NaCl inhibited its activity about 95%. (3) The enzyme has a high pH optimum. DIM-5 showed maximal activity at ˜pH 9.8, although it showed strongest cross-linking to AdoMet around pH 8. Neither HKMT activity nor AdoMet binding were observed below pH 6.0.

### Example 2

### Crystallographic Structures of DIM-5, a K9 histone H3 methyltransferase (MTase) from N. crassa, and a Ternary Complex of DIM-5, Methyl-Donor Product AdoHcy, and a Histone Peptide

Crystallographic Analysis of DIM-5

We used recombinant DIM-5 protein (residues 17 to 318 of accession AF429248) for crystallographic studies. Purified DIM-5 protein, prepared as in Example 1, was concentrated to about 10-15 mg/ml in 20 mM glycine (pH 9.8), 150 mM NaCl, 1 mM DTT, 5% glycerol, and 600 μM AdoHcy. Crystals were obtained using the hanging drop method, with mother liquor containing 1.1-1.2 M ammonium sulfate and 100 mM Na citrate (pH 5.4-5.6) at 16° C. Crystals belong to space group P2₁2₁2₁ with cell dimensions of 36.73×81.56×101.27 Å. Each asymmetric unit contains one molecule. Complete data sets were collected from a native crystal near the Zn-absorption edge (Table 1) and a SeMet-incorporated crystal at both Se— and Zn-absorption edges (not shown). The data were processed using the HKL package (Otwinowski and Minor, 1997).

Electron density maps were calculated using multiwavelength anomalous diffraction data from three intrinsic zinc ions. SOLVE (Terwilliger and Berendzen, 1999) first revealed the positions of three zinc atoms and RESOLVE (Terwilliger, 2000) was then used to modify the electron density map. The modified map was of good quality at 2.9-Å resolution to place amino acids of DIM-5 into the recognizable densities using O (Jones and Kjeldgard, 1997). In parallel, SOLVE determined the positions of five selenium atoms and two of them (SeMet 233 and 248) were confirmed by Zn-phased map and three of them (SeMet 75, 85, and 303) served as markers in the primary sequence during tracing.

A model of DIM-5 was built and refined using the X-PLOR program suite (Brünger, 1992) to 1.98-Å resolution with a crystallographic R factor of 0.205 and R_{free} value of 0.258. The final model includes 1,913 protein atoms (with mean B values of 26.9 Å²), 3 zinc ions, and 103 water molecules, with r.m.s. deviations of 0.008 Å and 1.5° from ideality for bond lengths and angles, respectively. Three segments of DIM-5 were not observed in the final model: the N-terminal 8 residues (17-24)—these may not be present in the native DIM-5 protein as there is an in-frame splicing site immediately after these residues; residues 89-99 of the pre-SET domain—these are deleted in many of the SUV39 proteins; and the majority of the C-terminal 34 amino acids—the C-terminus is also highly variable in length and sequence among SET proteins except for the three-Cys post-SET region. Among the non-glycine and non-proline residues, 86% are in most favored and 14% in additional allowed regions of a Ramachandran plot.

The coordinates of the structure have been deposited in the Protein Data Bank (ID code 1ML9).

TABLE 1
Summary of X-ray diffraction data collection for DIM-5

| Derivative | Native (Zn) | | |
|---|---|---|---|
| Wavelength (Å) | 1.0332 | 1.2834 | 1.2830 |
| Resolution range (Å) | 24.83-1.98 | 24.83-2.3 | 24.83-2.3 |
| Completeness (%)* | 97/95.8 | 98.8/95.3 | 98.8/94.0 |
| R linear (%)* | 0.055/0.276 | 0.063/0.184 | 0.067/0.227 |
| <I/σ(I)> | 15.4 | 18.6 | 18.6 |
| Observed reflections | 112,569 | 77,000 | 78,335 |
| Unique reflections | 20,963 | 13,923 | 14,065 |
| Anomalous zinc sites | 3 | 3 | 3 |

| | |
|---|---|
| Overall figure of merit | 0.48 at 2.9 Å resolution |
| Overall Z-score value | 20.13 at 2.9 Å resolution |

*The numerical numbers are given for the whole data set/the highest resolution bin.

Crystallographic Analysis of DIM-5 Ternary Complex

N. crassa DIM-5 protein was expressed and purified as described in Example 1. For co-crystallization, an H3 peptide (residues 1-15) was added at a final concentration of 2 mM to purified DIM-5 protein (12 mg/ml in 20 mM glycine, pH 9.8, 150 mM NaCl, 5 mM DTT, 5% glycerol, and 600 μM AdoHcy). Crystals were obtained using the hanging drop method at 16° C., with mother liquor containing 0.1 M Tris pH 8.4-8.6, 20-25% polyethylene glycol 2000 monomethyl ether, 0.2 M trimethylamine, and 5 mM DTT.

X-ray data from a single frozen crystal were collected on an ADSC Q315 CCD detector at beamline X25 at the National Synchrotron Light Source, Brookhaven National Laboratory. The exposure time for a 1° rotation was 120 sec at 1.0 Å wavelength with 400 mm detector-to-sample distance. Data acquisition and processing for a total of 135° rotation used the HKL2000 software package (Otwinowski and Minor, 1997). Crystallographic data statistics are shown in Table 2. Data from 10.0-4.0 Å were used in the structure solution by molecular replacement. All data to 2.6 Å were used for refinement.

TABLE 2
Summary of X-ray diffraction data collection for DIM-5 Ternary Complex

| Space group | P2₁2₁2₁ |
|---|---|
| Cell dimensions (Å) | 68.26 × 94.17 × 114.69 |
| Synchrotron beamline | NSLS X25 |
| Resolution range (Å) | 35-2.59/2.68-2.59 |
| Completeness (%) | 91.6/67.6 |
| R linear (%) | 0.088/0.228 |
| <I/σ(I)> | 23.3/4.5 |
| Unique reflections | 21,803/1,578 |
| R-factor | 0.22/0.30 |
| R-free (5% data) | 0.32/0.38 |
| Observed total reflections | 98,025 |
| Number of atoms | |
| Protein | 3954 |
| Peptide | 98 |
| AdoHcy | 52 |
| Zinc | 8 |
| Estimated coordinate error (Å) | |
| from Luzzati plot | 0.35 |
| from Sigmaa | 0.46 |
| Rms deviation from ideal values | |
| bond lengths (Å) | 0.009 |
| bond angles (°) | 1.6 |

The coordinates of substrate-free DIM-5 (PDB 1ML9), determined as described above, were used to search the molecular replacement solution using the program AMoRe (Navaza, 2001). With reference to the search model, two solutions were found: the orientation of the DIM-5 molecule in space group P2₁2₁2₁2 corresponds to Eulerian rotations of (103.07°, 80.86°, 0.15°) and (95.48°, 45.64°, 109.30°), with translations along a, b, and c axes of (0.384, 0.0547, 0.0630) and (0.0966, 0.6179, 0.1581) in fractional coordinates, respectively. The solutions, with the correlation coefficient of 0.488 and R factor of 0.44, indicated each asymmetric unit contains two complexes. The contact between the two DIM-5 molecules is mediated through N-terminal residues 30-45.

The resulting model, optimized by rigid-body refinement of X-PLOR (Briinger, 1992), provided an initial phase that was further improved by an overall anisotropic B-factor optimization (B11=20.7, B22=17.5, and B33=19.9) and a bulk solvent correction (X-PLOR), resulting in a R-factor of 0.33 and R-free of 0.37. The difference Fourier maps (2F_{obs}−F_{cal}, α_{cal} and F_{obs}−F_{cal}, α_{cal}), phased from the protein model, were then calculated at 3.0, 2.8, and 2.6 Å, respectively, and inspected using the graphic program O (Jones and Kjeldgard, 1997). Electron densities, without 2-fold non-crystallographic symmetry averaging, were clearly visible in both molecules corresponding to the AdoHcy, the zinc coordinated by post-SET Cys residues, and the structured portion of the H3 peptide. These segments were positioned manually to fit the electron density. One cycle (100 steps) of least-squares positional refinement using X-PLOR gave a R-factor of 0.26 and R-free of 0.33. Several cycles of least-squares refinement of positional and individual B-factors, followed by manual model building using O, were carried out. The non-crystallographic symmetry restraints were imposed on the two complexes during the refinement (with NCS weight of 300). A series of simulated annealing omit maps were used to guide the manual model fitting.

At this stage of refinement, it was observed that the disordered ends of the peptide, residues 13-15 or 1-6, co-localize to the general area of the beginning or the end of disordered protein residues 286-304, respectively. Discontinued densities do exist, but it was not possible to unambiguously distinguish between the peptide and protein densities. The assignment of solvent molecules to these densities would reduce the difference between values of R-factor and R-free; but such solvent molecules were not included in the final model (with R-factor of 0.22 and R-free of 0.32).

Besides residues 286-304 between the SET and post-SET regions, two other segments of DIM-5 were not modeled in the final structure: the N-terminal residues 17 to 25 and residues 90-96 of the pre-SET domain. In addition, a few stretches of residues (52-61, 85-89 and 97-98 of pre-SET, 190-202 and 212-224 of SET) are flexible, as indicated by disordered side chains and relatively higher crystallographic thermal factors of >75 Å² (2-3 times higher than the rest of the protein). As a result, many side chains of residues within or near the flexible stretches were modeled only as alanine (pre-SET residues: K53, N54, Q60, V64, S70, E72, E73, and D83; SET residues: E181, S185, E186, E194, S195, T196, R199, R200, D215, S216, L217, L221, and E227). The flexible stretches are clustered together in the folded structure: for example, the loop after strand β3 (K53, N54) is next to strand β9 (E181) and helix αF (S185 and E186); two 3₁₀ helices aA (Q60) and aI (L221) are packed together.

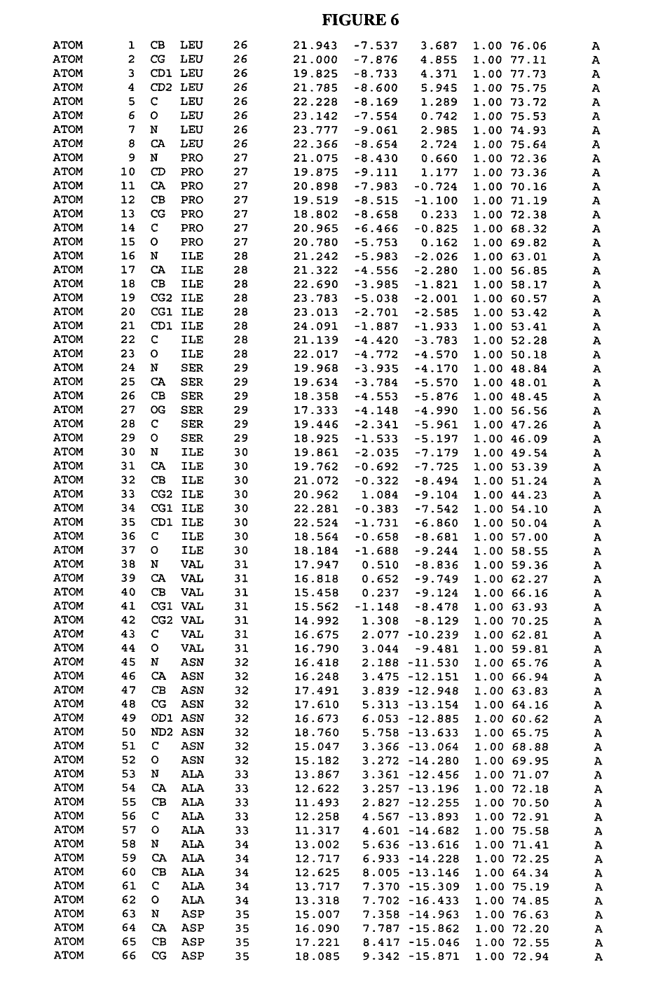

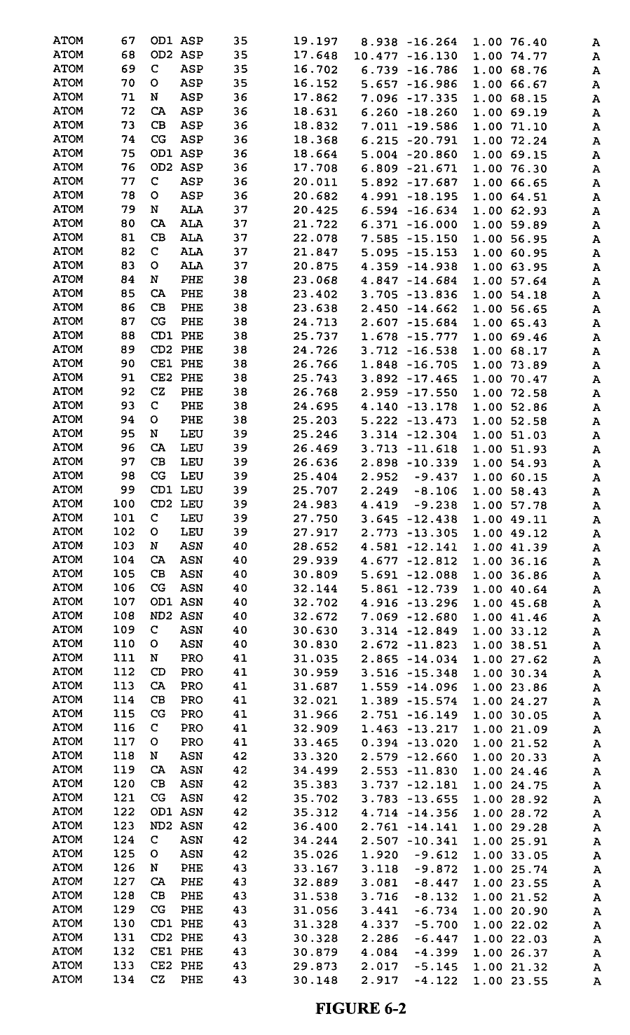

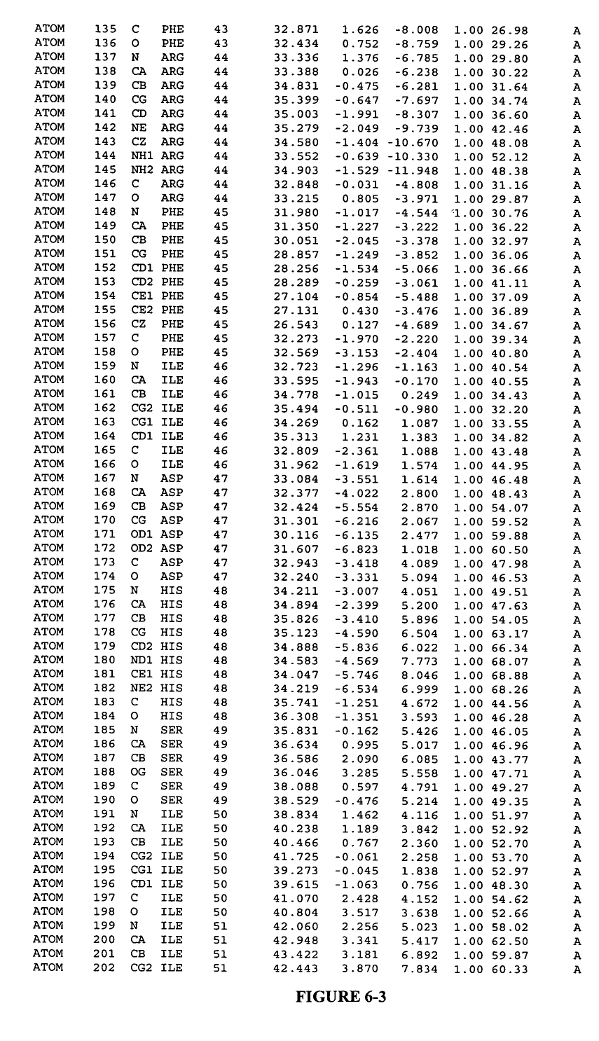

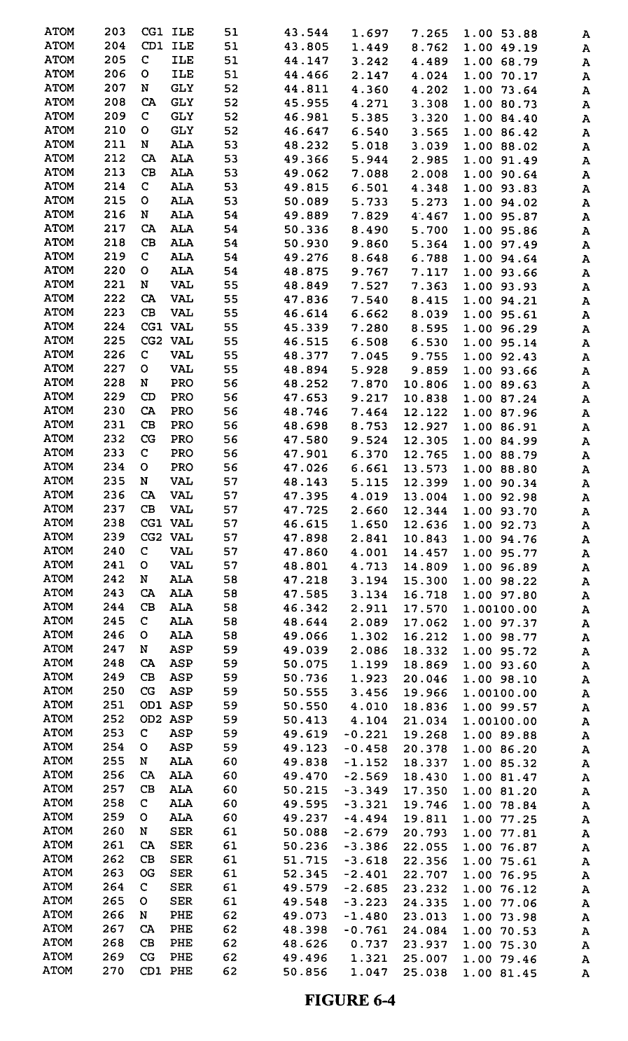

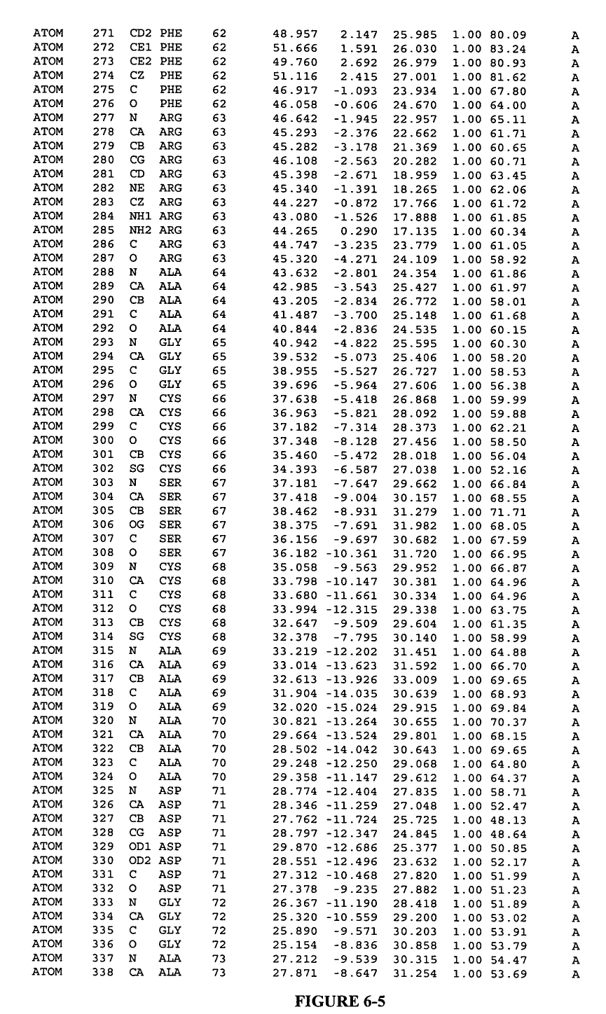

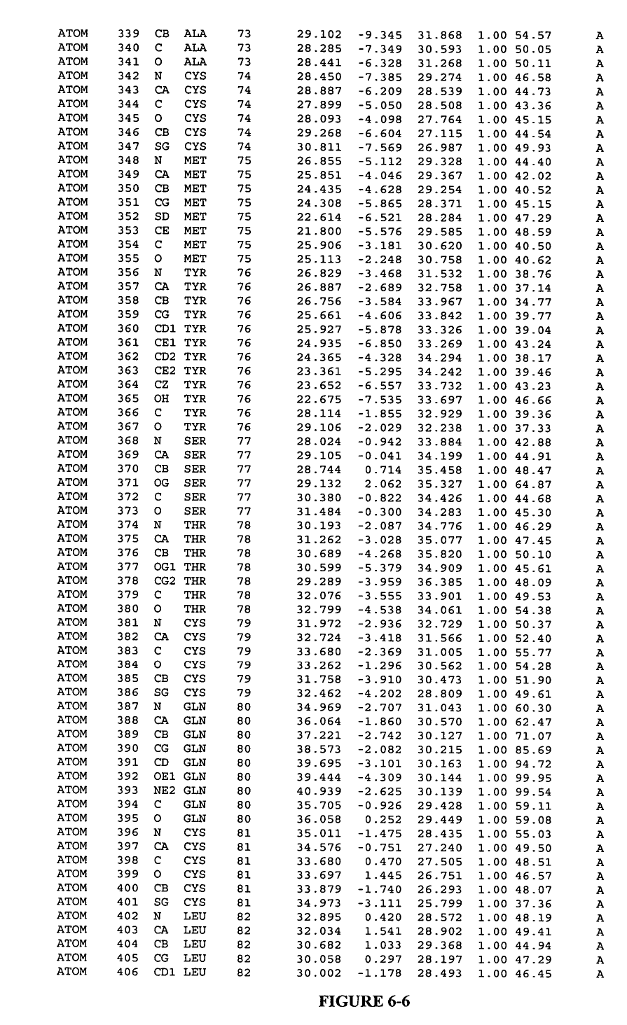

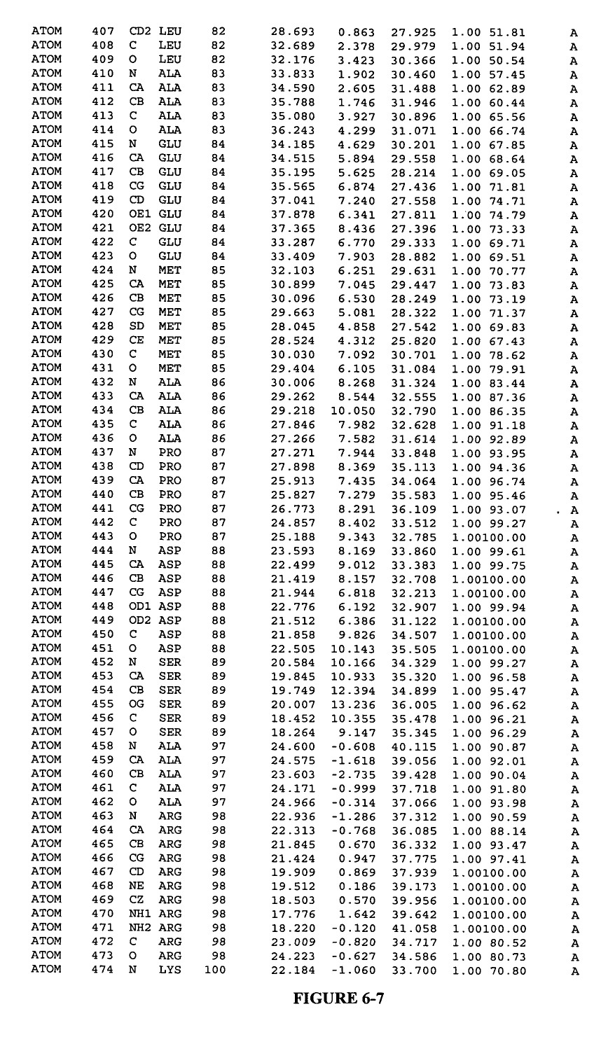

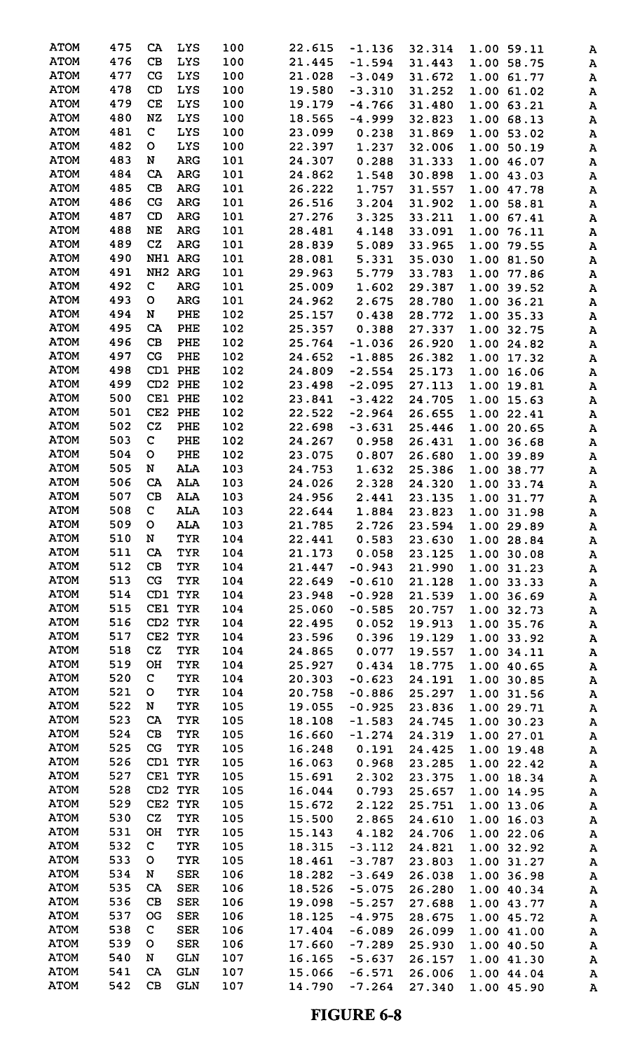

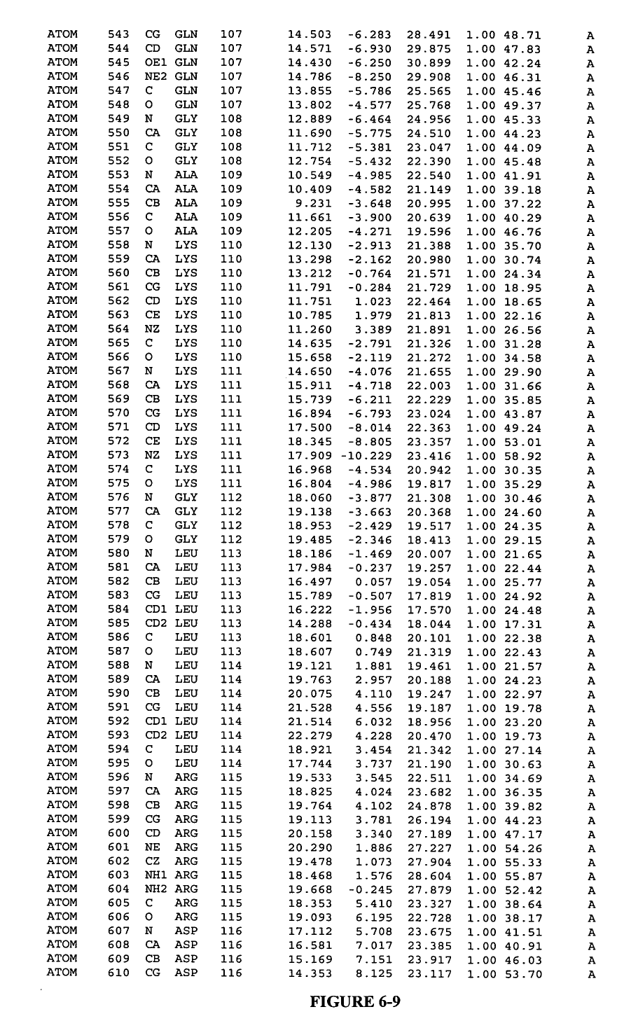

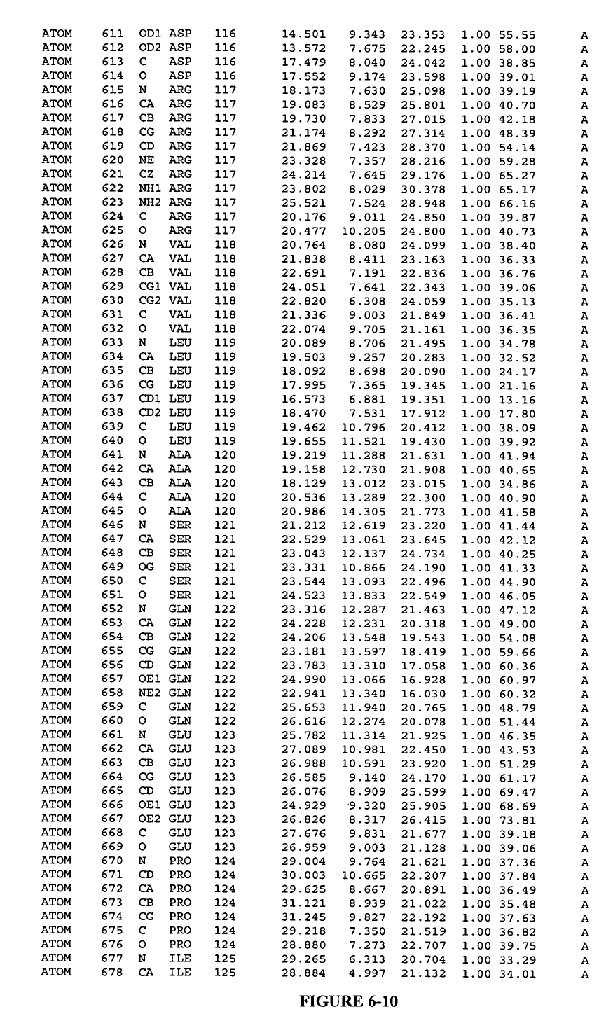

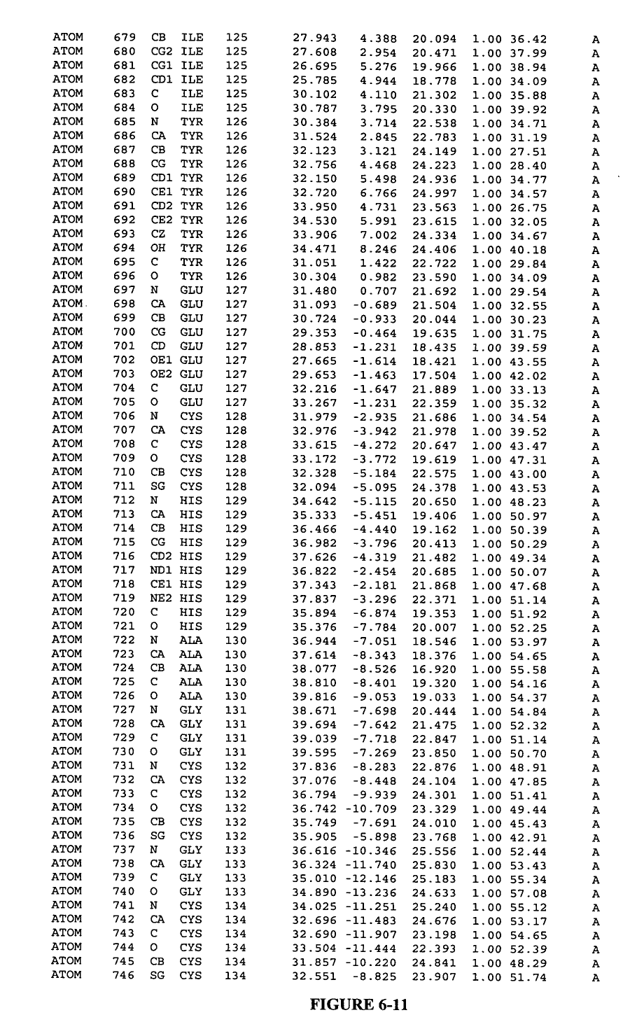

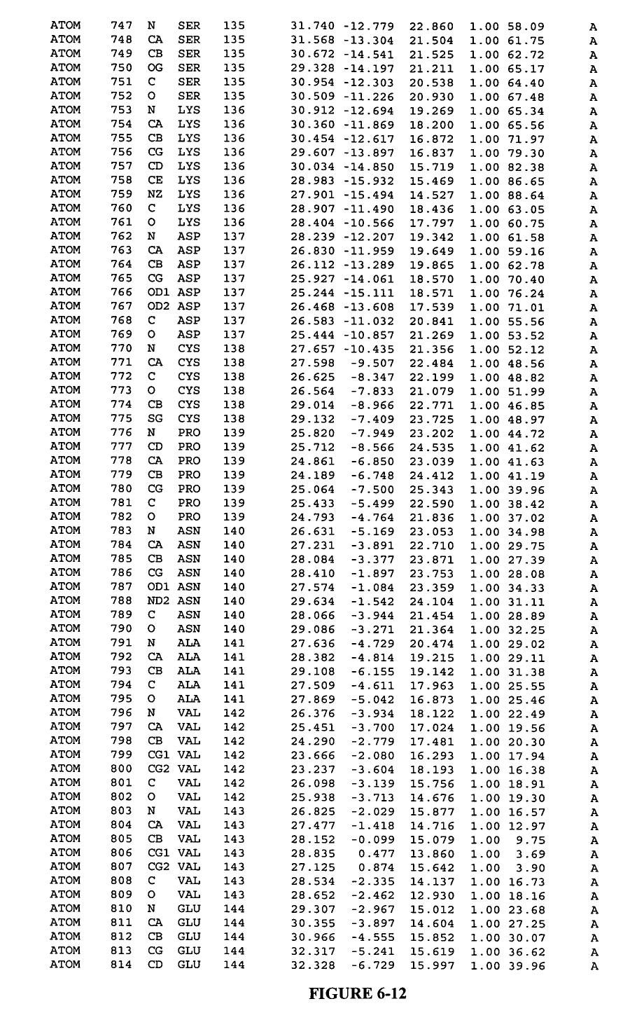

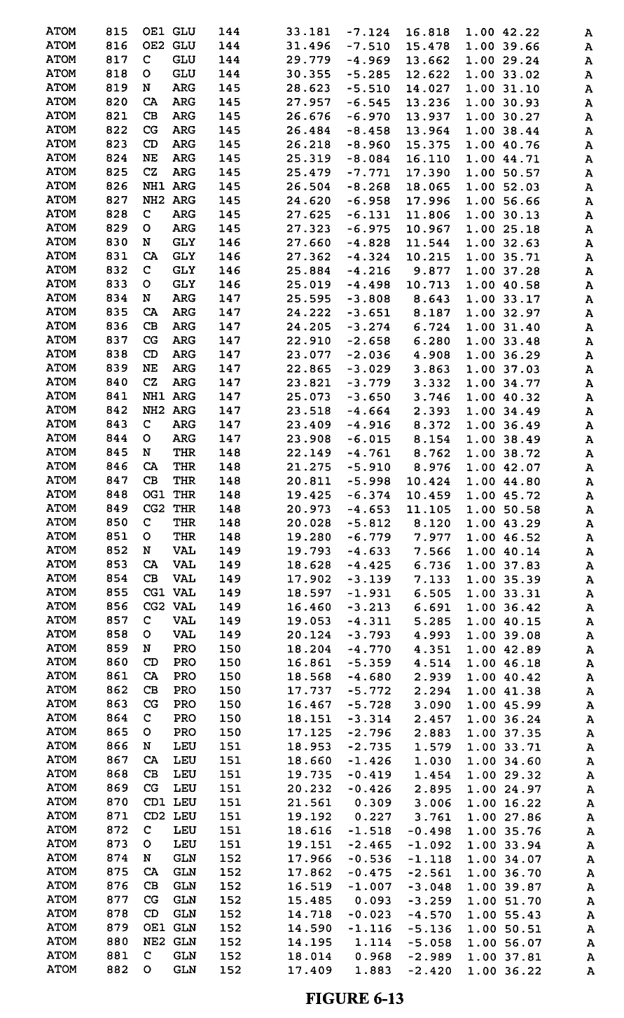

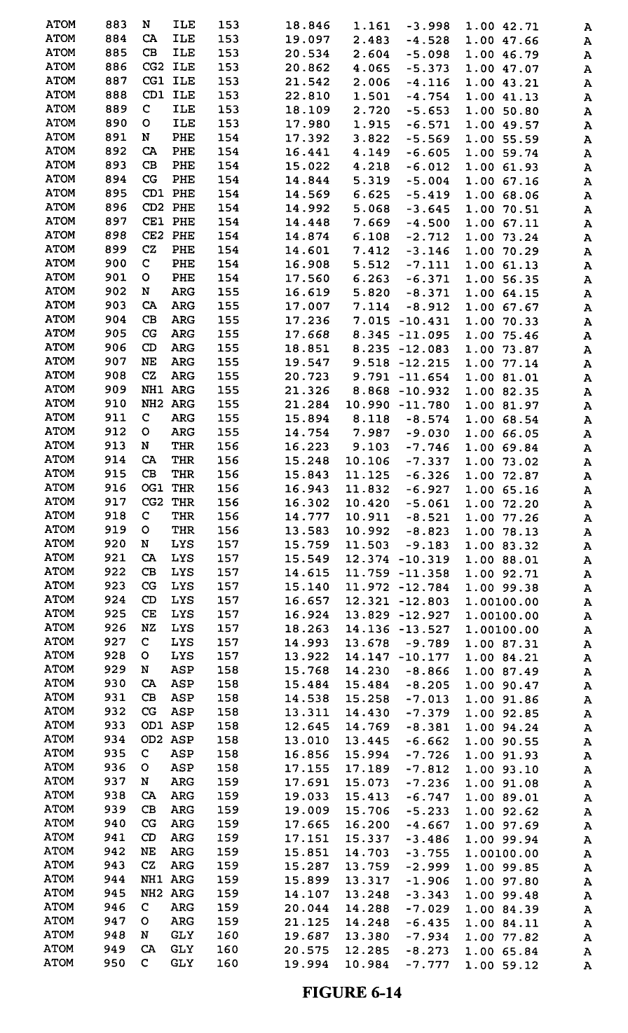

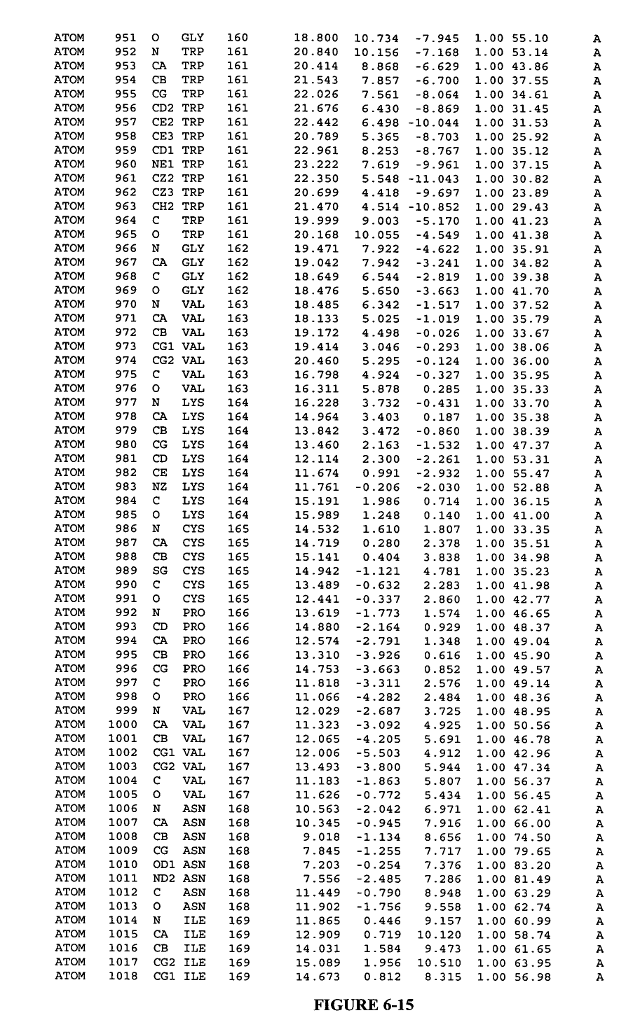

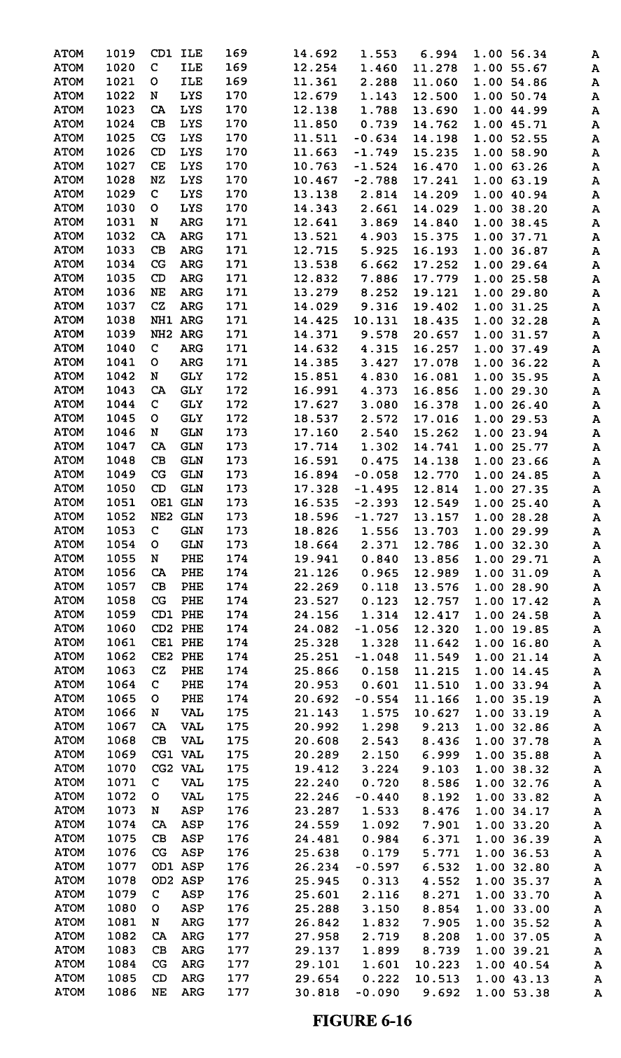

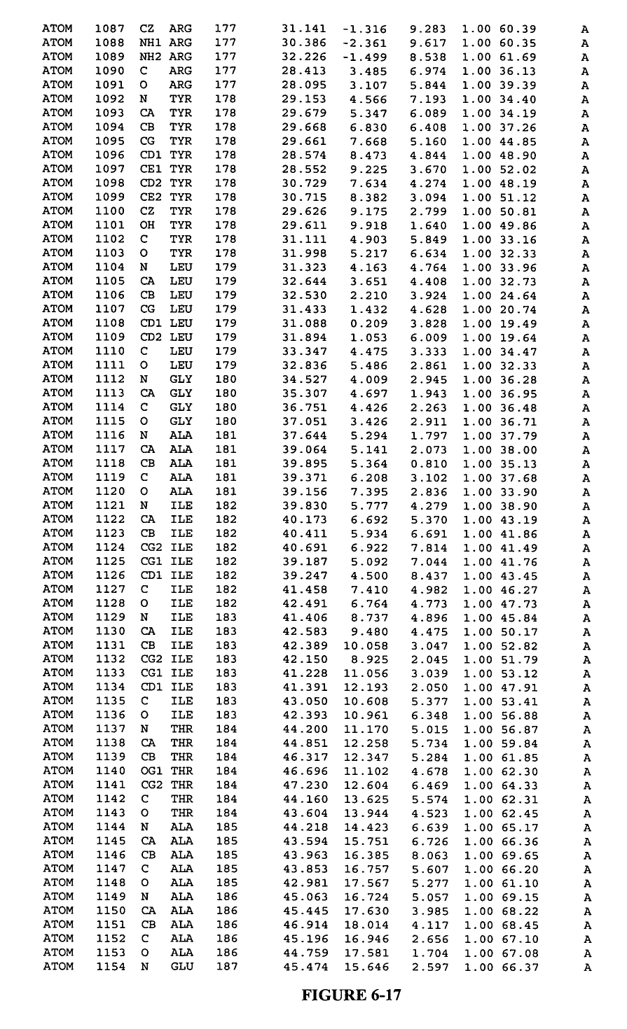

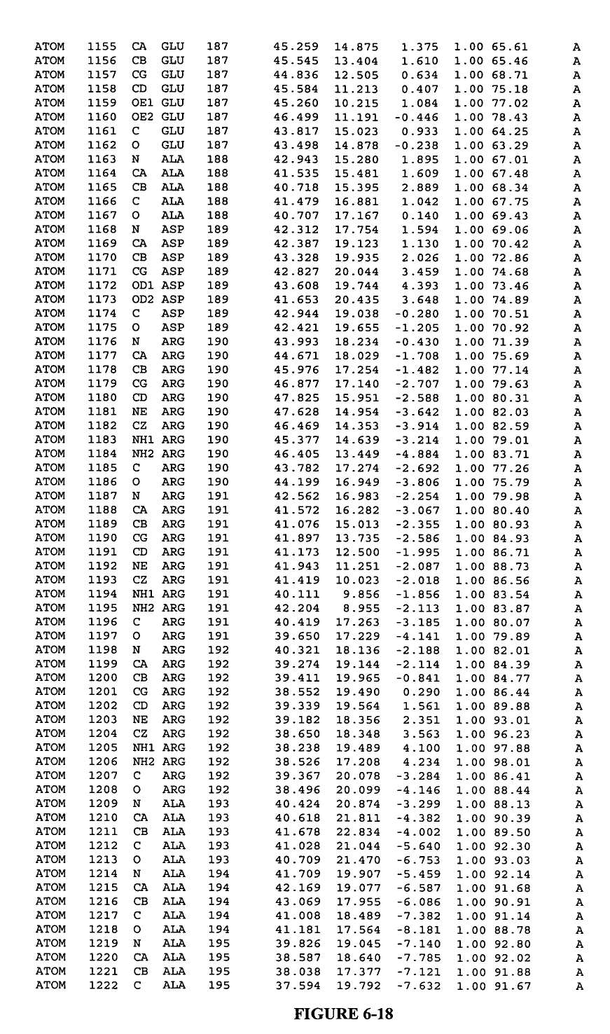

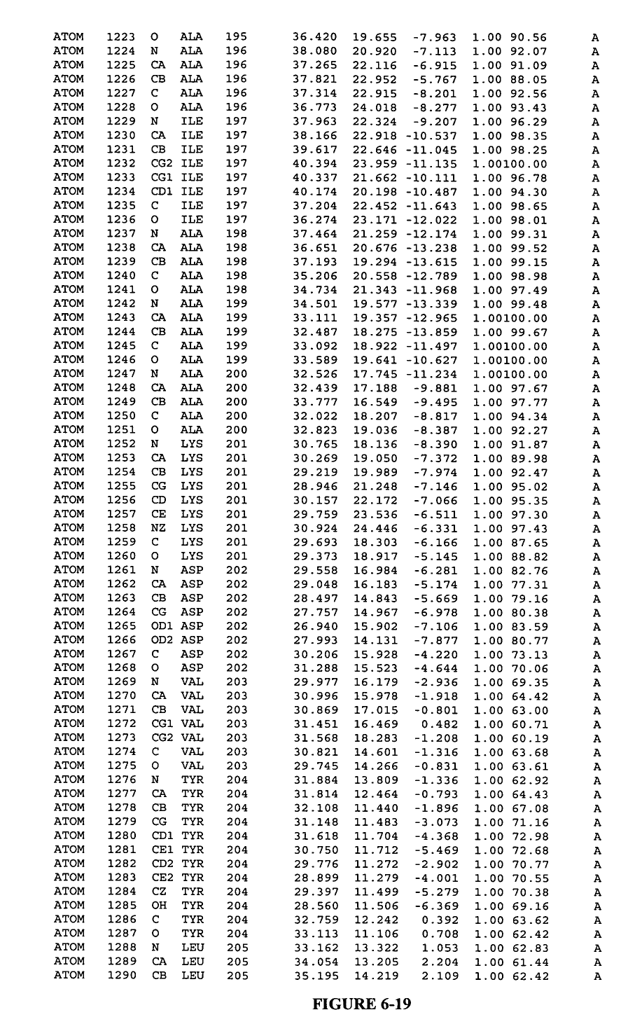

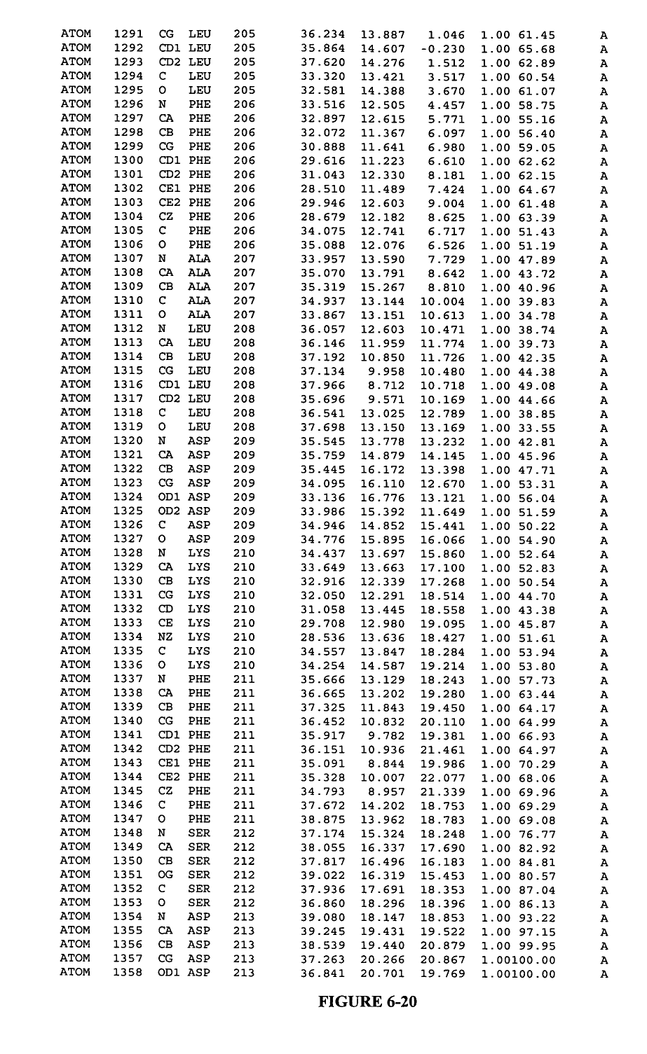

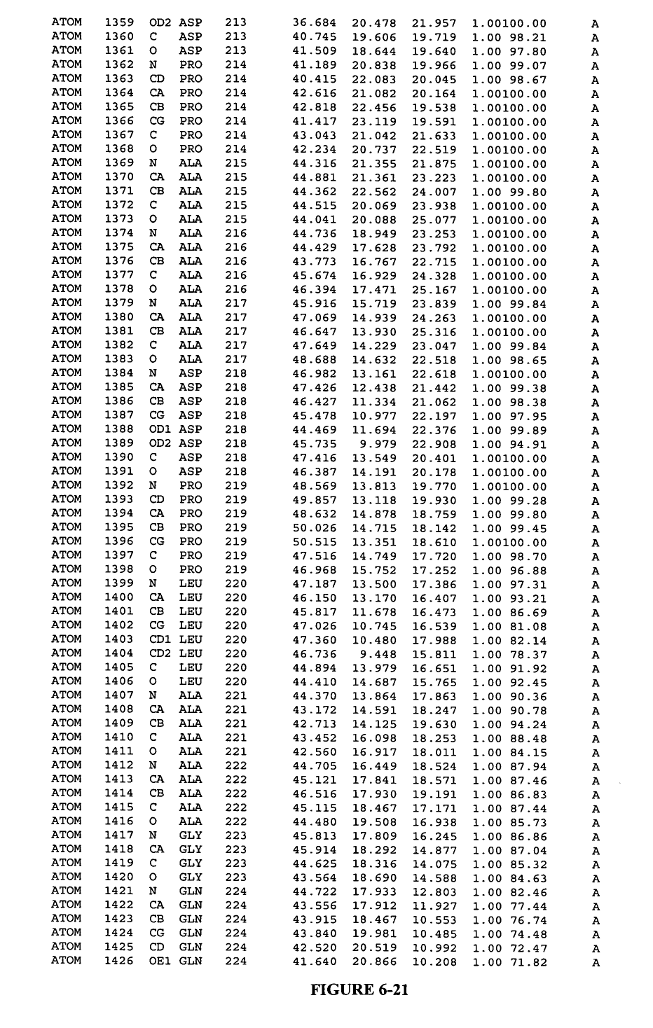

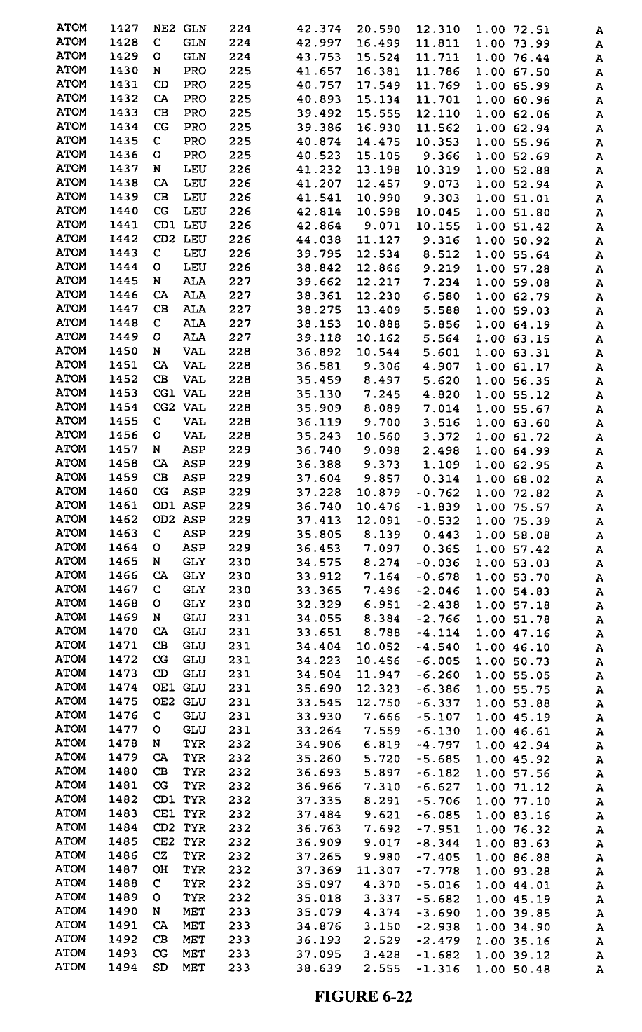

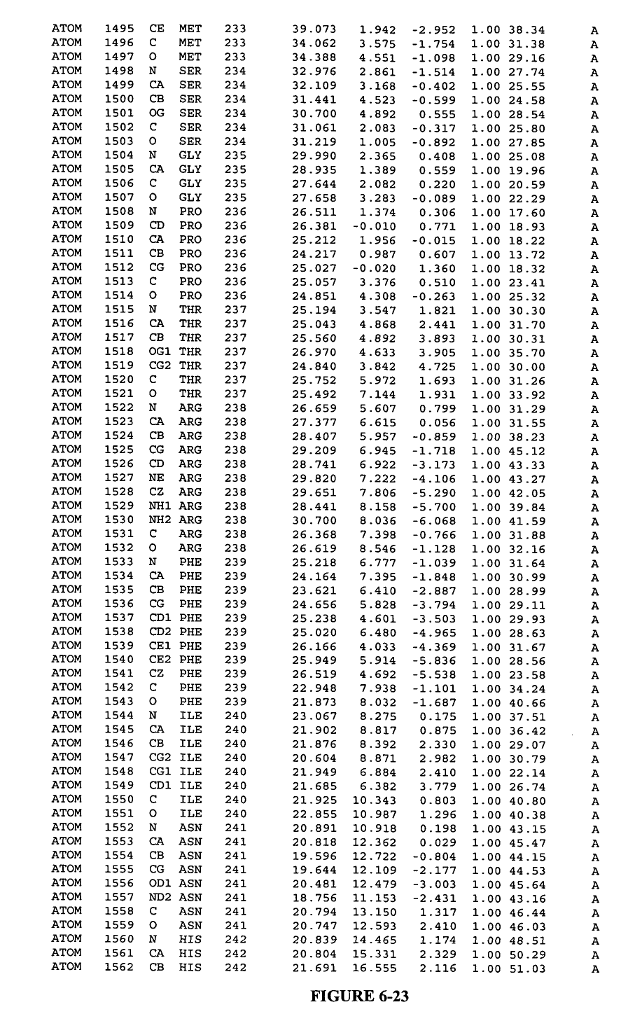

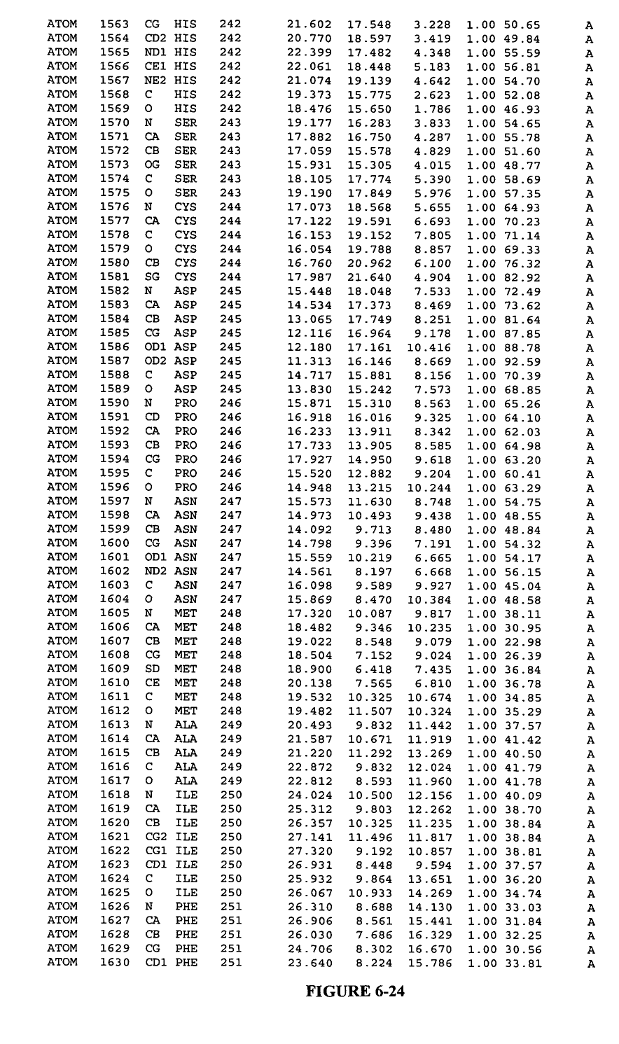

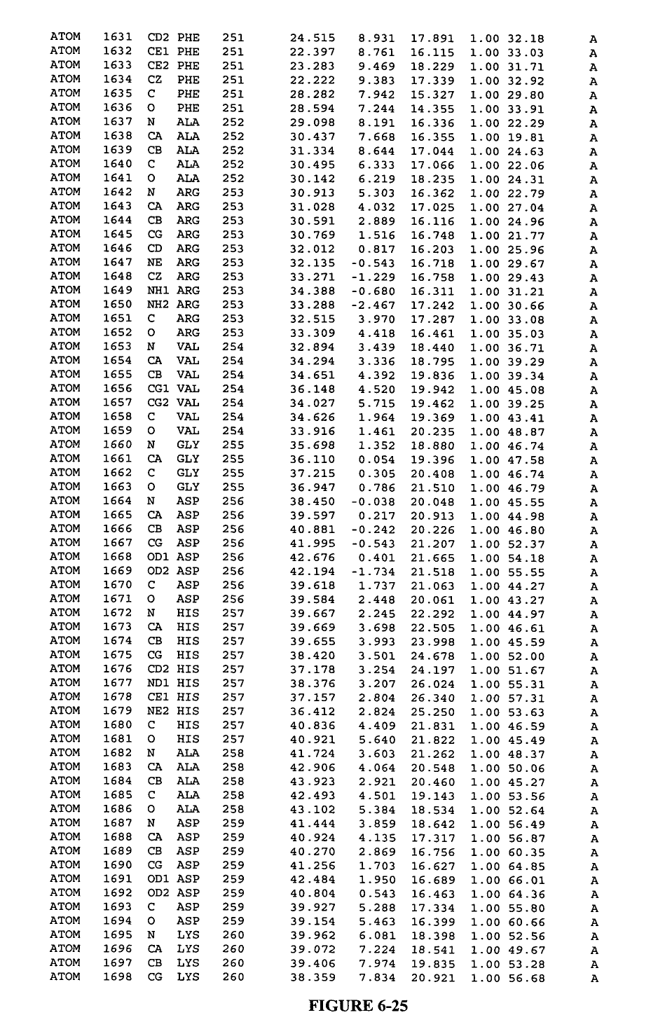

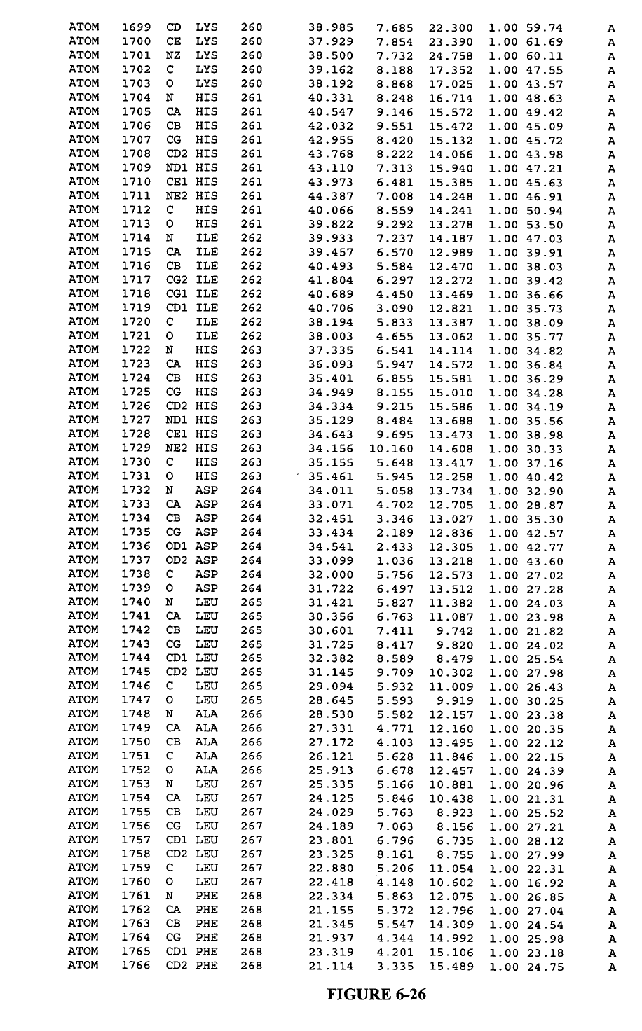

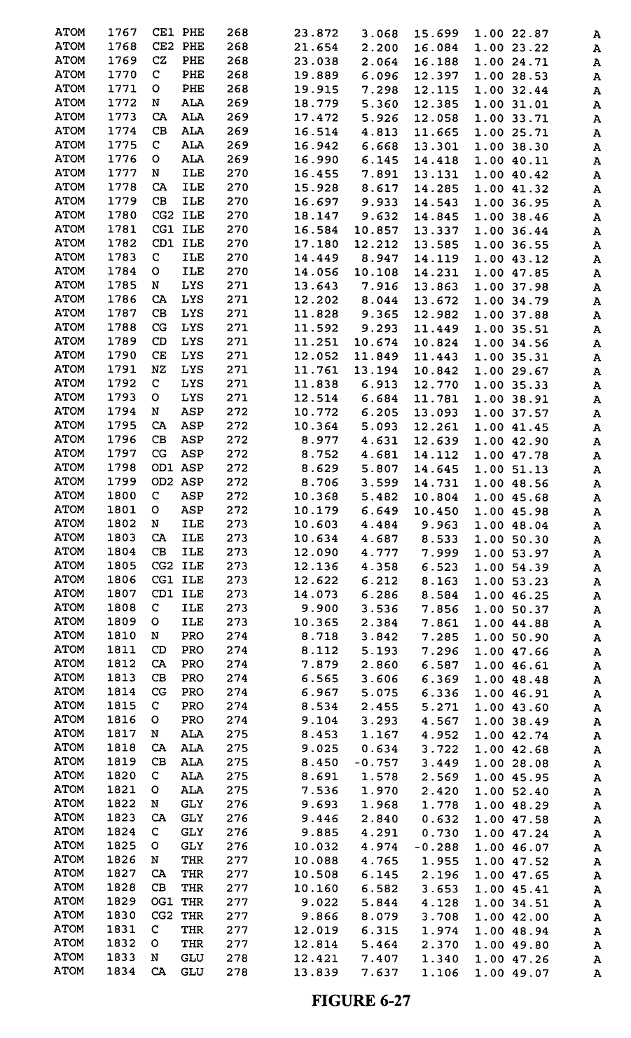

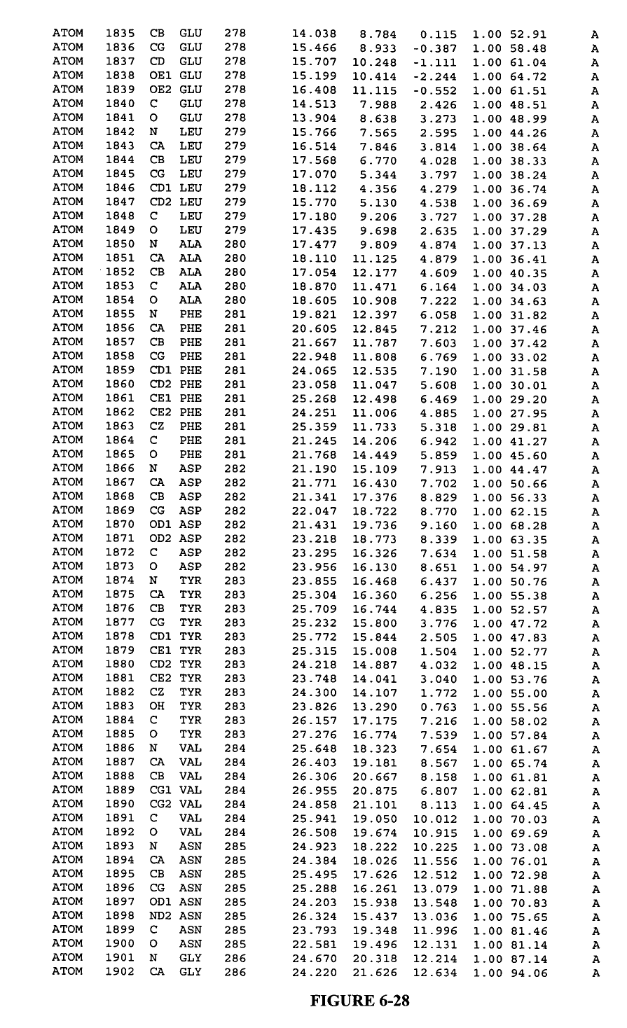

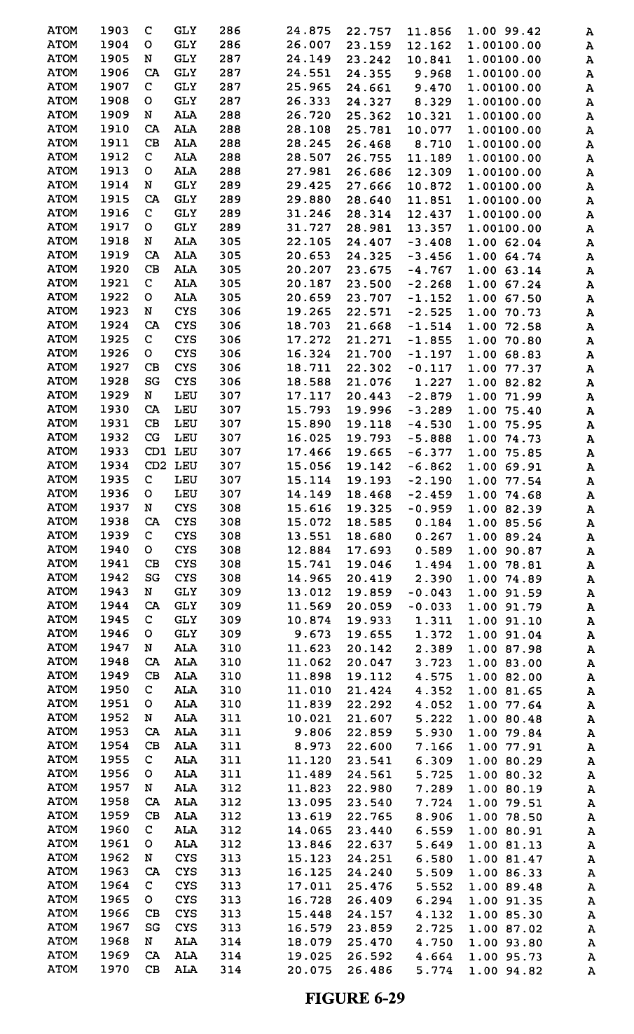

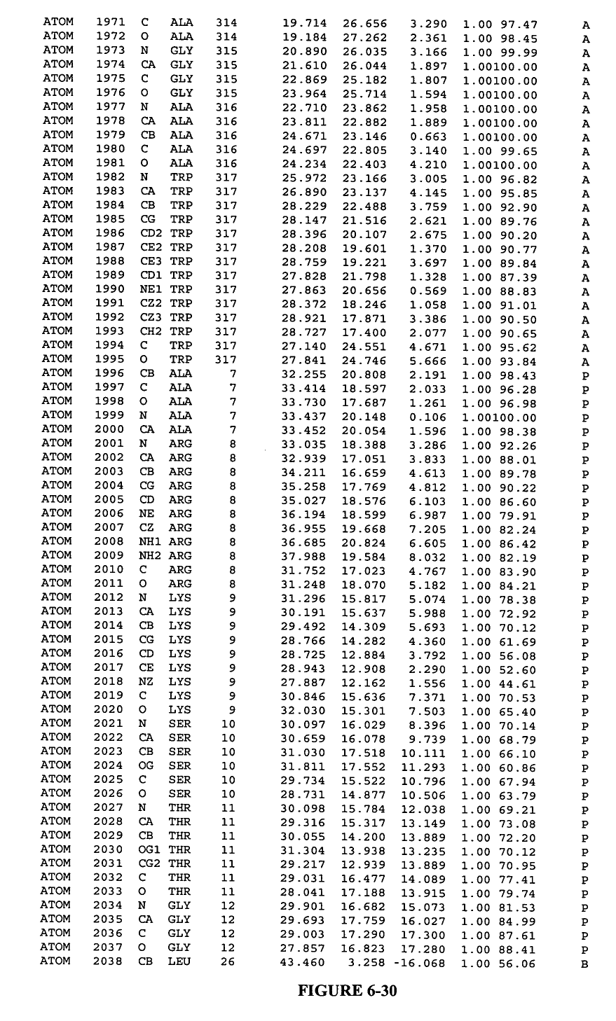

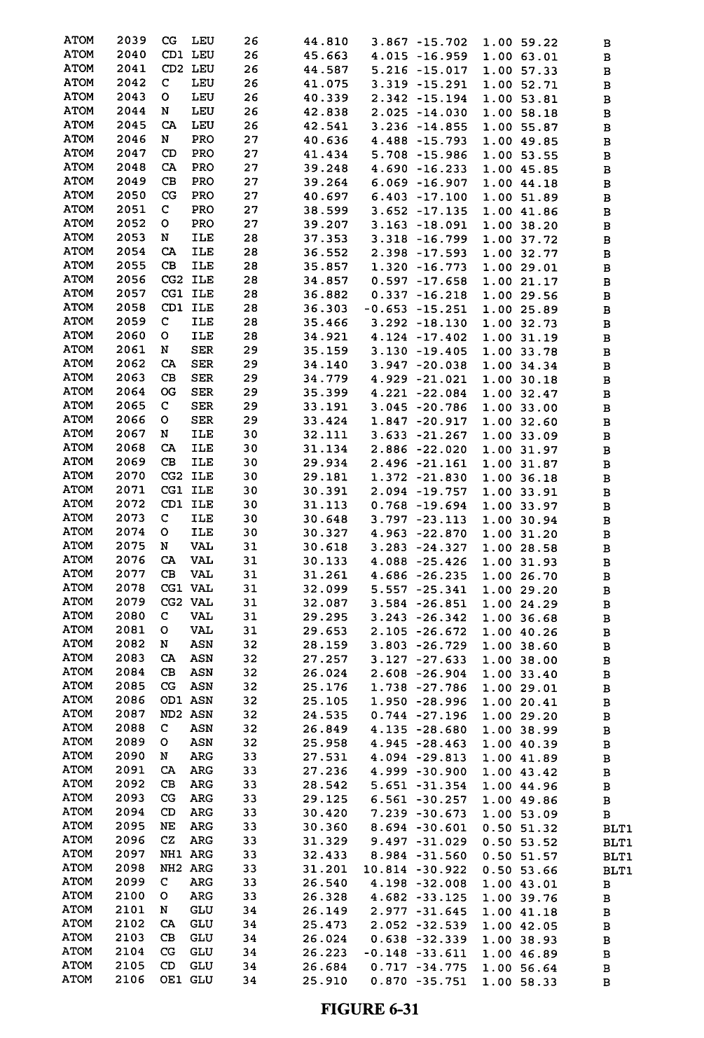

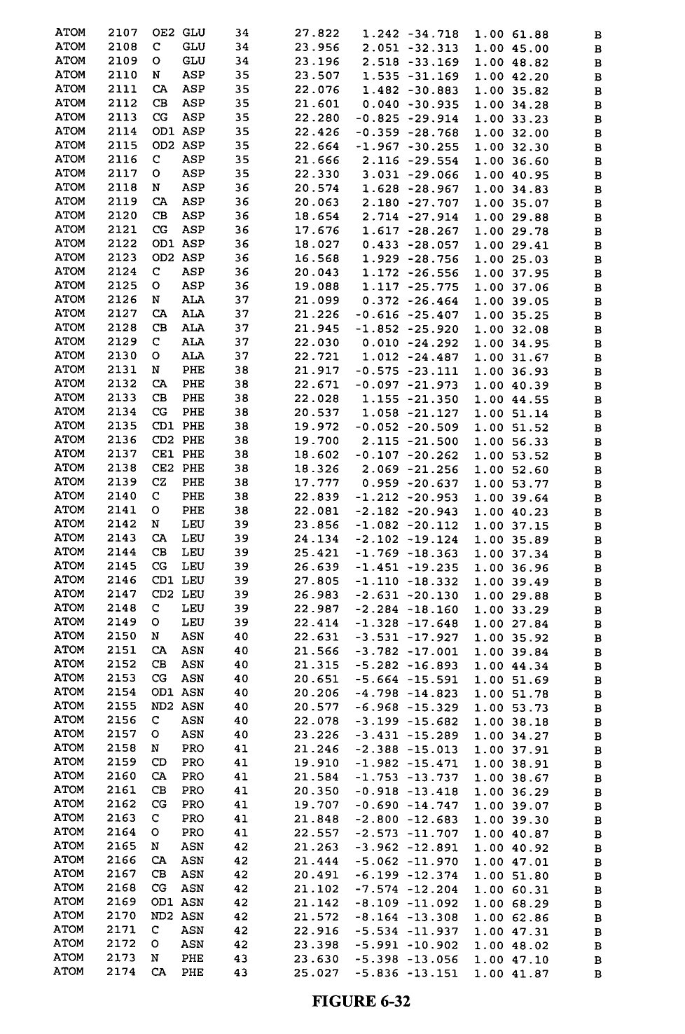

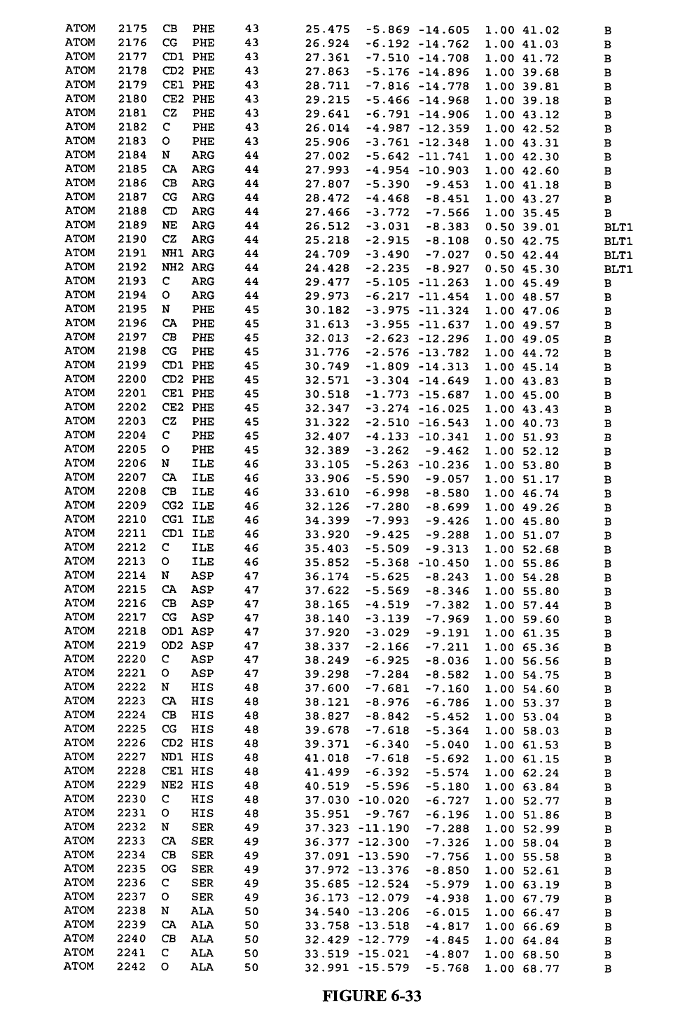

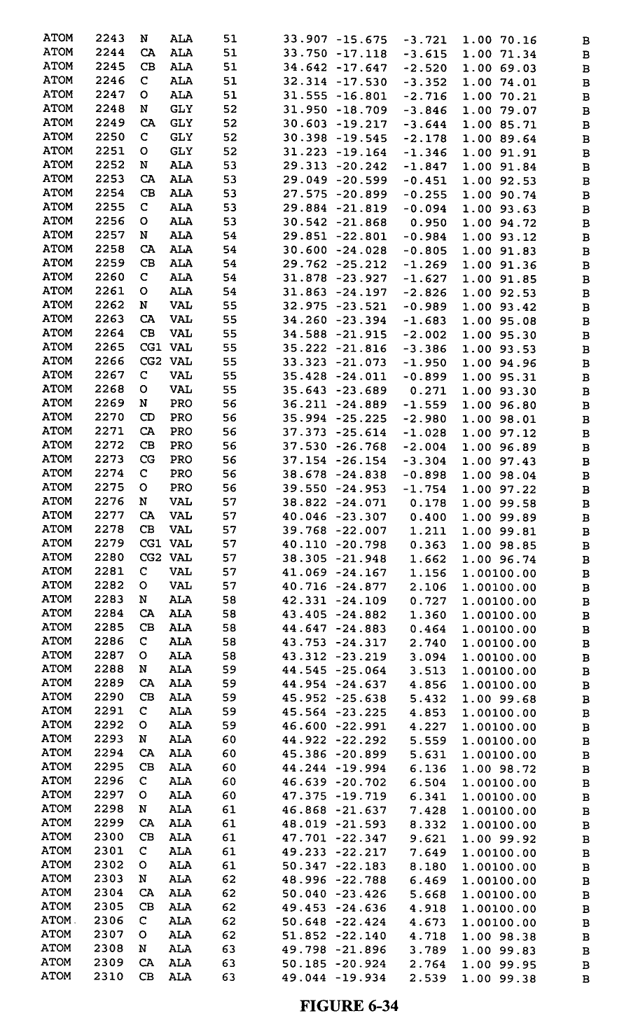

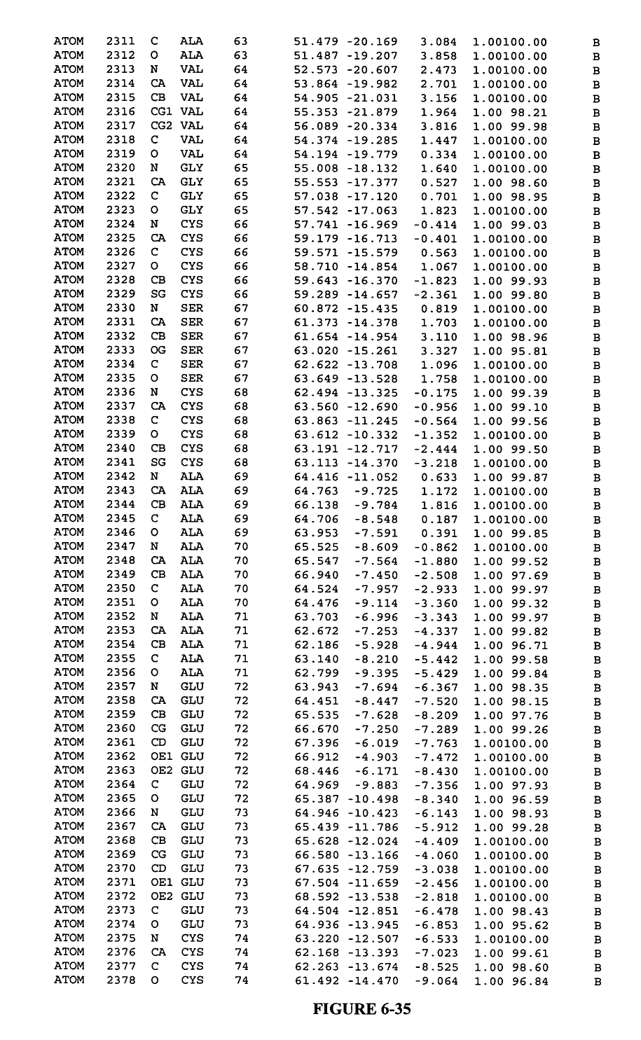

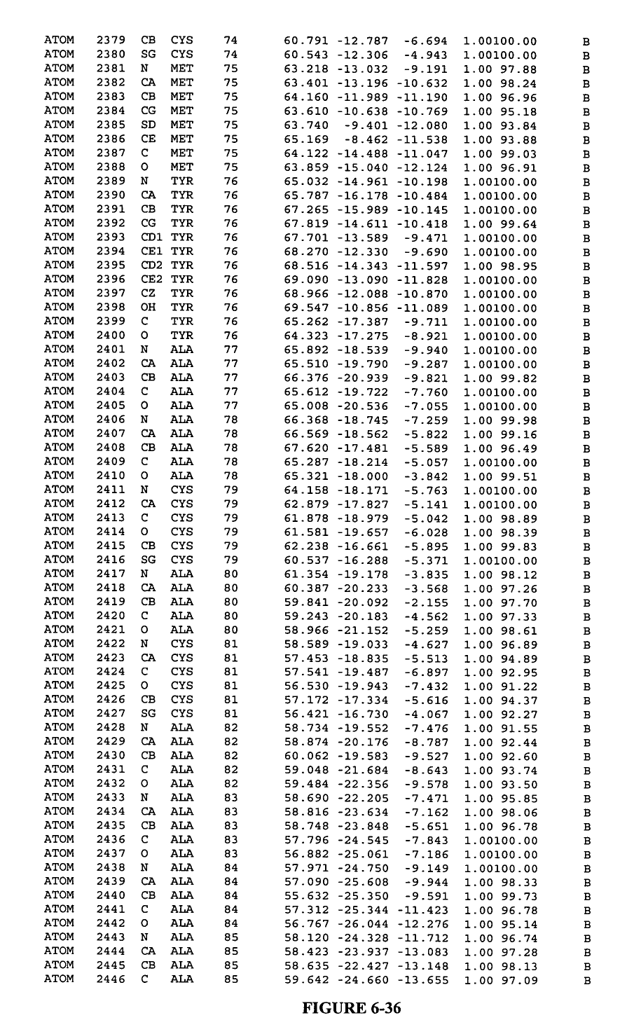

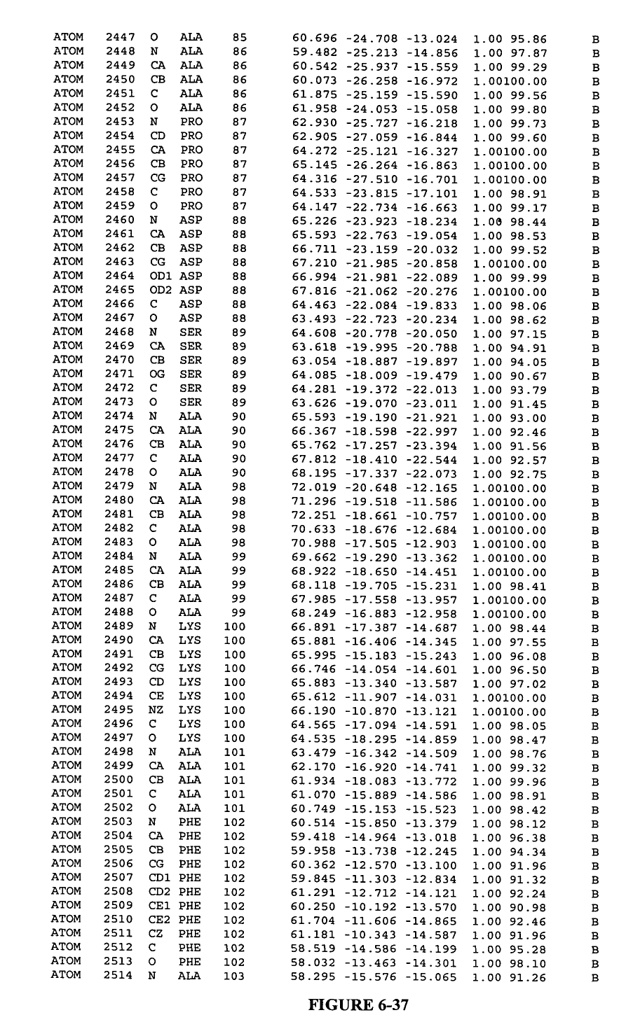

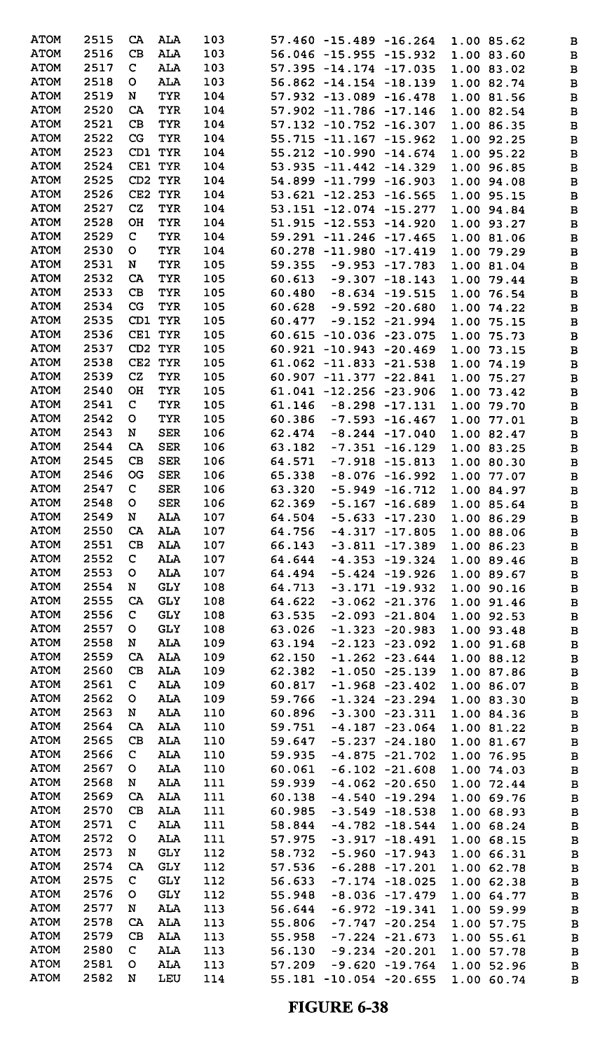

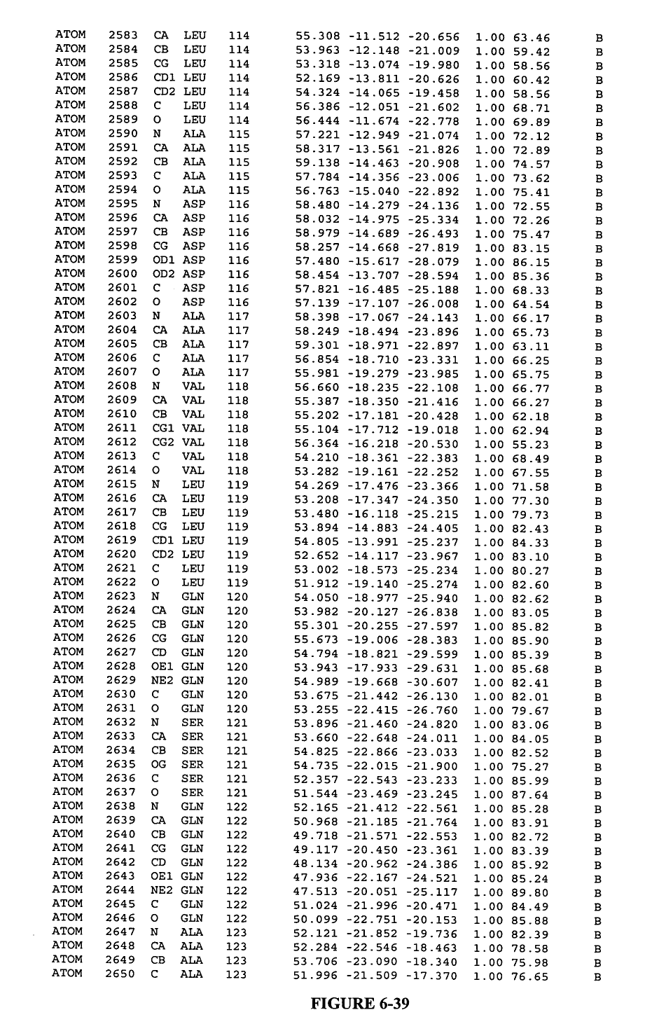

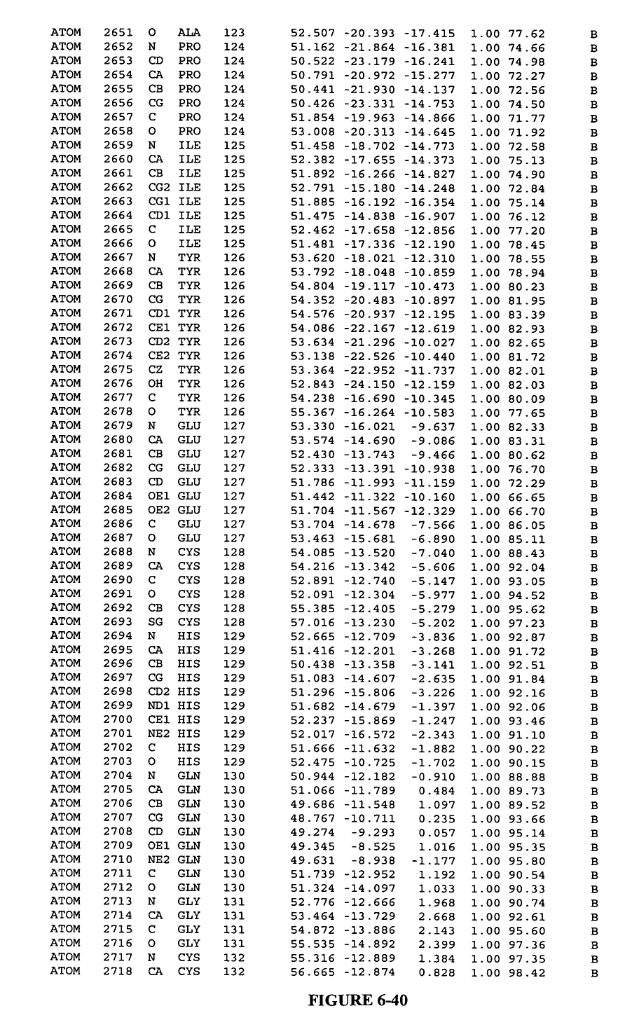

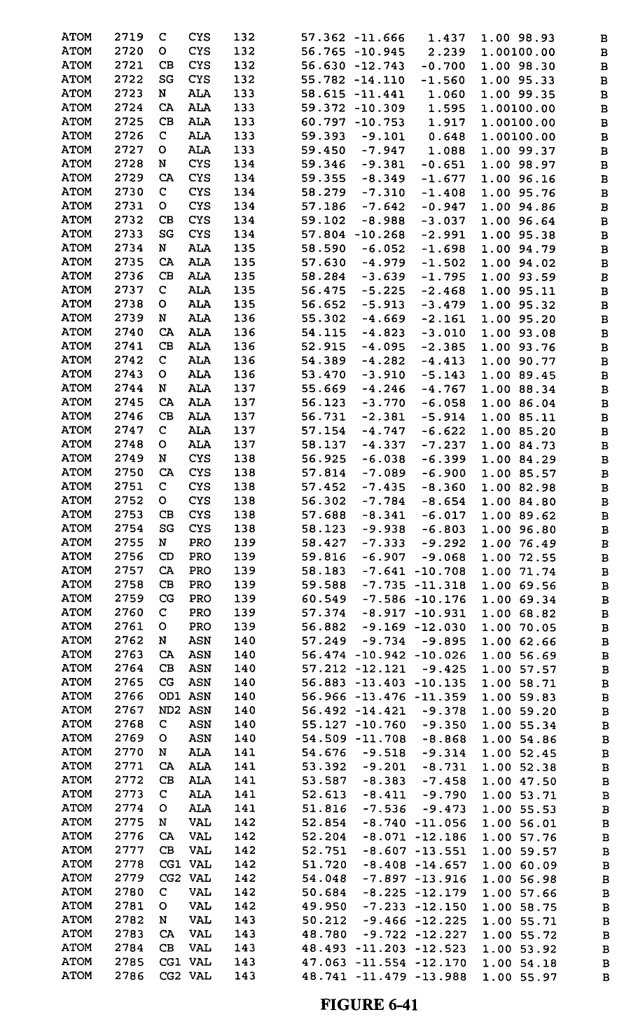

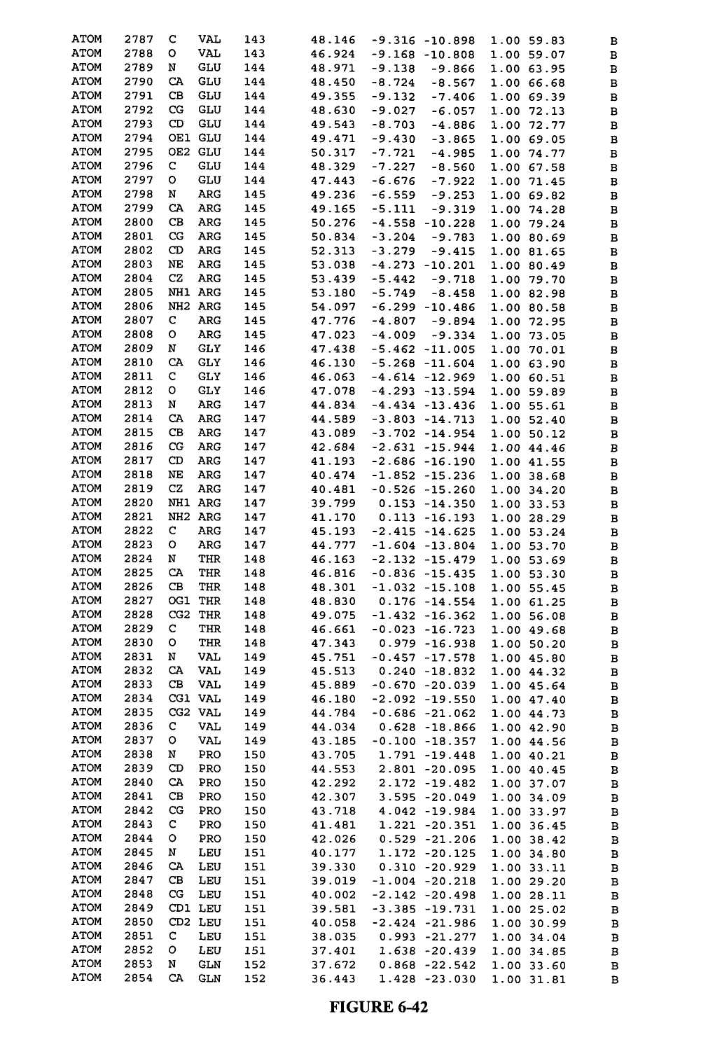

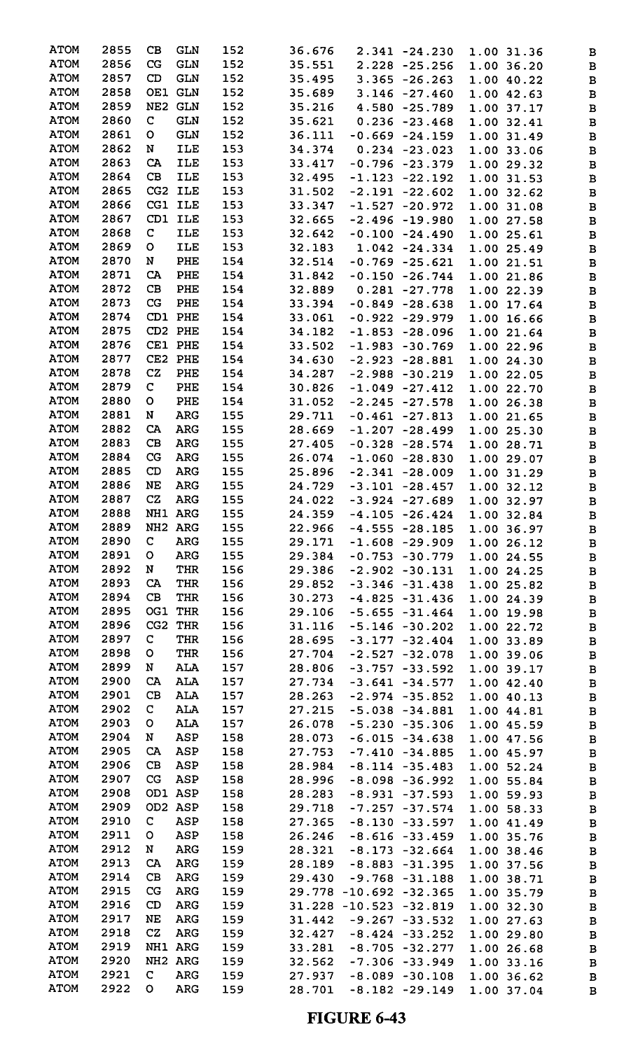

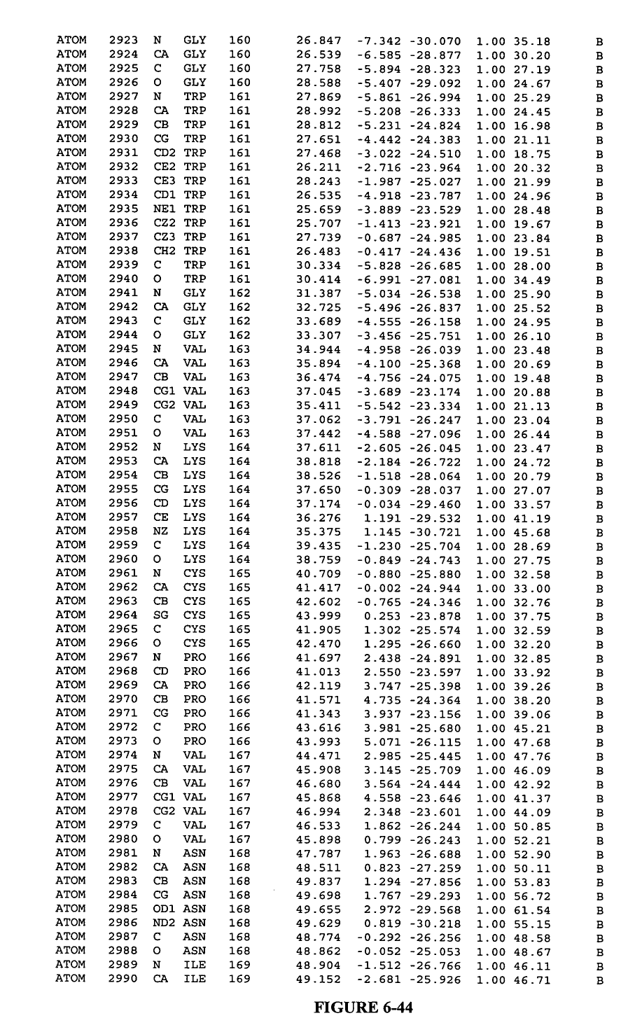

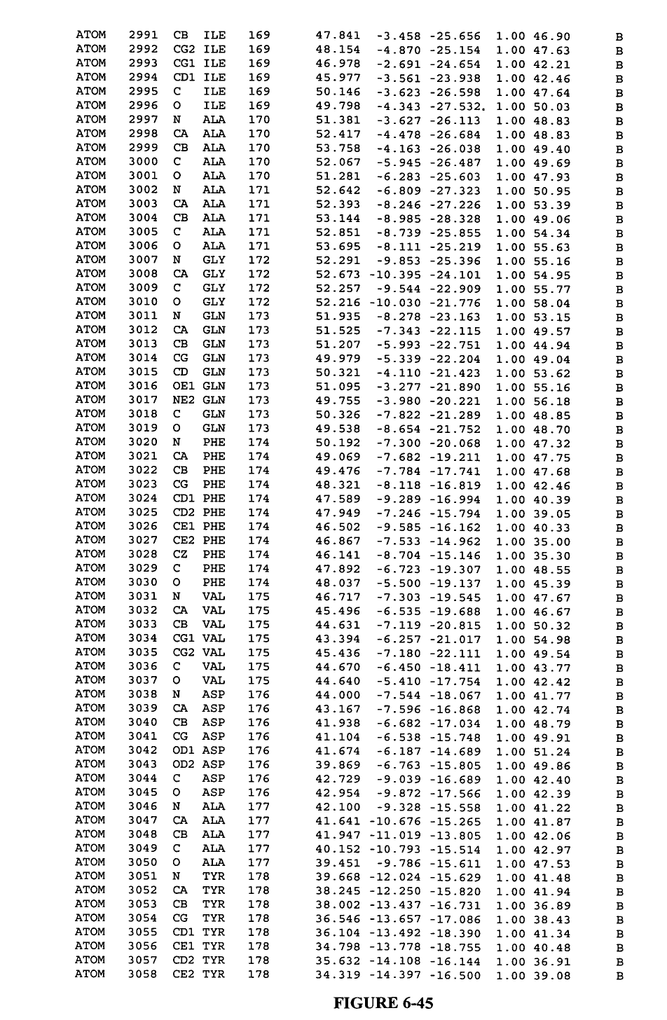

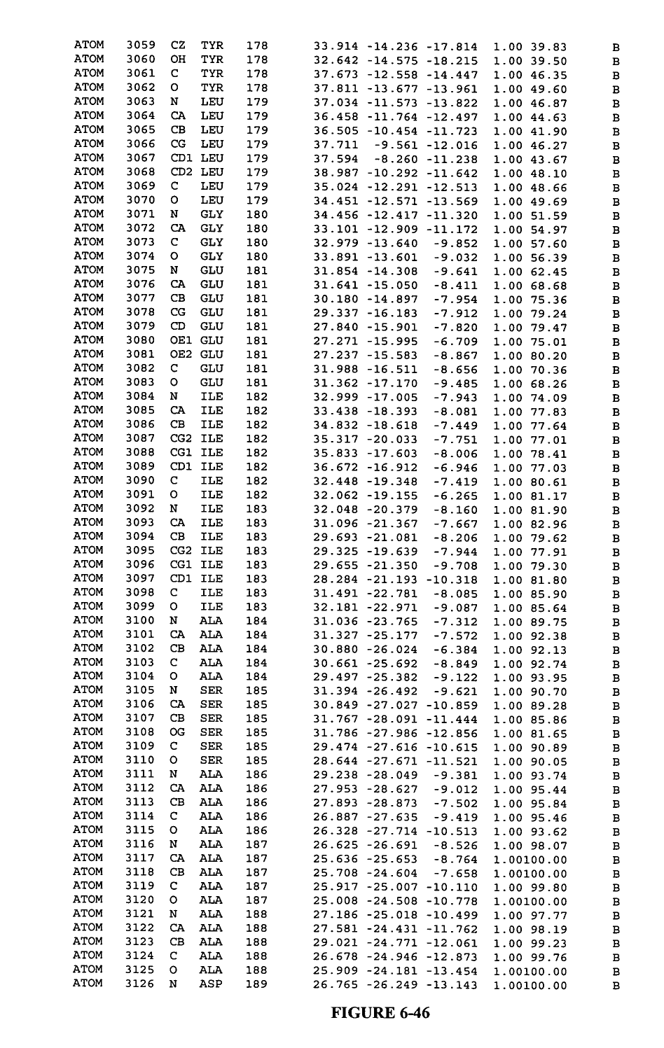

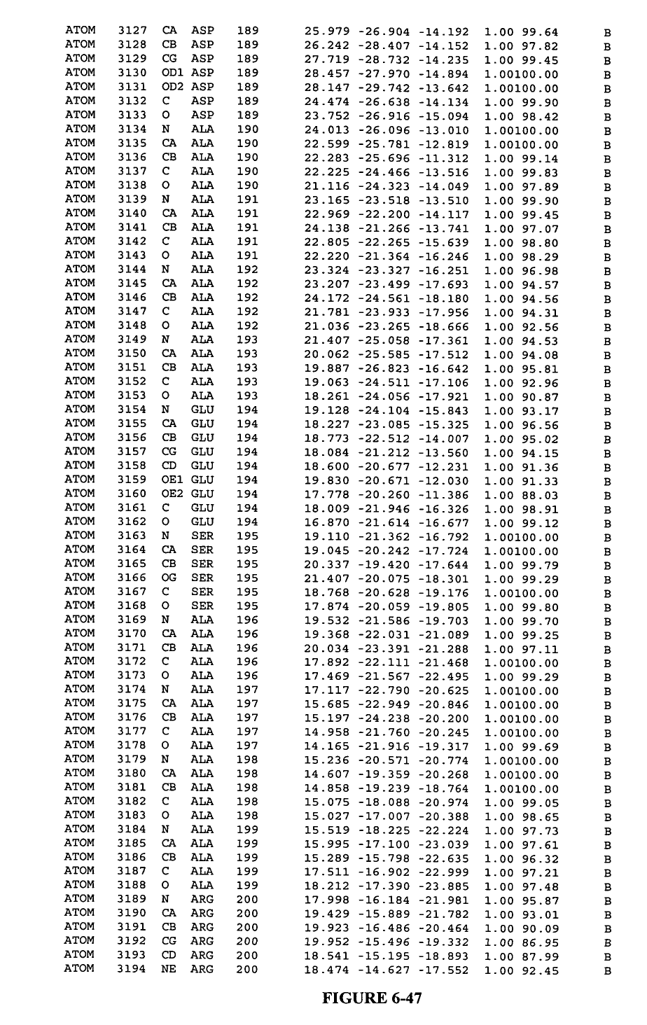

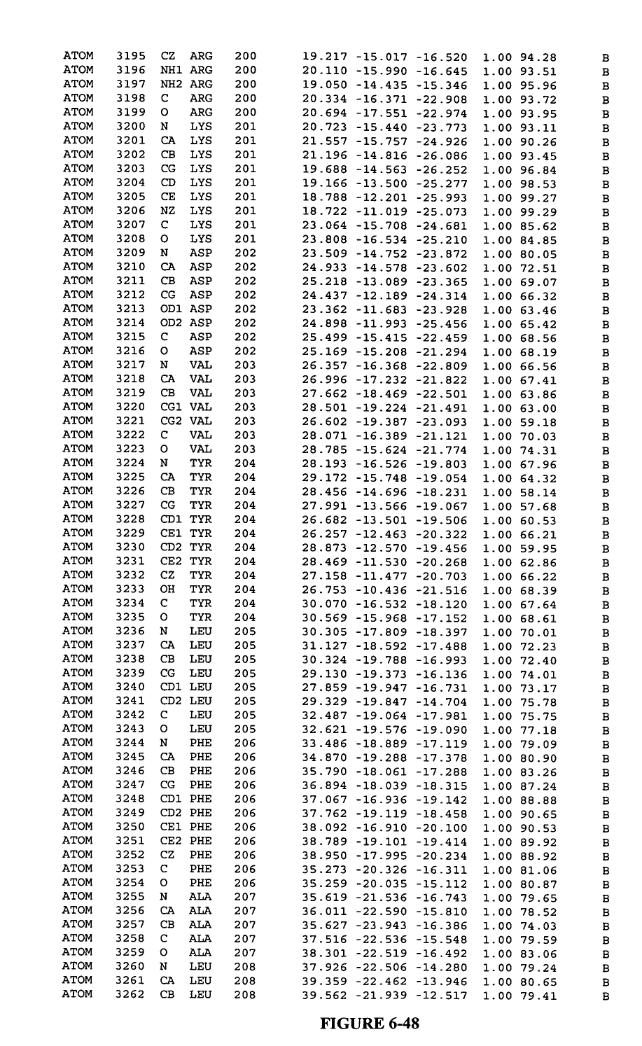

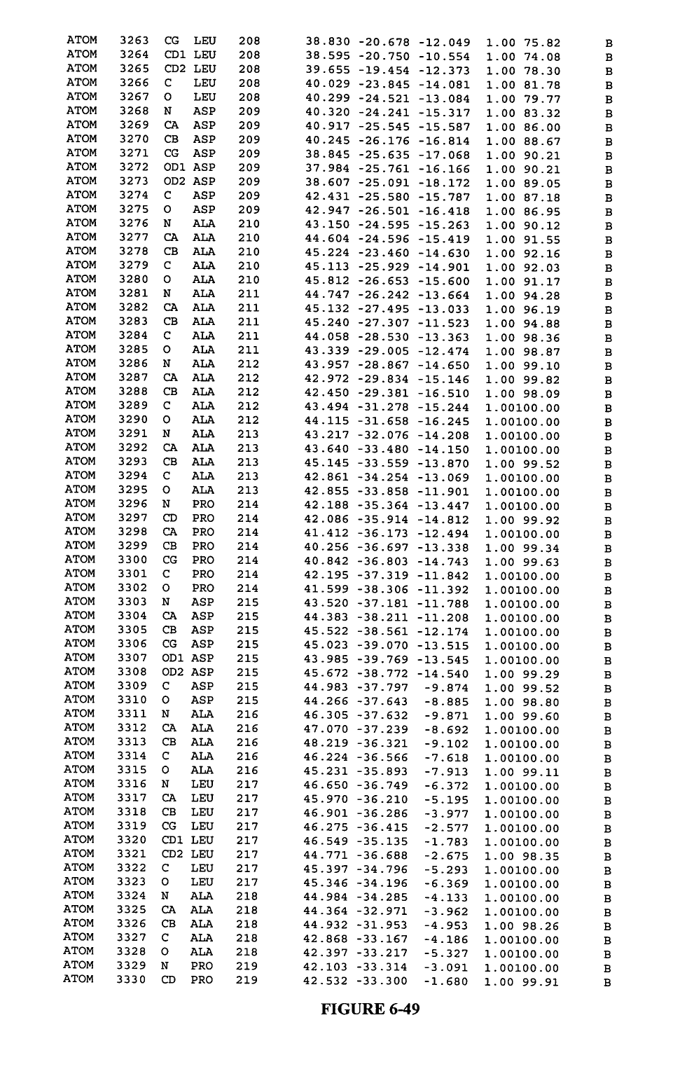

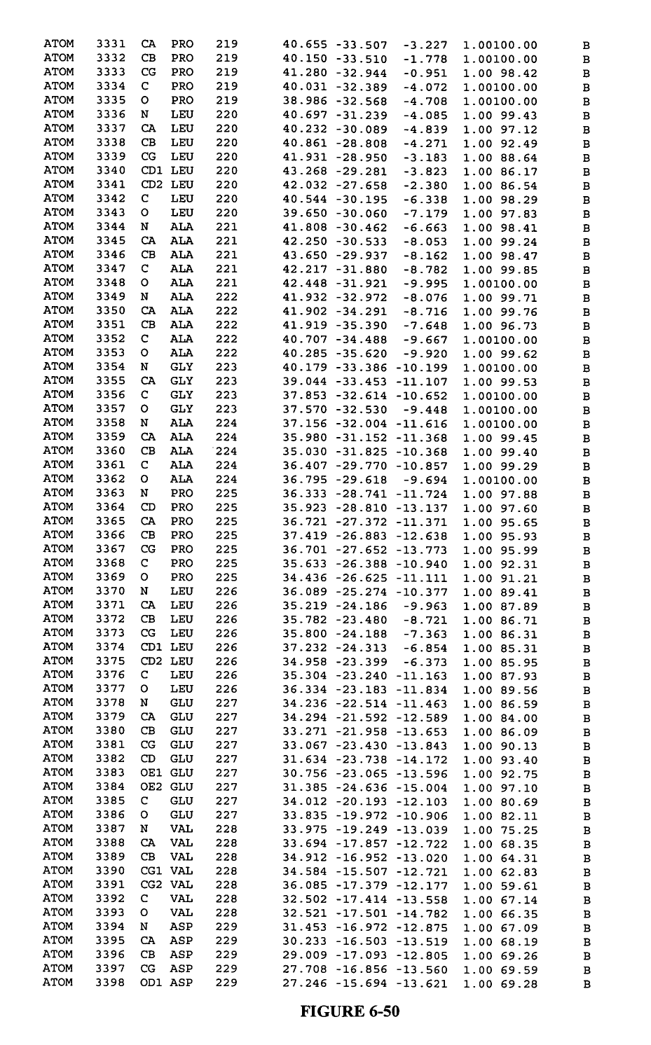

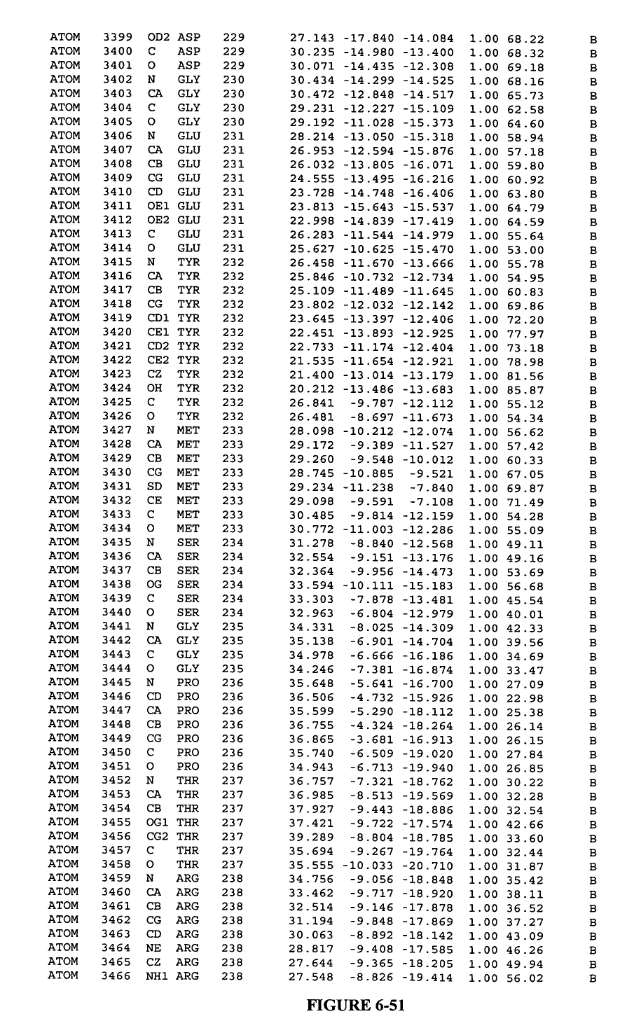

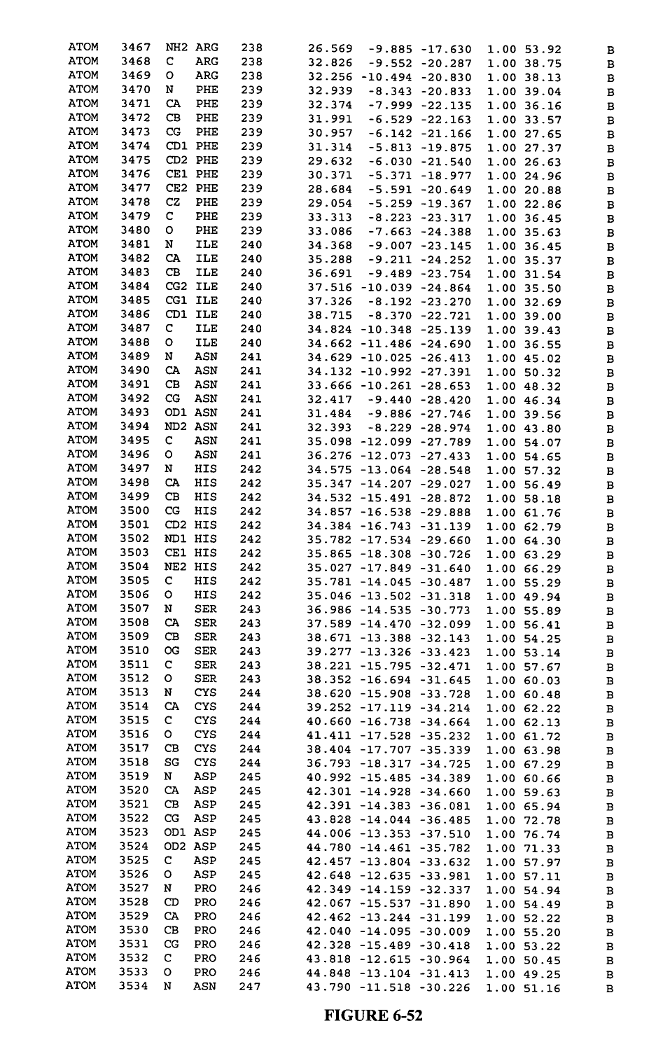

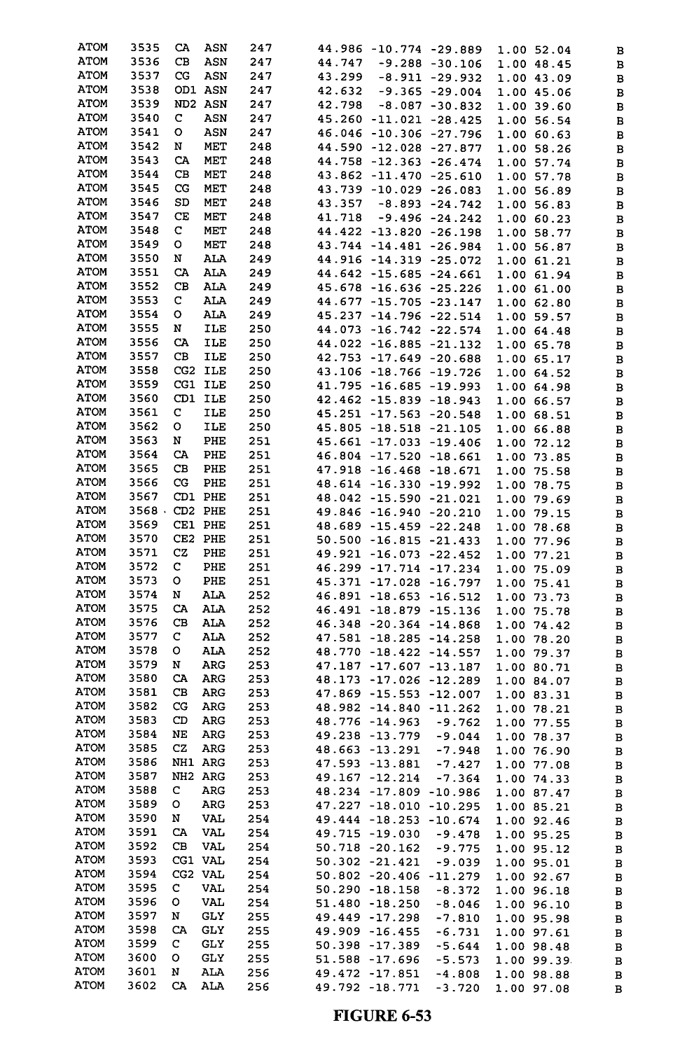

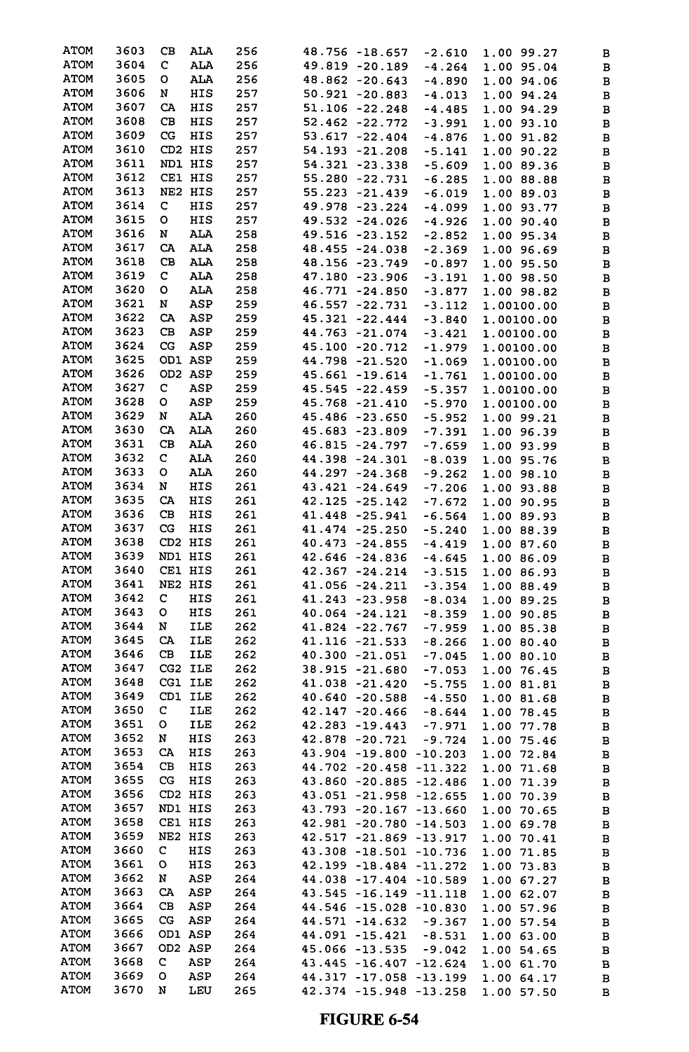

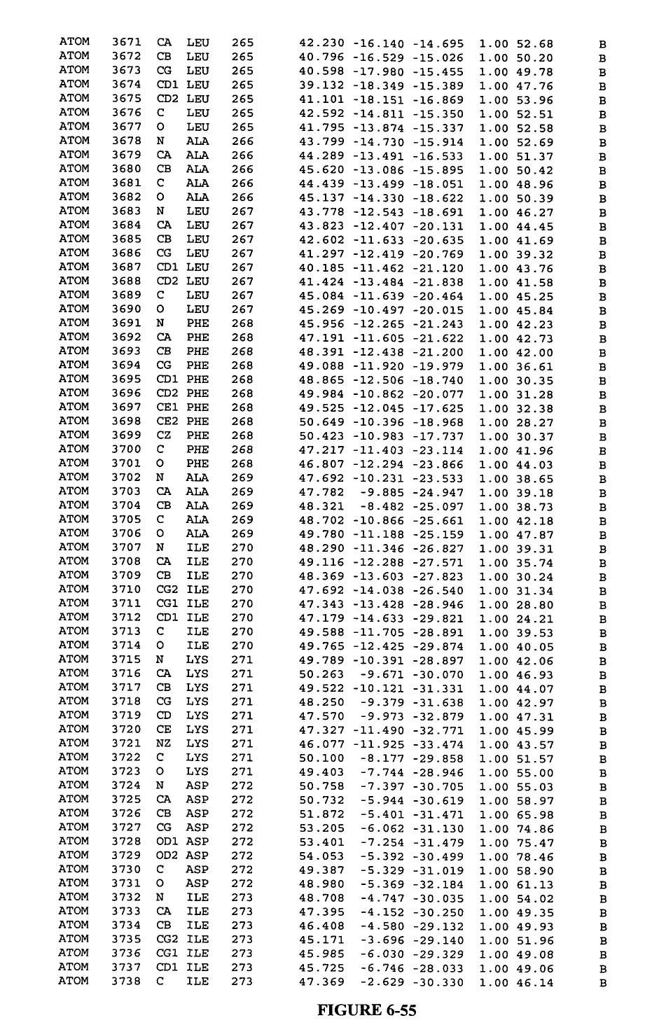

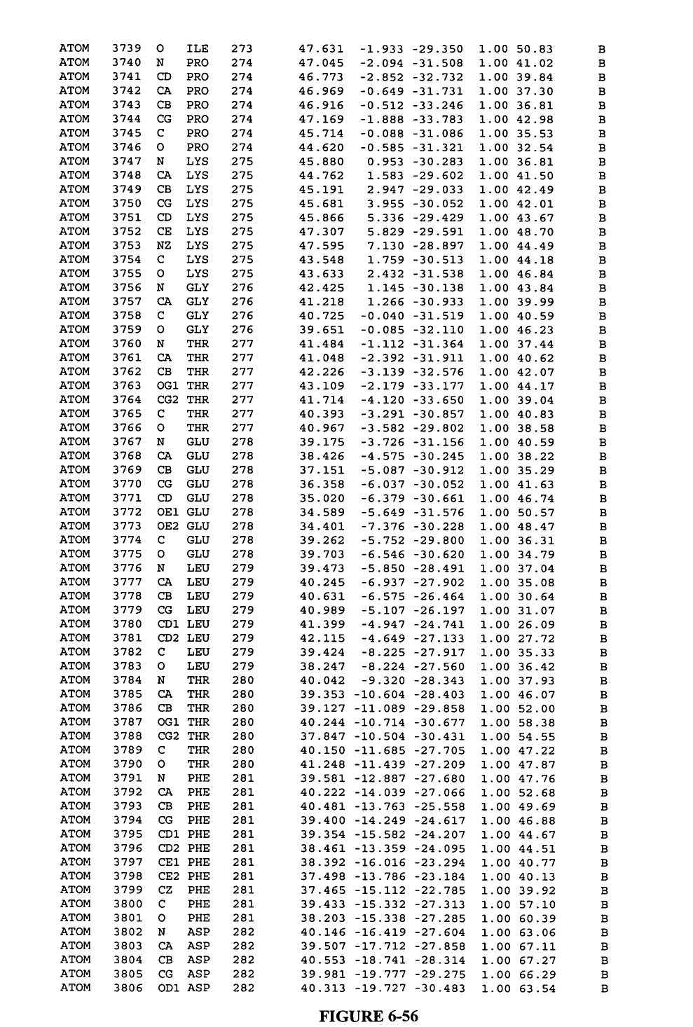

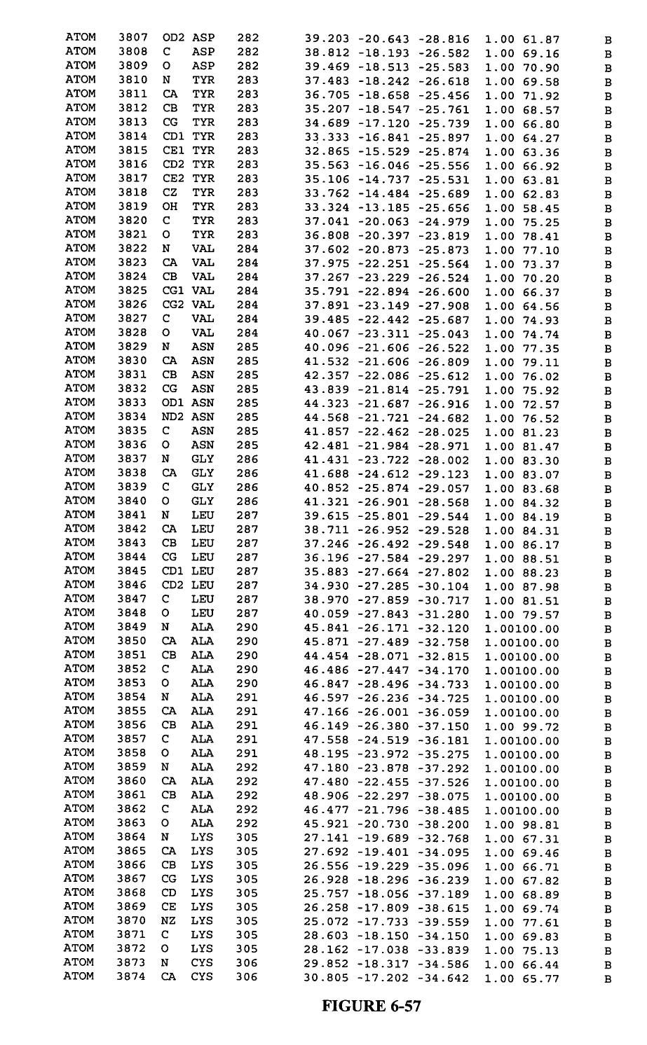

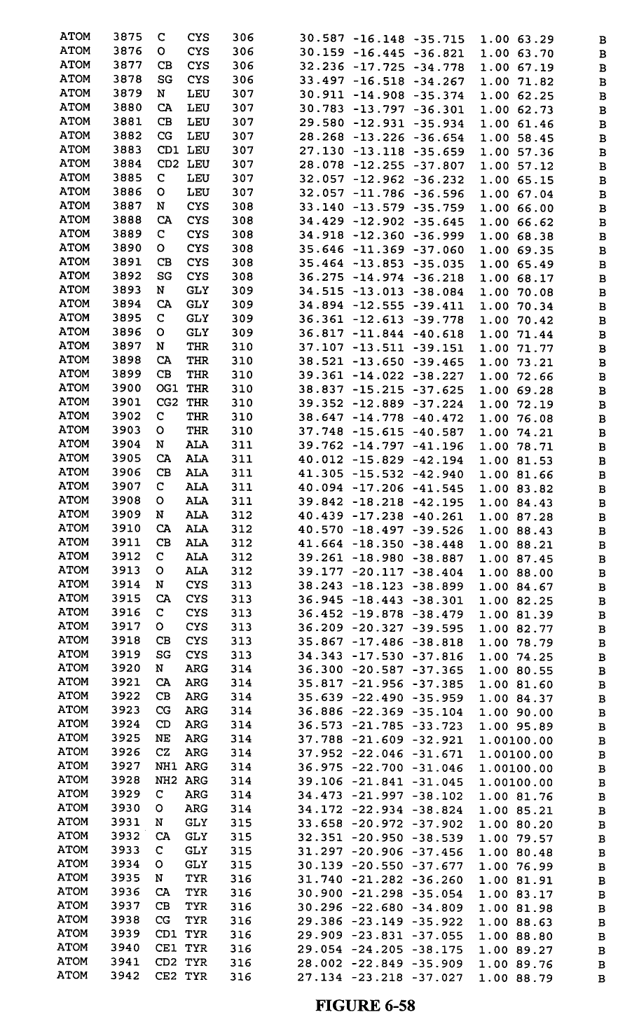

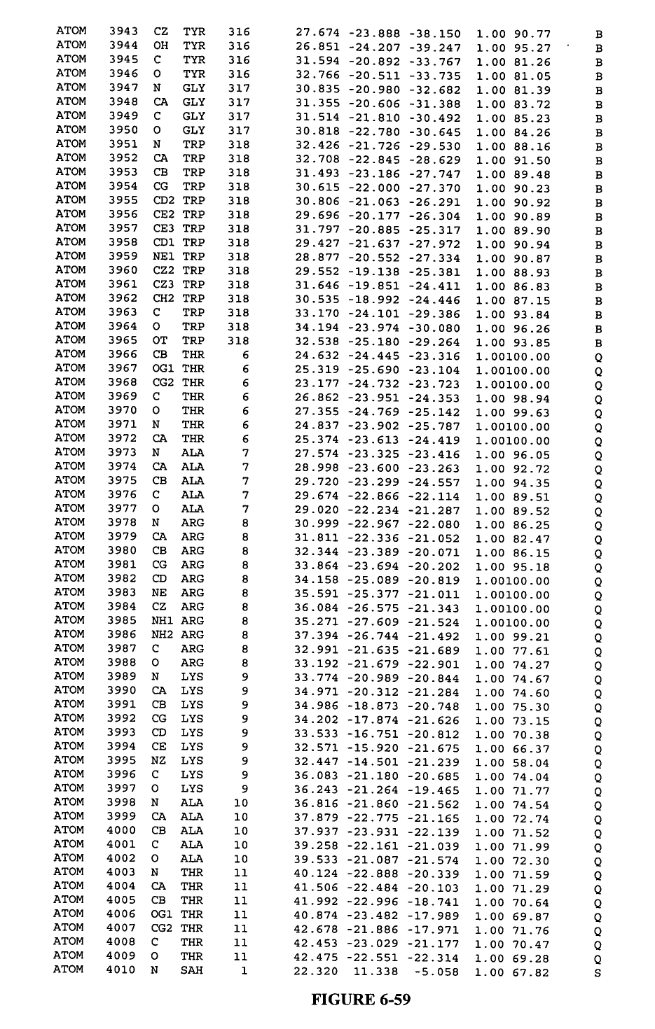

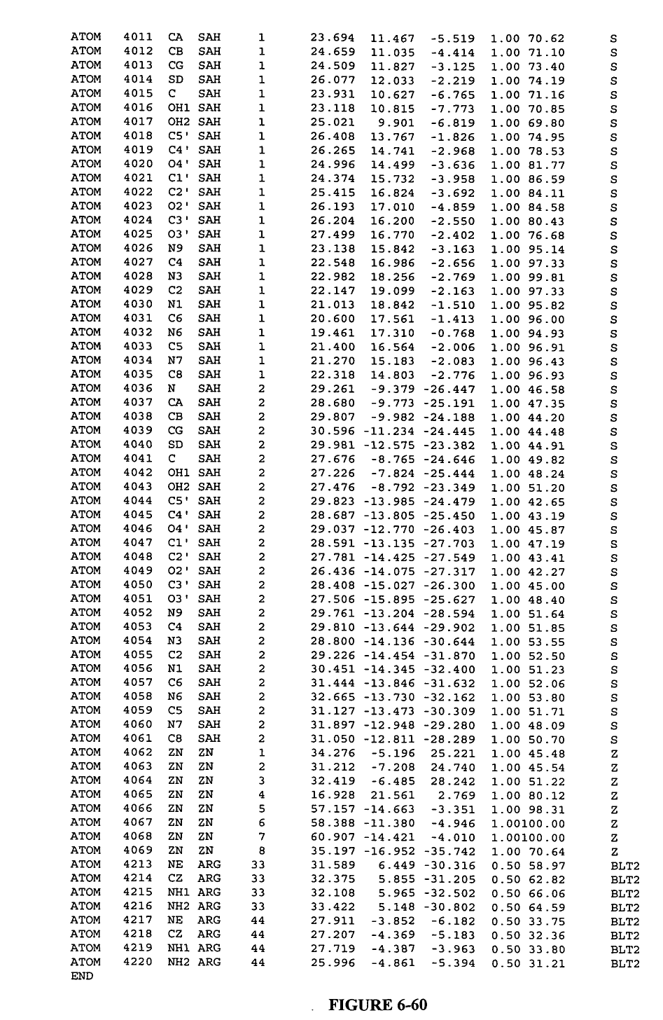

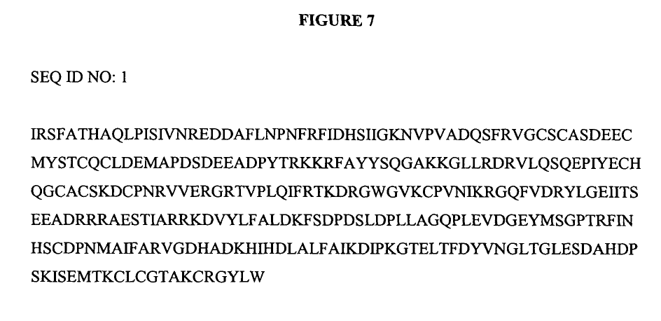

The coordinates of the structure have been deposited in the Protein Data Bank (ID code IPEG) and are also listed in FIG. 6.

Active Sites, Domains, and Druggable Regions of the DIM-5 and DIM-5 Ternary Complex Structures

The Pre-SET Domain

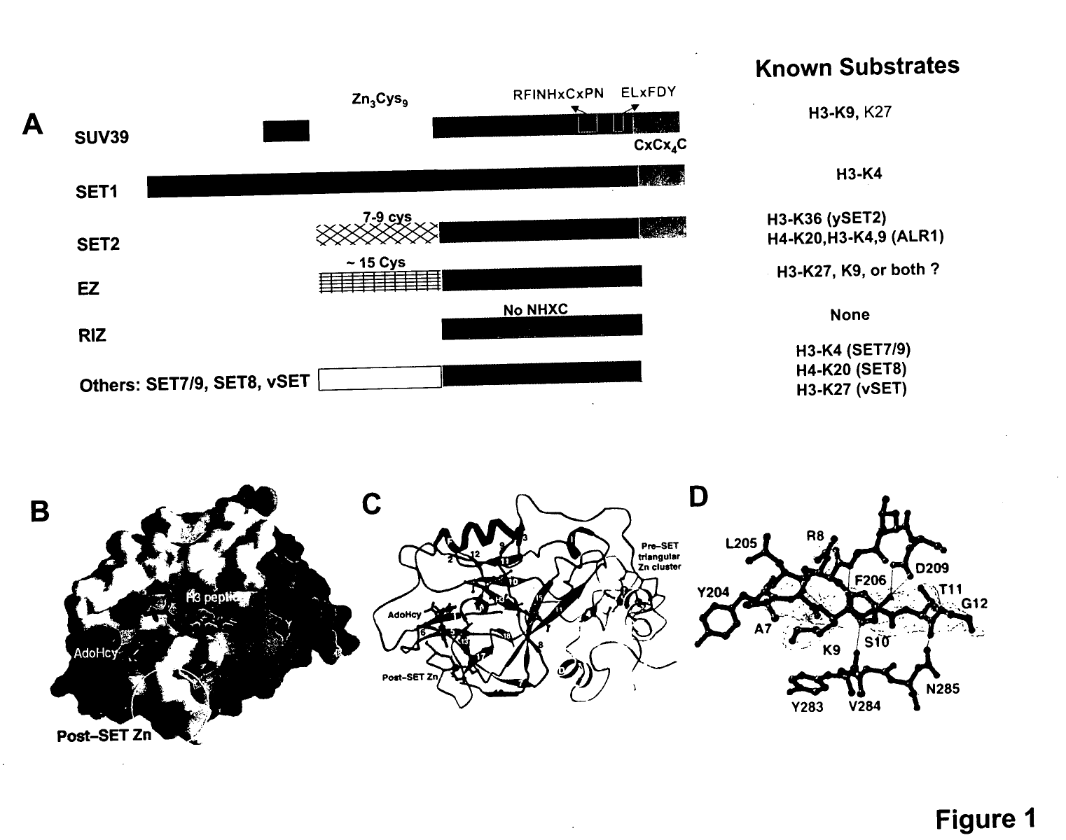

The pre-SET domain contains nine invariant cysteine residues that are grouped into two segments of five and four cysteines separated by various numbers of amino acids (46 in DIM-5). These nine cysteines coordinate three zinc ions to form an equallateral triangular cluster (FIG. 1C). Each zinc ion is coordinated by two unique cysteines (six total) and the remaining three cysteine residues (C66, C74, and C128) are each shared by two zinc atoms, thus serving as bridges to complete the tetrahedral coordination of the metal atoms. The distance between zinc atoms is ˜3.9 Å, and the Zn—S distance is ˜2.3 Å. A similar metal-thiolate cluster can be found in metallothioneins that are involved in zinc metabolism, zinc transfer and apoptosis. Methallothioneins often have two metal clusters: a (Me)₃Cys₉ and a (Me)₄Cys₁₁, where Me can be Zn²⁺, Cd²⁺, Cu²⁺ or another heavy metal. The tri-zinc cluster of DIM-5 can be superimposed perfectly upon the (Zn₂Cd)Cys₉ cluster of rat metallothionein (not shown). As noted, the pre-SET domain contains nine invariant cysteine residues that are grouped into two segments of five and four cysteines separated by a disordered region (residues 90-96). We noticed that the first-Cys segment (residues 50-99) is more mobile (with an average thermal value of 70 Å²) than the second segment (residues 100-150) with an average thermal value of 40 Å². This observation suggests an intriguing possibility that the zinc can be transferred from pre-SET triangular cluster to the post-SET domain, analogous to methallothioneins containing two metal clusters. The dynamic nature of the pre-SET domain is confirmed by a second data set, from a different crystal, collected at beamline 17-ID of the Advanced Photon Source, Argonne National Laboratory. This time we refined the structure using tighter restraints on NCS (weight=700, instead of 300 used in the previous refinement). The tighter NCS restraints resulted in a smaller difference between R-factor (0.26) and R-free (0.32) (again, no water molecules were included) at resolution range of 10-2.8 Å (28,713 reflections). However, the resulted structure is nearly identical to the previous one, particularly in the local regions around active site.

The pre-SET domain may comprise a druggable region, and modulators that inhibit its motion or ability to transfer zinc are within the scope of the present invention.

The SET Domain Forms the Active Site

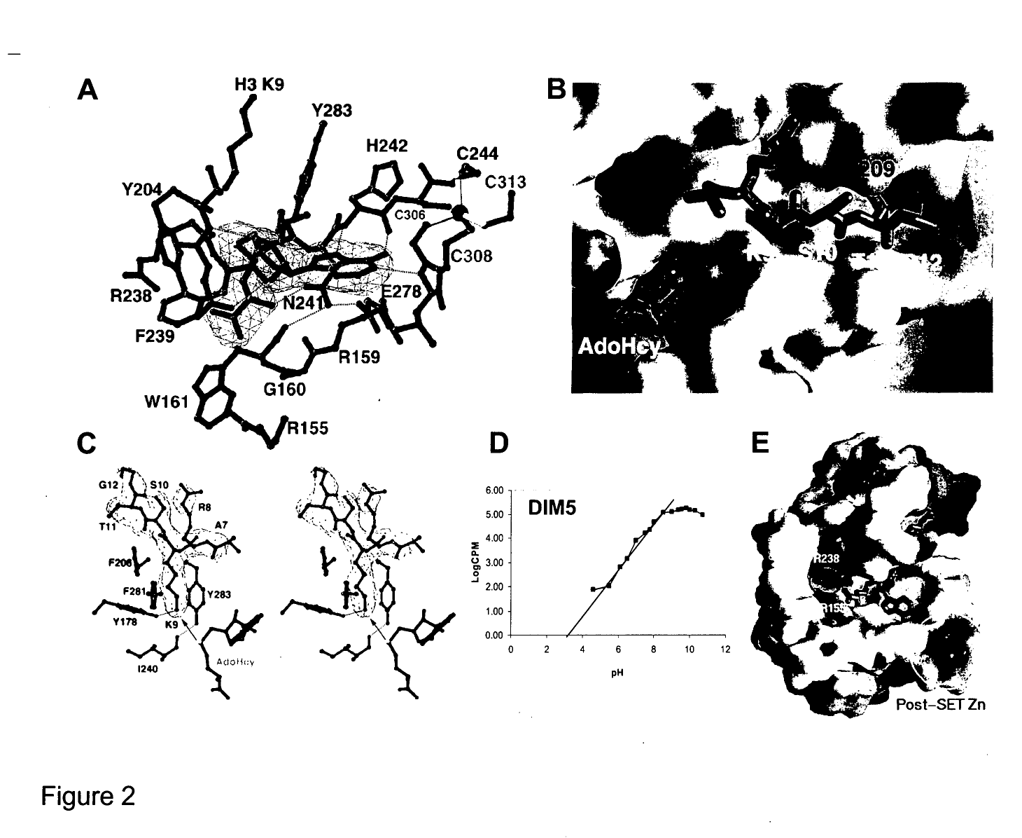

The SET domain resembles a square-sided β barrel topped by a helical cap (αF, αG, αH and αI). Four β sheets—(1↑ 5↑ 6↓) (7↑ 16↓) (4↓ 14↑ 15↓ 8↑) and (3↑ 9↑ 11↓ 10↑)—form the sides of the barrel and one sheet—(2↓ 12↓)—forms one end (FIG. 2A). In the middle of the open end of the barrel is a crossover structure (magenta) formed by threading the p17-loop through an opening formed by a short loop between strands β13 and β14. This brings together the two most-conserved regions of the SET domain: the αJ-β13-loop (N₂₄₁HXCXPN₂₄₇) and β17-loop (DY₂₈₃) (FIG. 1). The side chains of these two highly conserved segments are involved in (1) hydrophobic structural packing (1240 of αJ and L279 and F281 of β17); (2) intramolecular side chain-main chain interactions (after a sharp turn at P246, the side chain of N247 interacts with the main chain carbonyl oxygen of E278 and the main chain amide nitrogen of T280), (3) AdoMet binding site and active-site formation (R238 and F239 of αJ, N241:E278 pair, H242:D282 pair, and Y283). These invariant residues are clustered together, via pair-wise interactions such as the interactions between N241 and E278 and between H242 and D282, forming an active site in a location immediately next to the AdoMet binding pocket and peptide binding cleft (see below). All or a portion of the SET domain may comprise a druggable region.

AdoMet/AdoHcy Cofactor Binding Pocket

All known HKMTs use AdoMet as the methyl donor. The most common conformation of AdoMet, or its reaction product AdoHcy, is found in the so-called “consensus” MTases. These MTases are built around a mixed seven-stranded β-sheet, and they include more than 20 structurally-characterized MTases acting on carbon, oxygen, or nitrogen atom in DNA, RNA, protein, or small molecule substrates. DIM-5 does not share structural similarity to any of these AdoMet-dependent proteins and appears to use a completely different means of interaction with its cofactor.

The methyl-donor product, AdoHcy, is located in an open concave pocket (FIG. 2E) in a folded conformation. A similar cofactor conformation was observed in Rubisco MTase and SET7/9. The AdoHcy is kinked in a manner similar to that of AdoHcy bound to the class III MTase CbiF, a MTase that acts on the ring carbons of precorrin substrates, but is significantly different from the extended conformation most frequently observed in the widespread class I MTases such as the DNA MTases. DIM-5 interacts with all three moieties of AdoHcy, the adenine base, the ribose, and the homocysteine, through van der Waals contacts and hydrogen bonds (FIG. 2A).

We made conservative substitutions for several of the residues surrounding this density: R155H, W161F, Y204F and R238H (see Example 1). The enzymatic activities of all the mutants were reduced ranging from a 75% reduction (W161F) to nearly inactive (R238H). The ability of these mutants to bind AdoMet, as measured by crosslinking, was also reduced but not abolished. It appears that the reduced AdoMet binding alone could account for the reduction in HKMT activity for the R155H, W161F, and Y204F mutations. The R238H mutation, however, caused a much greater reduction in HKMT activity than in AdoMet binding, suggesting that R238 may also play roles in other aspects of catalysis. In SUV39H1 and SUV39H2, a histidine is in the position of R238 in DIM-5; changing this histidine to an arginine resulted in at least 20-fold increase of activity in SUV39H1, consistent with the greatly reduced activity in the converse R238H mutants of DIM-5.

Interestingly the concave pocket is larger than necessary to accommodate just one AdoHcy. In particular, there is an open space next to the bound AdoHcy in the orientation shown in FIG. 2E, where a less-ordered cofactor, surrounded by the highly conserved residues R155, W161, Y204, and R238, was observed in the binary structure of DIM-5-AdoHcy. This suggests that the bound AdoHcy moves towards the active site upon peptide binding, and accounts for the reduced, but not abolished, AdoMet binding ability of the R155H, W161F, Y204F and R238H mutants. This movement path would permit the exchange of the reaction product AdoHcy with AdoMet without releasing the peptide substrate and therefore should allow methyl transfers to proceed processively. Indeed, DIM-5 forms trimethyl-lysine, with little accumulation of mono- and di-intermediates. Considering that different methylation products might have different signaling properties, it is important to understand the structural basis for this apparent processivity.

All or a portion of the AdoMet/AdoHcy binding pocket may comprise a druggable region.

Peptide Binding Cleft

The histone tail peptide binds in a surface groove (FIG. 1B), inserted as a parallel β strand (red in FIG. 1C) between two DIM-5 strands, β10 (green) and β18 (magenta), and completes a 6-stranded hybrid β sheet (3↑ 9↑ 11↓ 10↑, H3↑, 18↑). The insertion of the target H3 peptide as a β strand is reminiscent of the interactions seen in the heterochromatin protein HP1 with a methylated histone H3 peptide, though in that case, the H3 peptide is inserted as an antiparallel strand between two HP1 strands. The binding of H3 peptide as a beta-strand may also explain why acetylated peptides are poor substrates for HKMTs. There is evidence that acetylation of histone N-terrnini increases their helical content, and a helical H3 tail is not expected to fit in the HKMT binding groove.

Recognition of the target Lys-9 is achieved through a variety of interactions between DIM-5 and the surrounding H3 sequence, including backbone-backbone, backbone-side chain, and side chain-side chain: (i) The main chain (N—H and C═O) of H3 Lys-9 hydrogen bonds with DIM-5 residues L205 (C═O) and A207 (N—H). (ii) While the main chain N—H of H3 Ser-10 hydrogen bonds the backbone carbonyl of Y283, its side chain hydroxyl oxygen forms a hydrogen bond with the side chain of DIM-5 D209 (FIG. 2D). This interaction appears to be critical for peptide recognition. Phosphorylation of Ser-10 prevents H3 Lys-9 methylation by SUV39H1, Clr4, SETDB1, as well as by DIM-5 (unpublished data). It is not surprising that a negatively charged phosphate group on Ser-10 would disrupt its interaction with D209. Replacing the highly-conserved D209 with Lys, Glu, or Gln also abolished or reduced DIM-5 activity, without affecting AdoMet crosslinking, suggesting that both side chain length and charge are important for the interaction with Ser-10. (iii) The main chain carbonyl of H3 Thr-11 hydrogen bonds the side chain of Q285, while its side chain fits into the space between the side chain of F206 and the hydrophobic portion of K210. Thr-11 may provide critical information for substrate recognition: the sequence around Lys-9 and Lys-27 (QARK₉ST or AARK₂₇SA) differ at this position and DIM-5 does not methylate Lys-27.

The ends of the H3 (1-15) peptide, residues 13-15 and 1-6, which are important for the methylation reaction, appear disordered in the current model. These residues could not be unambiguously identified because they co-localize to the general area of the beginning or the end of disordered protein residues 286-304, respectively (FIGS. 1C and 1D). Residues 286-304 correspond to a region highly variable in length and sequence among HKMT proteins, suggesting that the disordered region may contribute to the substrate specificity of different HKMTs. Further biochemical and structural analysis aimed towards a thermodynamic understanding will be required to resolved this interesting aspect of DIM-5 substrate recognition and allow direct observation of the interaction between this part of the enzyme and peptide substrate.

All or a portion of the peptide binding site may comprise a druggable region, and the H3 peptide may provide the basis for design of modulators that bind to this region.

Target Lysine Binding Site

The side chain of the target Lys-9 is deposited into a narrow channel (FIG. 2B), seen only when the post-SET region becomes structured. However, the corresponding channel in SET7/9 and Rubisco MTase can be pre-formed. The aromatic side chains of F206, F281, Y283, and the carboxyl-terminal residue W318 form the channel wall and make van der Waals contacts to the methylene part of the Lys-9 side chain (FIG. 2C). The Y283 hydroxyl group is hydrogen bonded to the backbone carbonyl oxygen of 1240. This interaction is also observed in the absence of the peptide substrate, suggesting that the Tyr ring is in a relatively fixed position to guide the side chain of the target lysine into the channel. At the bottom of the channel, the terminal amino group of the substrate lysine hydrogen bonds the Y178 hydroxyl and is ˜4 Å from the AdoHcy sulfur atom, where the transferable methyl group will be attached in AdoMet. The AdoHcy sulfur is also ˜4 Å away from the Y283 hydroxyl oxygen.

DIM-5 has an unusually high pH optimum (˜10) and is extremely sensitive to salt. At pH 10, the ε-amino group of the target lysine and the hydroxyl groups of Y178 and Y283 (which would all have typical pKa values of ˜10) should be partially deprotonated. The observed interactions suggest that deprotonated Y178 (O⁻) interacts with the terminal amino group of the target Lys and thereby facilitates its deprotonation, while deprotonated Y283 (O⁻) stabilizes the positive charge on the AdoMet methylsulfonium group (CH₃-S⁺). As a result of these interactions, the deprotonated amino group (NH₂) of the target lysine is able to nucleophilically attack the positively-charged AdoMet methylsulfonium without any general base.

The interactions described above readily explain several experimental observations: (i) The involvement of three potential deprotonation events (the target lysine, Y178 and Y283) is consistent with the pH profile of DIM-5; note that in a log plot of activity against pH, the slope intercepts at approximately 3 pH units (FIG. 2D). (ii) A Y283F mutation abolished both AdoMet crosslinking and MTase activity, consistent with a critical role for the affected hydroxyl group in binding AdoMet. (iii) A Y178V mutation caused complete loss of MTase activity and reduced crosslinking with AdoMet. Similarly, a Y178F mutation also dramatically reduced DIM-5 activity but had little effect on AdoMet crosslinking. This is consistent with the Y178 hydroxyl being in direct contact with the target nitrogen atom and playing an essential role in catalysis.

The Post-SET Domain

Besides the bound peptide, the most prominent difference between the DIM-5 structures with and without peptide is the post-SET structure. The post-SET region was unstructured in substrate-free DIM-5. In the substrate-free DIM-5 structure, the C-terminus, including the post-SET region, was mostly disordered in the crystal except for the segment between residues 299-308. This 10-residue segment, identified through M303 in selenomethionine-substituted DIM-5 protein, was stabilized in the interface between two crystallographic-related molecules. We hypothesized that this segment (along with the adjacent disordered residues) would adopt a different structure upon binding to substrate.

There are three conserved cysteine residues in this region that are essential for HKMT activity. Based on biochemical and genomic analyses, we suggested that these three cysteines form a metal binding site when coupled with a fourth cysteine near the active site (C244 in the signature motif N₂₄₁HXCXPN₂₄₇ of DIM-5). This is indeed what we observed in the current ternary structure (FIG. 2A)—a zinc ion is tetrahedrally coordinated by C244, C306, C308, and C313. Interestingly, the position of the imdidazole ring of the highly-conserved H242 suggests that its Nε2 atom could provide a fifth coordination to the zinc atom (FIG. 2A), while its Nδ1 atom hydrogen bonds the backbone N—H of Y283 and further stabilizes the interaction between the active site and the post-SET metal center.

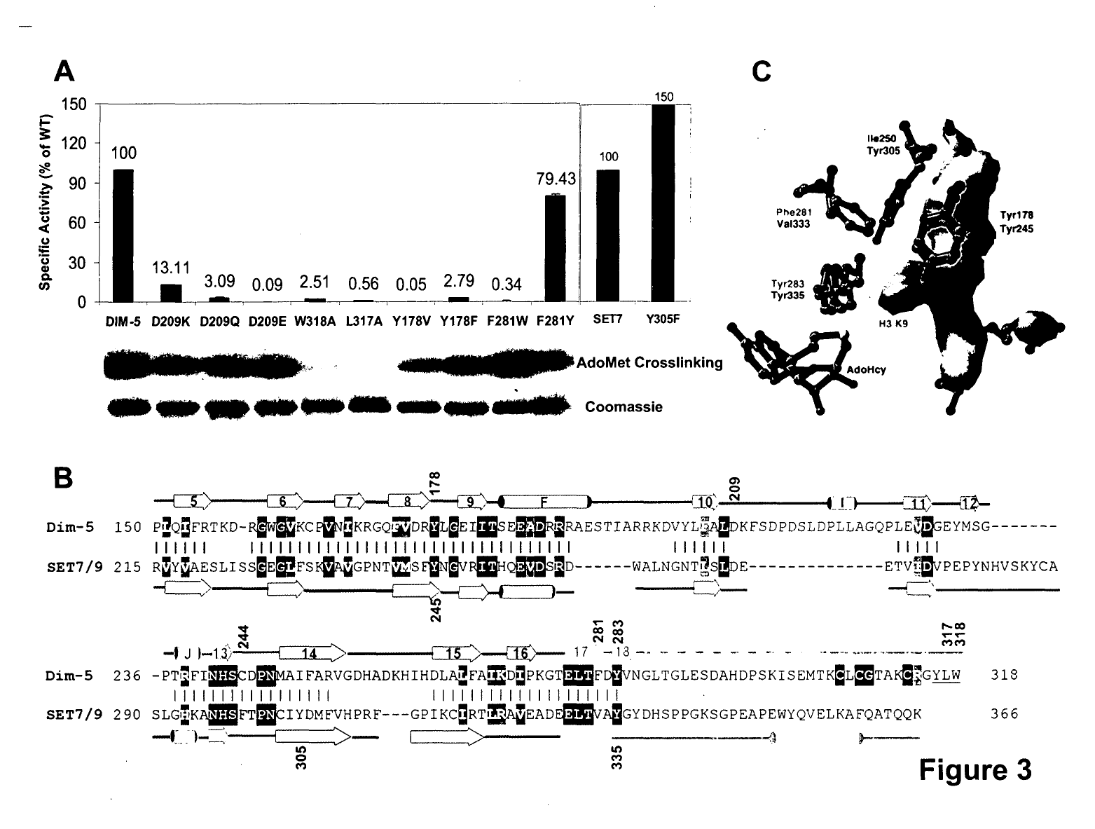

The post-SET zinc binding site is close to the active site (FIG. 2A). The structured post-SET region brings in C-terminal residues that participate in both AdoHcy and peptide binding: (i) The main chain amide nitrogen of L307 hydrogen bonds with the ring nitrogen N1 of the AdoHcy adenine base (FIG. 3A). (ii) The side chain of L317 packs against the AdoHcy adenine ring. (iii) W318 forms part of the channel that accommodates the target Lys and provides van der Waals contacts to the Ala-7 of H3 and to one of the hydroxyls of the AdoHcy ribose. (iv) R314 forms a salt bridge with D282. These interactions are consistent with the observation that simultaneous replacement of the three post-SET cysteines with serines abolished both DIM-5 AdoMet crosslinking and MTase activity. In addition, replacement of either of the last two C-terminal residues, L317 or W318, with alanine significantly reduced, but did not abolish, AdoMet crosslinking and MTase activity. Close examination of the post-SET region of many SET proteins, including SUV39, SET1, and SET2 families, suggests that these interactions between the post-SET domain and the active site are highly conserved: multiple hydrophobic residues are typically present after the post-SET cysteines, and there is usually a positively charged residue (R314 in DIM-5) following the last post-SET cysteine whenever an Asp (D282 in DIM-5) is present in the active site.

We suggest that the metal center we observed in DIM-5 is universal among all SET proteins with the Cys-rich post-SET. As this metal center is absolutely required for enzymatic activity, it represents a good target to design inhibitors that disrupt metal coordination, as successful for numerous metalloenzymes such as matrix metalloproteinases (reviewed in Bode et al. (1999) and Coussens et al. (2002)). In light of the foregoing, all or a portion of the post-SET domain comprises a druggable region.

Comparison to Other SET Proteins

Our structural determination of DIM-5 allowed us to perform a structure-guided sequence alignment of SET proteins that includes human SUV39 family proteins, all verified active HKMTs reported so far, and three bacterial SET proteins. The 318-residue DIM-5 protein is the smallest member of the SUV39 family. It contains four segments: (1) a weakly conserved amino-terminal region, (2) a pre-SET domain containing nine invariant cysteines, (3) the SET region containing signature motifs of NHXCXPN and DY, and (4) the post-SET region containing three invariant cysteines. The nine-Cys pre-SET region is unique to the SUV39 family, while the post-SET region is also present in many members of SET1 and SET2 families (Kouzarides, 2002), and even in one bacterial SET protein from Xylella fastidiosa (FIG. 1). Two active human HKMTs contain neither pre- nor post-SET regions: SET7 (also called SET9) methylates lysine 4 of histone H3 and SET8 (also called PR-SET7) methylates lysine 20 of H4.

Comparison of DIM-5 with SET7/9 and the Rubisco MTase, two SET proteins that do not have a Cys-rich post-SET domain, reveals a remarkable example of convergent evolution. In particular, like DIM-5, these two enzymes rely on residues C-terminal of the SET domain for the formation of lysine channel, but do so by packing of an α-helix, rather than a metal center, onto the active site.

Based in part on the structural information described above, in one aspect, the present invention is directed towards druggable regions of a SET domain protein and in certain embodiments, a histone lysine methyltransferase protein, comprising the majority of the amino acid residues contained in a subject druggable region. In another aspect, the present invention is directed toward an modulator that interacts with a druggable region of a SET domain protein. In one embodiment, this region comprises the pre-SET domain. In another embodiment, this region comprises the post-SET domain. In yet another embodiment, this region comprises the SET domain active site. In still other embodiments, wherein the SET domain protein is a histone methyltransferase, this region may comprise the AdoMet/AdoHcy cofactor binding pocket, peptide binding cleft, or target lysine binding site.

In another aspect, the present invention is directed towards modulators of the activity of a SET domain protein druggable region. In one embodiment, modulating is accomplished by contacting a compound with said druggable region. The contacting may result in binding of the compound to the region, and/or result in the modulation of the binding ability of a natural ligand of the region. For example, a compound may bind a druggable region and prevent the natural ligand from binding to or interacting with the region. In other embodiments, a compound may bind up or chelate the natural ligand, preventing it from binding to the region. In one embodiment, the modulator affects the binding of zinc atoms to a druggable region. The modulator may prevent the zinc atoms by binding to the druggable region by blocking access to or by chelating the zinc. In certain embodiments, the zinc binding site comprises the cysteines in the post-SET region of the protein.

### Example 3

### Basis for Product Specificity of DIM-5 Proteins

DIM-5 and SET7/9 generate distinct products: DIM-5 forms trimethyl-lysine and SET7/9 forms only monomethyl-lysine. A likely explanation for their different product specificities is that residues in the lysine binding channel of SET7/9 sterically exclude the target lysine side chain with methyl group(s). To identify any such residue(s), we superimposed the residues surrounding the target lysine in the DIM-5 ternary structure with those in the binary structure of SET7/9 complexed with AdoHcy (FIG. 3B). As expected from the primary sequence alignment (FIG. 3B), Y178 and Y283 of DIM-5 superimpose well with Y245 and Y335 of SET7/9. We also discovered that the edge of the F281 phenyl ring in DIM-5 points to the same position as the Y305 hydroxyl in SET7/9, both in close proximity to the terminal amino group of target lysine (FIG. 3C). Although these two residues are not aligned at the primary sequence level, we hypothesized that the Y305 hydroxyl in SET7/9 may be the source of steric hindrance limiting methylation.

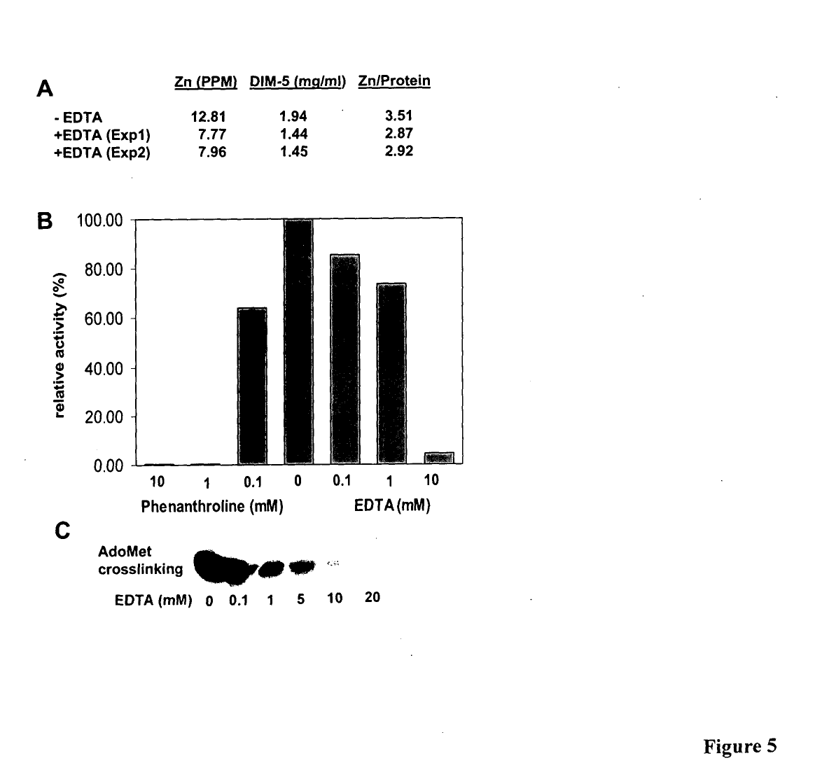

To test this hypothesis, we replaced F281 with a Tyr in DIM-5 (F281Y) and replaced Y305 with a Phe in SET7/9 (Y305F). We found that the F281Y mutation did not significantly impact the total activity of DIM-5 on histones, while the Y305F mutation resulted in an increase in activity of SET7/9 on histones (FIG. 3A). We then monitored the kinetics of product formation with the H3 peptide (residues 1-15) as substrate, using MALDI-TOF mass-spectrometry. FIG. 5 shows representative spectra and the time course for each enzyme. The wild-type (WT) DIM-5 produces tri-methyl-lysine as the predominant product even while a significant amount of unmodified substrate is still present (5 min), consistent with the idea that the enzyme is processive. Interestingly, DIM-5 F281Y initially converted unmodified substrate faster than WT (5 min), but the reaction stalled at the monomethyl stage (compare 5 and 30 min) and then very slowly converted mono- to di-methylated product (compare 30 min and 3 hrs). Trace amount of trimethylated product was observed only after prolonged incubation (3 hrs). These results sharply contrast those obtained with other DIM-5 variants with reduced overall catalytic activity, such as Y178F, R238H, and W318A. After overnight incubation of these feeble enzymes, a substantial amount of unmodified substrate remains but the trimethyl product is much more prominent than with F281Y. We conclude that the F281Y mutation changed the product specificity of DIM-5 from a tri-MTase to a mono- and di-MTase without affecting overall catalytic activity.

In the case of SET7/9, the WT enzyme produced only monomethyl lysine plus a trace amount of dimethyl lysine after overnight incubation. Mutant Y305F, however, produced dimethyl lysine at an accelerated rate, and even traces of trimethylated product were seen after an overnight incubation. The specific activity of the Y305F mutant is higher than that of WT, perhaps due its ability to add a second methyl group.

It was recently reported that a Y245A substitution in SET7/9 has little activity with unmodified substrate but allows SET7/9 to utilize mono- or di-methylated peptide as substrate to form di- or tri-methylated product, respectively. An analogous mutation in DIM-5, Y178V abolished enzymatic activity on both histones and unmodified peptide substrates. In contrast, the residual activity of the Y178F mutant generated trimethyl-lysine. The fact that Y178 of DIM-5 (Y245 of SET7/9) is highly conserved across enzymes with mono-, di-, and tri-specificities (FIG. 3B) is consistent with the idea that this residue is primarily concerned with general catalysis rather than product specificity. Conversely, mutations at F281 in DIM-5 and Y305 in SET7/9 alter specificity without significantly affecting catalytic potential.

### Example 4

### Mass Spectrometry Analysis of the Kinetic Progression of Methylation Reaction

Methylation reactions were carried out in 50 mM Glycine (pH 9.5), 4 mM DTT, 250 μM AdoMet, 20 μM peptide and 0.05 mg/ml enzyme (˜1.2 μM) at 23° C. for DIM-5 and 37° C. for SET7/9. Reactions were stopped by addition of TFA to 0.5%. For mass measurement, 1 μl of reaction mixture with TFA was added directly to 5 μl of CHCA (a-cyano-4-hydroxycinnamic acid) matrix, and 1 μl was spotted on a stainless steel sample plate and rapidly air-dried. Mass was measured by MALDI-TOF on an Applied Biosystems Voyager System 4258 machine (Chemistry Department, Emory University) operated in linear mode using reaction mix without enzyme for calibration. Each measurement was the average of 10 spectra collected at 10 different positions with 200 shots per position.

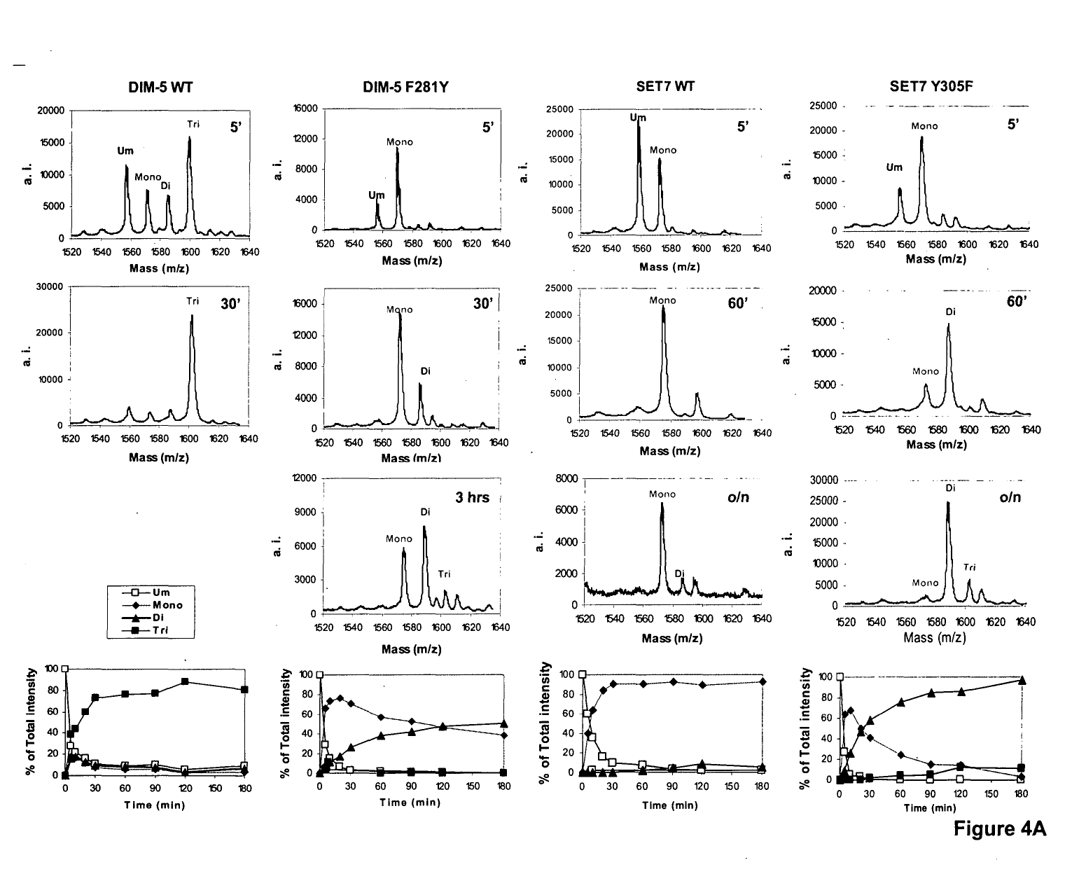

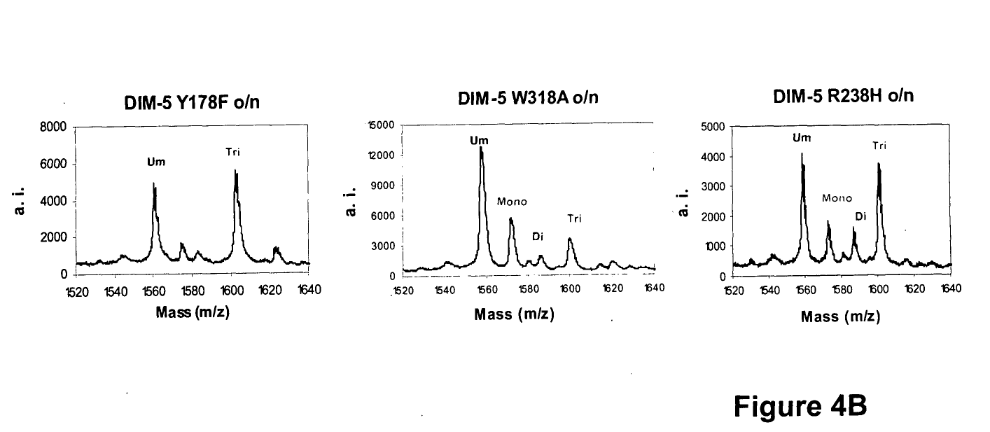

We tested the activity of DIM-5 on three synthetic peptides corresponding to the histone H3 N-terminal residues: 1-15, 1-13, and 5-15. Tri-methylated lysine was the main product for all three substrates. Among them, H3 1-15 was by far the best substrate, synthesizing tri-methylated product 15 to 20 times faster than the other two peptides. Crystals of DIM-5 complexed with H31-15 peptide and AdoHcy were obtained around pH 8.5, where the enzyme is active. The structure was solved at 2.6 Å resolution by molecular replacement using the coordinates of DIM-5 in the absence of substrate. Analysis of the difference Fourier maps clearly indicated electron densities for AdoHcy, the post-SET amino acids of DIM-5, and the structured portion of the H3 peptide (residues 7 to 12). This structure is described in more detail in Example 2. The results of the mass spectroscopic analysis are presented in FIG. 4.

### Example 5

### Inhibitors of DIM-5 Zinc Transfer Activity

Incubation of metal chelators, phenanthroline or EDTA, with DIM-5 protein inhibited its activity and significantly reduced AdoMet-binding (FIG. 5B-C). Interestingly, even when EDTA completely abolished DIM-5 activity, the protein still retained approximately three (2.9) zinc ions (FIG. 5A). As the triangular zinc cluster is quite stable, it is conceivable that the chelated zinc was coordinated by the three post-SET cysteines and C244, which is near the active site.

Equivalents

The present invention provides in part methods of screening novel druggable regions in SET domain proteins, and in certain embodiments, histone lysine methyltransferase proteins, to develop modulators of the protein. While specific embodiments of the subject invention have been discussed, the above specification is illustrative and not restrictive. Many variations of the invention will become apparent to those skilled in the art upon review of this specification. The appendant claims are not intended to claim all such embodiments and variations, and the full scope of the invention should be determined by reference to the claims, along with their full scope of equivalents, and the specification, along with such variations.

All publications and patents mentioned herein, including those items listed below, are hereby incorporated by reference in their entireties as if each individual publication or patent was specifically and individually indicated to be incorporated by reference. In case of conflict, the present application, including any definitions herein, will control.

Baumbusch, L. O., Thorstensen, T., Krauss, V., Fischer, A., Naumann, K., Assalkhou, R., Schulz, I., Reuter, G., and Aalen, R. B. (2001) Nucleic Acids Res. 29, 4319-4333; Bode, W., Femandez-Catalan, C., Tschesche, H., Grams, F., Nagase, H., and Maskos, K. (1999) Cell. Mol. Life Sci. 55, 639-652; Brünger, A. T. (1992) 3.1 edn (New Haven, Yale University); Carson, M. (1997) Methods Enzymol. 227, 493-505; Cheng, X., and Roberts, R. J. (2001) Nucleic Acids Res. 29, 3784-3795; Coussens, L. M., Fingleton, B., and Matrisian, L. M. (2002) Science 295, 2387-2392; Czermin, B., Melfi, R., McCabe, D., Seitz, V., Imhof, A., and Pirrotta, V. (2002) Cell 111, 185-196; Jacob, C., Maret, W., and Vallee, B. L. (1998) Proc. Natl. Acad. Sci. USA 95, 3489-3494; Jacobs, S. A., Harp, J. M., Devarakonda, S., Kim, Y., Rastinejad, F., and Khorasanizadeh, S. (2002) Nat. Struct. Biol. 9, 833-838; Jacobs, S. A., and Khorasanizadeh, S. (2002) Science 295, 2080-2083; Jenuwein, T., and Allis, C. D. (2001) Science 293, 1074-1080; Jones, T. A., and Kjeldgard, M. (1997) Methods Enzymol. 277, 173-208; Kouzarides, T. (2002) Curr. Opin. Genet. Dev. 12, 198-209; Kwon, T., Chang, J. H., Kwak, E., Lee, C. W., Joachimiak, A., Kim, Y. C., Lee, J., and Cho, Y. (2003) Embo J. 22, 292-303; Manzur, K. L., Farooq, A., Zeng, L., Plotnikova, O., Koch, A. W., Sachchidanand, and Zhou, M. M. (2003) Nat. Struct. Biol. 10, 187-196; Mannorstein, R. (2003) Trends Biochem. Sci. 28, 59-62; Min, J., Zhang, X., Cheng, X., Grewal, S. I., and Xu, R. M. (2002) Nat. Struct. Biol. 9, 828-832; Nakayama, J., Rice, J. C., Strahl, B. D., Allis, C. D., and Grewal, S. I. (2001) Science 292, 110-113; Navaza, J. (2001) Acta Crystallogr. D57, 1367-1372; Nicholls, A., Sharp, K. A., and Honig, B. (1991) Proteins 11, 281-296; Nielsen, P. R., Nietlispach, D., Mott, H. R., Callaghan, J., Bannister, A., Kouzarides, T., Murzin, A. G., Murzina, N. V., and Laue, E. D. (2002) Nature 416, 103-107; Otwinowski, Z., and Minor, W. (1997) Methods Enzymol. 276, 307-326; Rea, S., Eisenhaber, F., O'Carroll, D., Strahl, B. D., Sun, Z. W., Schmid, M., Opravil, S., Mechtler, K., Ponting, C. P., Allis, C. D., and Jenuwein, T. (2000) Nature 406, 593-599; Santos-Rosa, H., Schneider, R., Bannister, A. J., Sherriff, J., Bernstein, B. E., Ernre, N. C., Schreiber, S. L., Mellor, J., and Kouzarides, T. (2002) Nature 419, 407-411; Schubert, H. L., Blumenthal, R. M., and Cheng, X. (2003) Trends Biochem. Sci. in press; Schubert, H. L., Wilson, K. S., Raux, E., Woodcock, S. C., and Warren, M. J. (1998) Nat. Struct. Biol. 5, 585-592; Schultz, D. C., Ayyanathan, K., Negorev, D., Maul, G. G., and Rauscher, F. J., 3rd (2002) Genes Dev. 16, 919-932; Strahl, B. D., and Allis, C. D. (2000) Nature 403, 41-45; Tachibana, M., Sugimoto, K., Nozaki, M., Ueda, J., Ohta, T., Ohki, M., Fukuda, M., Takeda, N., Niida, H., Kato, H., and Shinkai, Y. (2002) Genes Dev. 16, 1779-1791; Tamaru, H., and Selker, E. U. (2001) Nature 414, 277-283; Tamaru, H., Zhang, X., McMillen, D., Singh, P., Nakayama, J., Grewal, S., Allis, D., Cheng, X., and Selker, E. U. (2003) Nature Genetics, 34, 75-79; Trievel, R. C., Beach, B. M., Dirk, L. M., Houtz, R. L., and Hurley, J. H. (2002) Cell 111, 91-103; Wang, X., Moore, S. C., Laszckzak, M., and Ausio, J. (2000) J. Biol. Chem. 275, 35013-35020; Wilson, J. R., Jing, C., Walker, P. A., Martin, S. R., Howell, S. A., Blackburn, G. M., Gamblin, S. J., and Xiao, B. (2002) Cell 111, 105-115; Xiao, B., Jing, C., Wilson, J. R., Walker, P. A., Vasisht, N., Kelly, G., Howell, S., Taylor, I. A., Blackburn, G. M., and Gamblin, S. J. (2003) Nature 421, 652-656; Zhang, X., Tamaru, H., Khan, S. I., Horton, J. R., Keefe, L. J., Selker, E. U., and Cheng, X. (2002) Cell 111, 117-127; Bannister, A. J., Zegerman, P., Partridge, J. F., Miska, E. A., Thomas, J. O., Allshire, R. C., and Kouzarides, T. (2001) Nature 410, 120-124; Baumbusch, L. O., Thorstensen, T., Krauss, V., Fischer, A., Naumann, K., Assalkhou, R., Schulz, I., Reuter, G., and Aalen, R. B. (2001) Nucleic Acids Research 29, 4319-4333; Blumenthal, R. M., and Cheng, X. (2001) Nat Struct Biol 8, 101-103; Boggs, B. A., Cheung, P., Heard, E., Spector, D. L., Chinault, A. C., and Allis, C. D. (2002). Nature Genetics 30, 73-76; Briggs, S. D., Bryk, M., Strahl, B. D., Cheung, W. L., Davie, J. K., Dent, S. Y., Winston, F., and Allis, C. D. (2001) Genes & Development 15, 3286-3295; Brünger, A. T. (1992) 3.1 edn (New Haven, Yale University); Carson, M. (1997) Methods Enzymology 227, 493-505; Cheng, X., and Roberts, R. J. (2001) Nucleic Acids Res 29, 3784-3795; Duerre, J. A., and Chakrabarty, S. (1975) J Biol. Chem. 250, 8457-8461; Fang, J., Feng, Q., Ketel, C. S., Wang, H., Cao, R., Xia, L., Erdjument-Bromage, H., Tempst, P., Simon, J. A., and Zhang, Y. (2002) Curr. Biol. 12, 1086-1099; Fauman, E. B., Blumenthal, R. M., and Cheng, X. (1999) Structures and Functions, X. Cheng, and R. M. Blumenthal, eds. (World Scientific), pp 1-38; Feng, Q., Wang, H., Ng, H. H., Erdjument-Bromage, H., Tempst, P., Struhl, K., and Zhang, Y. (2002) Curr. Biol. 12, 1052-1058; Fu, Z., Hu, Y., Konishi, K., Takata, Y., Ogawa, H., Gomi, T., Fujioka, M., and Takusagawa, F. (1996) Biochemistry 35, 11985-11993; Goedecke, K., Pignot, M., Goody, R. S., Scheidig, A. J., and Weinhold, E. (2001) Nat. Struct. Biol. 8, 121-125; Gong, W., O'Gara, M., Blumenthal, R. M., and Cheng, X. (1997) Nucleic Acids Res 25, 2702-2715; Heurgue-Hamard, V., Champ, S., Engstrom, A., Ehrenberg, M., and Buckingham, R. H. (2002) Embo. J. 21, 769-778; Jackson, J. P., Lindroth, A. M., Cao, X., and Jacobsen, S. E. (2002) Nature 416, 556-560; Jacobs, S. A., and Khorasanizadeh, S. (2002) Science 295, 2080-2083; Jacobs, S. A., Tavema, S. D., Zhang, Y., Briggs, S. D., Li, J., Eissenberg, J. C., Allis, C. D., and Khorasanizadeh, S. (2001) Embo. J. 20, 5232-5241; Jenuwein, T., Laible, G., Dorn, R., and Reuter, G. (1998) Cell Mol Life Sci. 54, 80-93; Jones, T. A., and Kjeldgard, M. (1997) Methods Enzymol 277, 173-208; Krogan, N. J., Dover, J., Khorrami, S., Greenblatt, J. F., Schneider, J., Johnston, M., and Shilatifard, A. (2002) J. Biol. Chem. 277, 10753-10755; Lachner, M., O'Carroll, D., Rea, S., Mechtler, K., and Jenuwein, T. (2001) Nature 410, 116-120; Lacoste, N., Utley, R. T., Hunter, J., Poirier, G. G., and Cote, J. (2002) J. Biol. Chem.; Laskowski, R. A. (1993) J. Appl. Cryst. 26, 283-291; Litt, M. D., Simpson, M., Gaszner, M., Allis, C. D., and Felsenfeld, G. (2001) Science 293, 2453-2455; Ma, H., Baumann, C. T., Li, H., Strahl, B. D., Rice, R., Jelinek, M. A., Aswad, D. W., Allis, C. D., Hager, G. L., and Stallcup, M. R. (2001) Curr. Biol. 11, 1981-1985; Nakahigashi, K., Kubo, N., Narita, S., Shimaoka, T., Goto, S., Oshima, T., Mori, H., Maeda, M., Wada, C., and Inokuchi, H. (2002) Proc. Natl. Acad. Sci. USA 99, 1473-1478; Ng, H. H., Feng, Q., Wang, H., Erdjument-Bromage, H., Tempst, P., Zhang, Y., and Struhl, K. (2002) Genes Dev. 16, 1518-1527; Nicholls, A., Sharp, K. A., and Honig, B. (1991) Proteins 11, 281-296; Nielsen, S. J., Schneider, R., Bauer, U. M., Bannister, A. J., Morrison, A., O'Carroll, D., Firestein, R., Cleary, M., Jenuwein, T., Herrera, R. E., and Kouzarides, T. (2001) Nature 412, 561-565; Nishioka, K., Chuikov, S., Sarma, K., Erdjument-Bromage, H., Allis, C. D., Tempst, P., and Reinberg, D. (2002a) Genes Dev. 16, 479-489; Nishioka, K., Rice, J. C., Sarma, K., Erdjument-Bromage, H., Werner, J., Wang, Y., Chuikov, S., Valenzuela, P., Tempst, P., Steward, R., et al. (2002b) Mol. Cell 9, 1201-1213; O'Carroll, D., Scherthan, H., Peters, A. H., Opravil, S., Haynes, A. R., Laible, G., Rea, S., Schmid, M., Lebersorger, A., Jerratsch, M., et al. (2000) Mol. Cell Biol. 20, 9423-9433; Ogawa, H., Ishiguro, K., Gaubatz, S., Livingston, D. M., and Nakatani, Y. (2002) Science 296, 1132-1136; Robbins, A. H., McRee, D. E., Williamson, M., Collett, S. A., Xuong, N. H., Furey, W. F., Wang, B. C., and Stout, C. D. (1991) J. Mol. Biol. 221, 1269-1293; Strahl, B. D., and Allis, C. D. (2000) Nature 403, 41-45; Strahl, B. D., Briggs, S. D., Brame, C. J., Caldwell, J. A., Koh, S. S., Ma, H., Cook, R. G., Shabanowitz, J., Hunt, D. F., Stallcup, M. R., and Allis, C. D. (2001) Curr. Biol. 11, 996-1000; Tachibana, M., Sugimoto, K., Fukushima, T., and Shinkai, Y. (2001) J. Biol. Chem. 276, 25309-25317; Tamaru, H., and Selker, E. U. (2001) Nature 414, 277-283; Terwilliger, T. C. (2000) Acta. Crystallogr. D56, 965-972; Terwilliger, T. C., and Berendzen, J. (1999) Acta. Crystallogr. D55, 849-861; van Leeuwen, F., Gafken, P. R., and Gottschling, D. E. (2002) Cell 109, 745-756; Vasak, M., and Hasler, D. W. (2000) Curr. Opin. Chem. Biol. 4, 177-183; Wang, H., Cao, R., Xia, L., Erdjument-Bromage, H., Borchers, C., Tempst, P., and Zhang, Y. (2001 a) Molecular Cell 8, 1207-1217; Wang, H., Huang, Z. Q., Xia, L., Feng, Q., Erdjument-Bromage, H., Strahl, B. D., Briggs, S. D., Allis, C. D., Wong, J., Tempst, P., and Zhang, Y. (2001b) Science 293, 853-857; Zhang, X., Zhou, L., and Cheng, X. (2000) Embo. J 19, 3509-3519;

We claim:

1. A method of modulating the activity of a SET domain protein comprising modulating the activity of a druggable region of said protein.

2. The method of claim 1, wherein said SET domain protein is a histone lysine methyltransferase SET domain protein and wherein said druggable region is selected from the group consisting of: pre-SET domain, post-SET domain, AdoMet/AdoHcy cofactor binding pocket, peptide binding cleft, target lysine binding site, and SET domain active site.

3. The method of claim 1, wherein said modulating is accomplished by contacting a compound with said druggable region.

4. The method of claim 3, wherein said contacting results in binding of said compound to said region.

5. The method of claim 1, wherein said contacting modulates the ability of said region's natural ligand to bind to said region.

6. The method of claim 1, wherein said modulating is accomplished by inhibiting the binding of a natural ligand to said region.

7. The method of claim 6, wherein said inhibiting is accomplished by blocking the binding site of said ligand.

8. The method of claim 6, wherein said inhibiting is accomplished by binding the natural ligand with a test compound to prevent it from binding to said region.

9. The method of claim 5, wherein said method is a method of inhibiting the catalytic activity of a SET domain protein comprising modulating the binding of zinc atoms to a druggable region.

10. The method of claim 9, wherein said protein is a histone lysine methyltransferase SET domain protein.

11. The method of claim 9, wherein said protein is a zinc-dependent histone lysine methyltransferase SET domain protein and said zinc atoms are required for enzymatic activity.

12. The method of claim 9, wherein said modulating comprises interrupting with a compound the binding of zinc atoms to a druggable region.

13. The method of claim 12, wherein said binding of zinc atoms is interrupted by a compound that chelates zinc.

14. The method of claim 12, wherein said binding of zinc atoms is interrupted by blocking a zinc binding site in said region.

15. The method of claim 14, wherein said zinc binding site comprises the cysteines in the post-SET region of the protein.

16. The method of claim 12, wherein said interrupting is the binding of zinc atoms to cysteines in the post-SET region of the protein.

17. The method of claim 9, wherein said protein is a histone H-3 Lysine-9 methyltransferase protein and said modulating comprises interrupting the binding of a zinc atom in the post-SET region of the protein.

18. A method for identifying a candidate therapeutic for a disease caused by an organism having a SET domain protein, comprising assaying the ability of a test compound to modulate the activity of at least one druggable region of said SET protein, wherein the ability to modulate indicates a candidate therapeutic.

19. The method of claim 18, wherein said organism is a fungus and said disease is a fungal infection.

20. The method of claim 18, wherein said organism is a mammal and said disease is cancer.

21. The method of claim 18, wherein said SET domain protein is a histone lysine methyltransferase.

22. The method of claim 21, wherein said histone lysine methyltransferase is zinc-dependent.

23. The method of claim 22, wherein the ability of said test compound to interrupt the binding of zinc atoms to a druggable region is assayed and wherein the ability to interrupt zinc binding indicates a candidate therapeutic.

24. The method of claim 18, wherein said test compound is selected from a library of compounds.

25. The method of claim 24, wherein said library is generated using combinatorial synthetic methods.

26. The method of claim 18, wherein ability to modulate is determined using an in vitro assay.

27. The method of claim 18, wherein ability to modulate is determined using an in vivo assay.

28. A method for identifying a candidate therapeutic for a disease caused by a cell or organism having a SET domain protein, comprising contacting said SET domain protein with a test compound, wherein the ability of said compound to bind to said protein indicates a candidate therapeutic.

29. A method for identifying a candidate therapeutic for a disease caused by a cell or organism having a SET domain protein, comprising contacting said SET domain protein with a test compound, wherein a decrease in the viability of said cell or organism indicates a candidate therapeutic.

30. A method for designing a candidate modulator for screening for modulators of a polypeptide, the method comprising:
(a) providing the three dimensional structure of a druggable region of a polypeptide comprising (1) an amino acid sequence comprising a histone lysine methyltransferase protein having SEQ ID NO: 1; or (2) an amino acid sequence having at least about 85% identity with SEQ ID NO: 1; and
(b) designing a candidate modulator based on the three dimensional structure of the druggable region of the polypeptide.

31. A method for designing a modulator of the activity of a histone lysine methyltransferase protein, comprising:
(a) providing a three-dimensional structure comprising: (1) an amino acid sequence comprising a histone lysine methyltransferase protein having SEQ ID NO: 1; or (2) an amino acid sequence having at least about 85% identity with SEQ ID NO: 1; or (3) an amino acid sequence comprising at least one druggable region of SEQ ID NO: 1; or (4) an amino acid sequence comprising a sequence having at least about 85% identity with at least one druggable region of SEQ ID NO: 1; and having at least one biological activity of histone lysine methyltransferase protein; and
(b) identifying a potential modulator by reference to the three-dimensional structure.

32. The method of claim 31, further comprising:
(c) contacting a polypeptide comprising a sequence at least 50% identical to the amino acid sequence in the three-dimensional structure and having at least one biological activity of histone lysine methyltransferase protein; which polypeptide may optionally be the same as the histone lysine methyltransferase protein in the structure; with the potential modulator; and
(d) assaying either (1) the ability of said modulator to bind the histone lysine methyltransferase protein or (2) activity of the histone lysine methyltransferase protein or (3) determining the viability of a cell or organism having said histone lysine methyltransferase protein after contact with the modulator, wherein ability to bind or a change in the activity of the protein or the viability of the cell or organism indicates that the modulator may be useful for prevention or treatment of a histone lysine methyltransferase protein-related disease or disorder.

33. The method of claim 31, wherein said histone lysine methyltransferase protein is a H-3 Lysine-9 methyltransferase and said three-dimensional structure is defined by the coordinates in FIG. 6.

34. The method of claim 33, wherein said polypeptide is DIM-5.

35. A method for identifying a potential modulator of a histone lysine methyltransferase polypeptide from a database, the method comprising:
(a) providing the three-dimensional coordinates for a plurality of the amino acids of a polypeptide comprising: (1) an amino acid sequence comprising a histone lysine methyltransferase protein having SEQ ID NO: 1; or (2) an amino acid sequence having at least about 85% identity with SEQ ID NO: 1; or (3) an amino acid sequence comprising at least one druggable region of SEQ ID NO: 1; or (4) an amino acid sequence comprising a sequence having at least about 85% identity with at least one druggable region of SEQ ID NO: 1; and having at least one biological activity of histone lysine methyltransferase protein;
(b) identifying a druggable region of the polypeptide; and
(c) selecting from a database at least one potential modulator comprising three dimensional coordinates which indicate that the modulator may bind or interfere with the druggable region.

36. A computer-assisted method for identifying an modulator of the activity of a histone lysine methyltransferase polypeptide, comprising:
(a) supplying a computer modeling application with a set of structure coordinates as listed in PDB accession number 1ML9 or FIG. 6 for the atoms of the amino acid residues from any of the above-described druggable regions of histone lysine methyltransferase polypeptide so as to define part or all of a molecule or complex;
(b) supplying the computer modeling application with a set of structure coordinates of a chemical entity; and
(c) determining whether the chemical entity is expected to bind to or interfere with the molecule or complex.

37. The method of claim 36, wherein determining whether the chemical entity is expected to bind to or interfere with the molecule or complex comprises performing a fitting operation between the chemical entity and a druggable region of the molecule or complex, followed by computationally analyzing the results of the fitting operation to quantify the association between the chemical entity and the druggable region.

38. The method of claim 36, further comprising supplying or synthesizing the potential modulator, then assaying the potential modulator to determine whether it modulates histone lysine methyltransferase protein activity.

39. A method for preparing a potential modulator of a druggable region contained in a polypeptide, the method comprising:
(a) using the atomic coordinates for the backbone atoms of at least about six amino acid residues from a polypeptide of SEQ ID NO:1 with a ± a root mean square deviation from the backbone atoms of the amino acid residues of not more than 5.0 Å, to generate one or more three-dimensional structures of a molecule comprising a druggable region from the polypeptide;
(b) employing one or more of the three dimensional structures of the molecule to design or select a potential modulator of the druggable region; and
(c) synthesizing or obtaining the modulator.

40. A computer-assisted method for identifying an inhibitor of the activity of a histone lysine methyltransferase polypeptide, comprising:
(a) supplying a computer modeling application with a set of structure coordinates as listed in FIG. 6 or in PDB 1ML9 for the atoms of the amino acid residues from any of the above-described druggable regions of histone lysine methyltransferase polypeptide so as to define part or all of a molecule or complex;
(b) supplying the computer modeling application with a set of structure coordinates of a chemical entity; and
(c) determining whether the chemical entity is expected to bind to or interfere with the molecule or complex.

41. The method of claim 40, wherein determining whether the chemical entity is expected to bind to or interfere with the molecule or complex comprises performing a fitting operation between the chemical entity and a druggable region of the molecule or complex, followed by computationally analyzing the results of the fitting operation to quantify the association between the chemical entity and the druggable region.

42. The method of claim 40, further comprising screening a library of chemical entities.

43. A computer-assisted method for designing an inhibitor of histone lysine methyltransferase activity comprising:
(a) supplying a computer modeling application with a set of structure coordinates having a root mean square deviation of less than about 1.5 Å from the structure coordinates as listed in FIG. 6 or in PDB accession number 1ML9 for the atoms of the amino acid residues from any of the above-described druggable regions of histone lysine methyltransferase so as to define part or all of a molecule or complex;
(b) supplying the computer modeling application with a set of structure coordinates for a chemical entity;
(c) evaluating the potential binding interactions between the chemical entity and the molecule or complex;
(d) structurally modifying the chemical entity to yield a set of structure coordinates for a modified chemical entity; and
(e) determining whether the modified chemical entity is an inhibitor expected to bind to or interfere with the molecule or complex, wherein binding to or interfering with the molecule or molecular complex is indicative of potential inhibition of histone lysine methyltransferase activity.

44. The method of claim 43, wherein determining whether the modified chemical entity is an inhibitor expected to bind to or interfere with the molecule or complex comprises performing a fitting operation between the chemical entity and the molecule or complex, followed by computationally analyzing the results of the fitting operation to evaluate the association between the chemical entity and the molecule or complex.

45. The method of claim 43, wherein the set of structure coordinates for the chemical entity is obtained from a chemical library.

46. A computer-assisted method for designing an inhibitor of histone lysine methyltransferase activity de novo comprising:
(a) supplying a computer modeling application with a set of three-dimensional coordinates derived from the structure coordinates as listed in FIG. 6 or in PDB accession number 1ML9 for the atoms of the amino acid residues from any of the above-described druggable regions of histone lysine methyltransferase so as to define part or all of a molecule or complex;
(b) computationally building a chemical entity represented by a set of structure coordinates; and
(c) determining whether the chemical entity is an inhibitor expected to bind to or interfere with the molecule or complex, wherein binding to or interfering with the molecule or complex is indicative of potential inhibition of bistone lysine methyltransferase activity.

47. The method of claim 46, wherein determining whether the chemical entity is an inhibitor expected to bind to or interfere with the molecule or complex comprises performing a fitting operation between the chemical entity and a druggable region of the molecule or complex, followed by computationally analyzing the results of the fitting operation to quantify the association between the chemical entity and the druggable region.

48. The method of any of claims 40, 43, or 46, further comprising supplying or synthesizing the potential inhibitor, then assaying the potential inhibitor to determine whether it inhibits histone lysine methyltransferase activity.

49. A method for identifying a druggable region of a histone lysine methyltransferase protein, the method comprising:
(a) obtaining crystals of a polypeptide comprising (1) an amino acid sequence comprising a histone lysine methyltransferase protein having SEQ ID NO: 1; or (2) an amino acid sequence having at least about 85% identity with SEQ ID NO: 1; and having at least one biological activity of histone lysine methyltransferase protein, such that the three dimensional structure of the crystallized polypeptide may be determined to a resolution of 3.5 Å or better;
(b) determining the three dimensional structure of the crystallized polypeptide using X-ray diffraction; and
(c) identifying a druggable region of the crystallized polypeptide based on the three-dimensional structure of the crystallized polypeptide.

50. Crystalline histone lysine methyltransferase comprising a crystal having a P2₁2₁2₁ space group.

51. The crystal of claim 50, further having cell dimensions of 36.73×81.56×101.27 Å and one molecule per asymmetric unit.

52. The crystal of claim 50, wherein the protein is DIM-5.

53. A crystalline histone lysine methyltransferase complex.

54. The crystalline complex of claim 53, comprising a crystal having a P2₁2₁2₁ space group.

55. The crystal of claim 53, further having unit cell dimension 68.26×94.17×114.69 Å and two molecules per asymmetric unit.

56. The crystalline complex of claim 53, wherein said complex comprises a metal-dependent histone lysine methyltransferase protein and a substrate.

57. The crystalline complex of claim 53, wherein said complex comprises a mutant of a metal-dependent histone lysine methyltransferase protein and a substrate.

58. The crystalline complex of claim 53, wherein said complex comprises a naturally occurring mutant of a metal-dependent histone lysine methyltransferase protein and a substrate.

59. The crystalline complex of claim 53, wherein said complex comprises a metal-dependent histone lysine methyltransferase protein and a substrate, wherein said metal-dependent histone lysine methyltransferase protein has greater than 95% homology to a naturally occurring metal-dependent histone lysine methyltransferase protein.

60. The crystalline complex of claim 53, wherein said complex comprises a metal-dependent histone lysine methyltransferase protein and a substrate, wherein the SET region of said metal-dependent histone lysine methyltransferase protein has greater than 95% homology to the SET region of a naturally occurring metal-dependent histone lysine methyltransferase protein.

61. The crystalline complex of claim 53, wherein said complex comprises a metal-dependent histone lysine methyltransferase protein and a substrate, wherein said transferase acts on lysine-9 in histone H3.

62. The crystalline complex of claim 53, wherein the complex comprises DIM-5.

63. The crystalline complex of claim 53, wherein the complex comprises a peptide.

64. The crystalline complex of claim 63, wherein the complex comprises an H3 peptide.

65. The crystalline complex of claim 53, wherein the complex comprises S-adenosyl-L-homocysteine.

66. The crystalline complex of claim 53, wherein the crystal effectively diffracts X-rays for the determination of the atomic coordinates of a histone lysine methyl transferase protein to a resolution less than 4.0 Angstroms.

67. The crystalline complex of claim 66, wherein the resolution is less than 3.0 Angstroms.

68. A crystallized polypeptide comprising (1) an amino acid sequence comprising a histone lysine methyltransferase protein having SEQ ID NO: 1; or (2) an amino acid sequence having at least about 85% identity with SEQ ID NO: 1; or (3) an amino acid sequence comprising at least one druggable region of SEQ ID NO: 1; or (4) an amino acid sequence comprising a sequence having at least about 85% identity with at least one druggable region of SEQ ID NO: 1; and having at least one biological activity of a histone lysine methyl transferase protein; wherein the crystal has a P2₁2₁2₁ space group.

69. A crystallized polypeptide comprising a structure of a polypeptide that is defined by a portion of the atomic coordinates in FIG. 6 or in PDB accession number 1ML9.

70. A method for determining the crystal structure of a homolog of a polypeptide, the method comprising:
(a) providing the three dimensional structure of a first crystallized polypeptide comprising (1) an amino acid sequence comprising a histone lysine methyltransferase protein having SEQ ID NO: 1; or (2) an amino acid sequence having at least about 85% identity with SEQ ID NO: 1; or (3) an amino acid sequence comprising at least one druggable region of SEQ ID NO: 1; or (4) an amino acid sequence comprising a sequence having at least about 85% identity with at least one druggable region of SEQ ID NO: 1; and having at least one biological activity of histone lysine methyltransferase protein;
(b) obtaining crystals of a second polypeptide comprising an amino acid sequence that is at least 50% identical to the amino acid sequence comprising SEQ ID NO: 1 and having at least one biological activity of histone lysine methyl transferase protein, such that the three dimensional structure of the second crystallized polypeptide may be determined to a resolution of 3.5 Å or better; and
(c) determining the three dimensional structure of the second crystallized polypeptide by x-ray crystallography based on the atomic coordinates of the three dimensional structure provided in step (a).

71. A method for obtaining structural information about a molecule or a molecular complex of unknown structure comprising:
(a) crystallizing the molecule or molecular complex;
(b) generating an x-ray diffraction pattern from the crystallized molecule or molecular complex;
(c) applying at least a portion of the structure coordinates of FIG. 6 or in PDB accession number 1ML9 to the x-ray diffraction pattern to generate a three-dimensional electron density map of at least a portion of the molecule or molecular complex whose structure is unknown.

72. A method for making a crystallized complex comprising a polypeptide and a candidate modulator, the method comprising:
(a) crystallizing a polypeptide comprising (1) an amino acid sequence comprising a histone lysine methyltransferase protein having SEQ ID NO: 1; or (2) an amino acid sequence having at least about 85% identity with SEQ ID NO: 1; or (3) an amino acid sequence comprising at least one druggable region of SEQ ID NO: 1; or (4) an amino acid sequence comprising a sequence having at least about 85% identity with at least one druggable region of SEQ ID NO: 1; and having at least one biological activity of histone lysine methyltransferase protein; such that crystals of the crystallized polypeptide will diffract x-rays to a resolution of 5 Å or better; and
(b) soaking the crystals in a solution comprising a potential modulator.

73. A method for incorporating a potential modulator in a crystal of a polypeptide, comprising placing a crystal of histone lysine methyl transferase protein having a space group P2₁2₁2₁ in a solution comprising the potential modulator.
